(19) United States
(12) Patent Application Publication
(10) Pub. No.: US 2026/0349527 A1
(43) Pub. Date: Nov. 5, 2026

(54) METHOD AND ELECTRONIC DEVICE FOR PROVIDING VIRTUAL IMAGE

(71) Applicant: SAMSUNG ELECTRONICS CO., LTD., Suwon-si (KR)

(72) Inventors: Jaeseung CHUNG, Suwon-si (KR); Changkun LEE, Suwon-si (KR); Narae CHOI, Suwon-si (KR); Jungkwuen AN, Suwon-si (KR); Bongsu SHIN, Suwon-si (KR)

(73) Assignee: SAMSUNG ELECTRONICS CO., LTD., Suwon-si (KR)

(21) Appl. No.: 19/716,734

(22) Filed: Jun. 23, 2026

Related U.S. Application Data
(63) Continuation of application No. PCT/KR2026/005675, filed on Apr. 28, 2026.

(30) Foreign Application Priority Data
Apr. 28, 2025 (KR) 10-2025-0055805
Jun. 23, 2025 (KR) 10-2025-0082704
Mar. 30, 2026 (KR) 10-2026-0057186

(51) Int. Cl. G06F 3/01; G02B 30/56; G06T 3/60; G06T 7/246; G06T 7/50; G06T 7/73; G06V 40/20

(52) U.S. Cl. CPC G06F 3/017; G02B 30/56; G06T 3/60; G06T 7/246; G06T 7/50; G06T 7/73; G06V 40/28; G06T 2207/30196

(57) ABSTRACT

An electronic device for providing a virtual image includes at least one processor configured to obtain an input image, and generate a flipped image by performing correction to flip the input image, an optical engine configured to provide light of the flipped image when receiving the flipped image, a waveguide comprising a first optical coupling area allowing the light of the flipped image provided from the optical engine to be incident into the waveguide and a second optical coupling area emitting the light of the flipped image incident through the first optical coupling area to the outside, and a lens configured to provide the virtual image in which the input image is floating on a virtual projection plane by focusing the light of the flipped image emitted through the second optical coupling area into an inverted image on the virtual projection plane.

### TECHNICAL FIELD

This application is a continuation of International Application No. PCT/KR2026/005675, filed on Apr. 28, 2026, which is based on and claims priority to Korean Patent Application No. 10-2025-0055805, filed on Apr. 28, 2025, in the Korean Intellectual Property Office, to Korean Patent Application No. 10-2025-0082704, filed on Jun. 23, 2025, in the Korean Intellectual Property Office, and to Korean Patent Application No. 10-2026-0057186, filed on Mar. 30, 2026, in the Korean Intellectual Property Office, the disclosures of which are incorporated by reference herein in their entireties.

### BACKGROUND

### 1. Field

The disclosure relates to a method and an electronic device for providing a virtual image. More particularly, the disclosure relates to an electronic device for providing a virtual image floating on a virtual projection plane and a method of providing a virtual image by using the electronic device.

### 2. Description of Related Art

With advancements in electronic technologies, various types of electronic devices are being developed and supplied. An electronic device including a display apparatus for displaying an image has been rapidly developed in recent years.

Recently, according to the development of augmented reality (AR), mixed reality (MR), hologram technology, etc., interest in display technology for enhancing interaction with users has been increasing. In particular, technologies for providing intuitive information delivery and immersive user experience by visually representing digital images as if they are floating within real space are being utilized in various fields.

### SUMMARY

According to an embodiment of the disclosure, an electronic device may include at least one processor configured to obtain an input image, and generate a flipped image by performing correction to flip the input image.

According to an embodiment of the disclosure, the electronic device may include an optical engine configured to provide light of the flipped image when receiving the flipped image.

According to an embodiment of the disclosure, the electronic device may include a waveguide including a first optical coupling area configured to direct the light of the flipped image provided from the optical engine to be incident into the waveguide and a second optical coupling area configured to emit the light of the flipped image incident through the first optical coupling area to the outside.

According to an embodiment of the disclosure, the electronic device may include a lens located on a front surface of the waveguide and configured to provide the virtual image in which the input image is floating on a virtual projection plane by focusing the light of the flipped image emitted through the second optical coupling area as an inverted image on the virtual projection plane.

According to an embodiment of the disclosure, a method of providing a virtual image may include obtaining an input image.

According to an embodiment of the disclosure, the method of providing the virtual image may include generating a flipped image by performing correction including flipping the input image horizontally and vertically.

According to an embodiment of the disclosure, the method of providing the virtual image may include providing the virtual image in which the input image is floating by providing light of the flipped image to a first optical coupling area of the waveguide by using an optical engine, and emitting the light of the flipped image incident into the waveguide to outside of a waveguide through the second optical coupling area of the waveguide, directing the light of the flipped image to pass through a lens, and focusing the light of the flipped image as an inverted image on a virtual projection plane.

### BRIEF DESCRIPTION OF THE DRAWINGS

The disclosure will now be described more fully through the detailed descriptions below with reference to the accompanying drawings, in which reference numerals denote structural elements.

FIG. 1A is a diagram for describing an electronic device according to an embodiment of the disclosure.

FIG. 1B is a diagram for describing a display unit of an electronic device, according to an embodiment of the disclosure.

FIG. 2 is a flowchart illustrating a method of providing a virtual image through an electronic device, according to an embodiment of the disclosure.

FIG. 3 is a diagram illustrating a method of operating an electronic device, according to an embodiment of the disclosure.

FIG. 4 is a block diagram of an electronic device according to an embodiment of the disclosure.

FIG. 5 is a diagram for describing an optical engine and a waveguide, according to an embodiment of the disclosure.

FIG. 6 is a flowchart illustrating a method of providing a virtual image through an electronic device, according to an embodiment of the disclosure.

FIG. 7A is a diagram for describing a waveguide and a lens, according to an embodiment of the disclosure.

FIG. 7B is a diagram for describing a waveguide and a lens, according to an embodiment of the disclosure.

FIG. 8 is a diagram for describing a waveguide and a lens, according to an embodiment of the disclosure.

FIG. 9 is a diagram for describing a waveguide according to an embodiment of the disclosure.

FIG. 10A is a block diagram of an electronic device according to an embodiment of the disclosure.

FIG. 10B is a diagram for describing an operation in which an electronic device obtains an image of a real world, according to an embodiment of the disclosure.

FIG. 10C is a diagram for describing an operation in which an electronic device obtains an image of a real world, according to a comparative example.

FIG. 11A is a flowchart illustrating an operating method of an electronic device for obtaining an image of a real world by using an image sensor, according to an embodiment of the disclosure.

FIG. 11B is a diagram for describing a waveguide and an image sensor, according to an embodiment of the disclosure.

FIG. 12A is a flowchart illustrating an operating method of an electronic device for obtaining an image of a real world by using an image sensor, according to an embodiment of the disclosure.

FIG. 12B is a diagram for describing a waveguide and an image sensor, according to an embodiment of the disclosure.

FIG. 12C is a diagram for describing a waveguide and an image sensor, according to an embodiment of the disclosure.

FIG. 13A is a diagram for describing a waveguide and an image sensor, according to an embodiment of the disclosure.

FIG. 13B is a diagram for describing a waveguide and an image sensor, according to an embodiment of the disclosure.

FIG. 14 is a diagram for describing a waveguide and an image sensor, according to an embodiment of the disclosure.

FIG. 15A is a flowchart illustrating an operating method of an electronic device for recognizing a user's gesture, according to an embodiment of the disclosure.

FIG. 15B is a diagram illustrating an operation in which an electronic device recognizes a user's gesture, according to an embodiment of the disclosure.

FIG. 16A is a flowchart illustrating an operating method of an electronic device for providing an indicator indicating a distance between a hand and a virtual projection plane, according to an embodiment of the disclosure.

FIG. 16B is a diagram for explaining an operation in which an electronic device provides an indicator indicating a distance between a hand and a virtual projection plane, according to an embodiment of the disclosure.

FIG. 16C is a diagram for explaining an operation in which an electronic device provides a hovering detection indicator and a touch recognition indicator, according to an embodiment of the disclosure.

FIG. 17 is a diagram for explaining a display unit of an electronic device, according to an embodiment of the disclosure.

FIG. 18 is a diagram illustrating a reference grating of a reference coordinate system and projection gratings for each user viewpoint, according to an embodiment of the disclosure.

FIG. 19 is a diagram illustrating first to third virtual images provided by an electronic device, according to an embodiment of the disclosure, which vary depending on viewing positions of users.

FIG. 20 is a flowchart illustrating an operating method of an electronic device for performing calibration and detecting a user motion, according to an embodiment of the disclosure.

FIG. 21 is a diagram illustrating an operation in which an electronic device generates a transform matrix by performing calibration, according to an embodiment of the disclosure.

FIG. 22 is a diagram illustrating an operation in which an electronic device corrects a transform matrix based on detecting that a first condition is satisfied, according to an embodiment of the disclosure.

FIG. 23 is a diagram illustrating an operation in which an electronic device corrects a transform matrix based on detecting that a first condition is satisfied, according to an embodiment of the disclosure.

FIG. 24 is a diagram illustrating an operation in which an electronic device re-performs calibration based on detecting that a second condition is satisfied, according to an embodiment of the disclosure.

FIG. 25 is a diagram illustrating an operation in which an electronic device re-performs calibration based on detecting that a second condition is satisfied, according to an embodiment of the disclosure.

FIG. 26 is a diagram illustrating an operation in which an electronic device re-performs calibration based on detecting that a second condition is satisfied, according to an embodiment of the disclosure.

FIG. 27 is a flowchart illustrating a method, performed by an electronic device, of correcting or re-calibrating a transform matrix based on whether an intended user interface (UI) element is activated, according to an embodiment of the disclosure.

FIG. 28A is a diagram illustrating an operation in which an electronic device detects activation of an intended UI element according to an embodiment of the disclosure.

FIG. 28B is a diagram illustrating an operation in which an electronic device corrects a transform matrix based on a first offset, according to an embodiment of the disclosure.

FIG. 29A is a diagram illustrating an operation in which an electronic device fails to detect activation of an intended UI element, according to an embodiment of the disclosure.

FIG. 29B is a diagram illustrating an operation in which an electronic device corrects a transform matrix based on a second offset, according to an embodiment of the disclosure.

FIG. 29C is a diagram illustrating an operation in which an electronic device re-performs calibration based on a second offset, according to an embodiment of the disclosure.

### DETAILED DESCRIPTION

Although the terms used herein are selected from among common terms that are currently widely used in consideration of their functions in an embodiment of the disclosure, the terms may be different according to an intention of one of ordinary skill in the art, a precedent, or the advent of new technology. In addition, in particular cases, the terms are discretionally selected by the applicant of the disclosure, in which case, the meaning of those terms will be described in detail in the corresponding description of an embodiment of the disclosure. Therefore, the terms used herein are not merely designations of the terms, but the terms are defined based on the meaning of the terms and content throughout the disclosure.

As used herein, the singular forms “a,” “an,” and “the” may include the plural forms as well, unless the context clearly indicates otherwise. All the terms used in the present specification, including technical and scientific terms, may have the same meanings as those generally understood by one of skill in the art of the disclosure.

Each of expressions such as “A or B,” “at least one of A and B,” “at least one of A or B,” “A, B, or C,” “at least one of A, B, and C,” and “at least one of A, B, or C” herein may include any one of items listed together with the corresponding expression or all possible combinations of the same.

The expression “and/or” includes a combination of a plurality of described relevant elements or any one of the plurality of described relevant elements.

The terms such as “1st,” “2nd,” “first,” and “second” may be merely used to distinguish a corresponding element from other corresponding elements and do not limit the corresponding elements in terms of other aspects (e.g., the degree of importance or the order).

In addition, in the disclosure, when a part “includes” or “comprises” an element, unless there is a particular description contrary thereto, the part may further include other elements, not excluding the other elements. In addition, the terms such as “ . . . unit,” “module,” etc. used herein indicate a unit, which processes at least one function or operation, and the unit may be implemented by hardware or software, or by a combination of hardware and software.

The expression “configured to (or set to)” used in the disclosure may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some cases, the expression “system configured to . . . ” may mean that the system is “capable of . . . ” along with other devices or parts. For example, “a processor configured (or set) to perform A, B, and C” may imply a dedicated processor (e.g., an embedded processor) for performing a corresponding operation or a generic-purpose processor (e.g., central processing unit (CPU) or an application processor) capable of performing corresponding operations by executing one or more software programs stored in memory.

In addition, in the disclosure, it should be understood that when elements are “connected” or “coupled” to each other, the elements may be directly connected or coupled to each other, but may alternatively be connected or coupled to each other with an element therebetween, unless specified otherwise.

All functions or operations described in the disclosure may be processed individually by one processor and/or collectively by a plurality of processors. The one processor or a combination of the plurality of processors is circuitry that performs processing, and may include circuitry such as an application processor (AP), a communication processor (CP), a graphics processing unit (GPU), a natural processing unit (NPU), a microprocessor unit (MPU), a system on chip (SoC), an integrated chip (IC), etc.

It should be understood that blocks in each flowchart and combinations of flowcharts may be performed by one or more computer programs including computer-executable instructions. The one or more computer programs may be all stored in a single memory unit, or may be divided and stored in a plurality of different memory units.

An embodiment of the disclosure may be represented by functional block configurations and various processing operations. Some or all of the functional blocks may be implemented as various numbers of hardware and/or software configurations that execute specific functions. For example, the functional blocks of the disclosure may be implemented by one or more microprocessors or circuit configurations for a predetermined function. In addition, for example, the functional blocks of the disclosure may be implemented in various programming or scripting languages. The functional blocks may be implemented as algorithms executed in one or more processors. In addition, the disclosure may employ conventional technology for electronic environment setting, signal processing, and/or data processing.

Hereinafter, embodiments of the disclosure will be described in detail with reference to the accompanying drawings to allow one of skill in the art to easily carry out the embodiments. However, an embodiment of the disclosure may be embodied in many different forms and should not be construed as being limited to the embodiment of the disclosure set forth herein. In addition, in the drawings, parts irrelevant to the description are omitted to clearly describe an embodiment of the disclosure, and like elements are denoted by like reference numerals throughout the disclosure.

Hereinafter, embodiments of the disclosure will be described in detail with reference to the drawings.

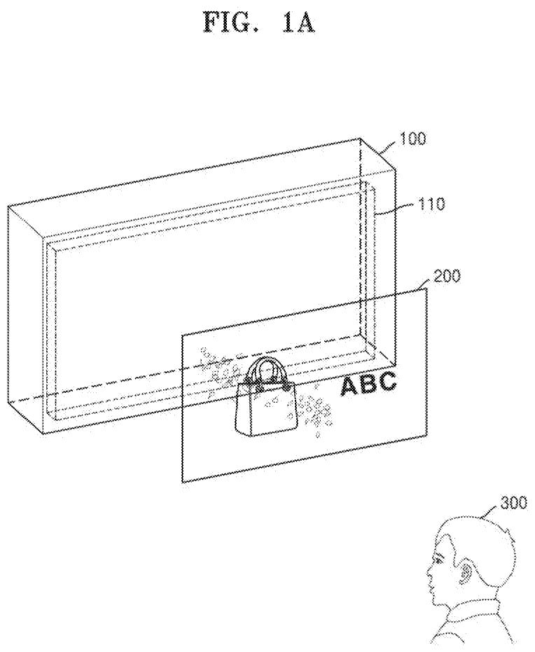

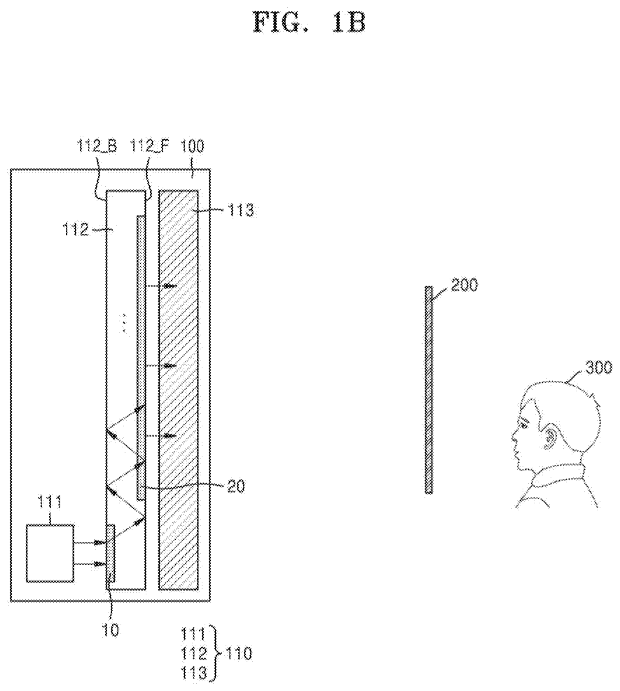

FIG. 1A is a diagram for describing an electronic device 100 according to an embodiment of the disclosure. FIG. 1B is a diagram for describing a display unit 110 of the electronic device 100 according to an embodiment of the disclosure.

Referring to FIG. 1A, the electronic device 100 according to an embodiment of the disclosure may be a device for providing an image 200 to a user 300.

In an embodiment of the disclosure, the electronic device 100 may be implemented as the electronic device 100 having various shapes such as a mobile device, a smartphone, a monitor (e.g., an interactive monitor), a laptop computer, a tablet personal computer (PC), a robot device, a head-up display, a wearable device, a head-mounted display (HVID) device, a digital signage, etc.

In an embodiment of the disclosure, the electronic device 100 may include the display unit 110. The electronic device 100 may display the image 200 through the display unit 110. In an embodiment of the disclosure, the image 200 provided by the electronic device 100 may be the virtual image 200 recognized as if floating in the air or space. In an embodiment of the disclosure, the virtual image 200 provided by the electronic device 100 may be perceived by the user 300 as if formed at a position on a three-dimensional (3D) space spaced apart from the electronic device 100 by a predetermined distance within a user's field of view. The virtual image 200 provided by the electronic device 100 may be recognized as an image spaced apart from the electronic device 100 and floating in the air, thereby providing a sense of 3D to the user 300.

Referring to FIG. 1B, in an embodiment of the disclosure, the electronic device 100 may include the display unit 110. In an embodiment of the disclosure, the display unit 110 may include an optical engine 111, a waveguide 112, and a lens 113.

The optical engine 111 may emit light containing an image input to the optical engine 111 toward the waveguide 112. The waveguide 112 may receive light projected from the optical engine 111. The light containing the image may be projected from the optical engine 111 toward the waveguide 112, and diffracted light that is diffracted within the waveguide 112 may be output toward the user 300 viewing the electronic device 100. Accordingly, the user 300 may observe the virtual image 200 through the waveguide 112.

The waveguide 112 may have a planar shape. The waveguide 112 may be formed in a single-layer or multi-layer structure in which light may propagate through internal reflection. In an embodiment of the disclosure, the waveguide 112 may include a first optical coupling area 10 and a second optical coupling area 20.

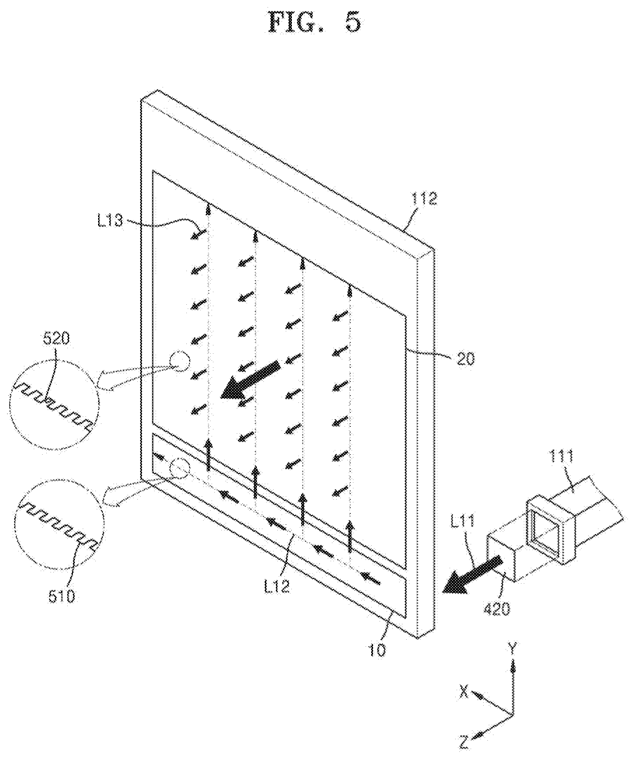

The first optical coupling area 10 may be located on one side of the waveguide 112. The first optical coupling area 10 may be located on a back surface 112_B of the waveguide 112 facing the optical engine 111. The waveguide 112 may be configured to input the light containing the image output from the optical engine 111 into the waveguide 112 through the first optical coupling area 10. In an embodiment of the disclosure, an optical element (e.g., diffraction grating) capable of inputting the light containing the image to the waveguide 112 may be disposed in the first optical coupling area 10. A detailed description of the first optical coupling area 10 will be provided below with reference to FIG. 5.

The light containing the image that is input to the waveguide 112 may propagate through total internal reflection inside the waveguide 112. The second optical coupling area 20 may be located on the other side of the waveguide 112. The second optical coupling area 20 may be located on a front surface 112_F of the waveguide 112 through which the light containing the image is output. The waveguide 112 may be configured to emit the light containing the image to the outside of the waveguide 112 through the second optical coupling area 20. In an embodiment of the disclosure, an optical element (e.g., diffraction grating) capable of outputting the light containing the image to the outside of the waveguide 112 may be disposed in the second optical coupling area 20. A detailed description of the second optical coupling area 20 will be provided below with reference to FIG. 5.

The lens 113 may be located on the front surface 112_F of the waveguide 112. The front surface 112_F of the waveguide 112 may correspond to an exit surface of the waveguide 112 through which the light containing the image is emitted to the outside. The front surface 112_F of the waveguide 112 may correspond to a surface that the user 300 directly views when using the electronic device 100. In the disclosure, the lens 113 being located on the front surface 112_F of the waveguide 112 means both the lens 113 being directly coupled (e.g., attached) to the front surface 112_F of the waveguide 112 and the lens 113 being spaced apart from the front surface 112_F of the waveguide 112 by a predetermined distance.

In an embodiment of the disclosure, the lens 113 may be directly coupled (e.g., attached) to the front surface 112_F of the waveguide 112. For example, the lens 113 may be coupled to the waveguide 112 through a transparent adhesive member.

In an embodiment of the disclosure, the lens 113 may be spaced apart from the front surface 112_F of the waveguide 112. The lens 113 may be disposed at a predetermined distance from the front surface 112_F of the waveguide 112. For example, the lens 113 may be spaced apart from the front surface 112_F of the waveguide 112 through a mechanical structure (e.g., a support structure) or an auxiliary member (e.g., a spacer).

In an embodiment of the disclosure, the lens 113 may be an optical element that refracts incident light rays and condenses the light rays onto a predetermined area. The lens 113 may generally include a transparent optical material. The lens 113 may have a curved shape with a curvature on one or both surfaces thereof or a refractive pattern equivalent to the curved shape to control the traveling direction of incident light. The lens 113 may refract light rays incident from the outside, so that the light rays that have passed through the lens 113 may be condensed onto a predetermined focal area.

According to an embodiment of the disclosure, the light containing the image emitted from the second optical coupling area 20 of the waveguide 112 may pass through the lens 113. The light containing the image may be refracted while passing through the lens 113, so that the refracted light rays may converge on a predetermined plane to form a substantial image. The image formed by passing through the lens 113 may be an image including optical information corresponding to the image output (or projected) from the optical engine 111. The image formed by passing through the lens 113 may be a real image.

A plane on which the substantial image is formed may be referred to as a virtual projection plane. The virtual projection plane may be formed in front of the light emission direction of the lens 113, that is, at a position separated from the lens 113 by a predetermined distance with respect to a direction in which the light rays that have passed through the lens 113 travel. The virtual projection plane may be formed in a space corresponding to the front of the electronic device 100. The virtual projection plane may be formed in a space between the user 300 viewing the electronic device 100 and the electronic device 100. The electronic device 100 may provide the virtual image 200 in which an input image is floating on the virtual projection plane through the lens 113.

In an embodiment of the disclosure, the lens 113 may be configured to focus light emitted through the second optical coupling area 20 as an inverted image on the virtual projection plane. The virtual image 200 formed on the virtual projection plane may correspond to an image inverted from the image output (or projected) from the optical engine 111.

According to an embodiment of the disclosure, the electronic device 100 may receive an image from the optical engine 111 through the waveguide 112 to emit light forward, and form an image floating at a specific position through the lens 113, thereby implementing the virtual image 200 with a sense of 3D or depth within the field of view of the user 300.

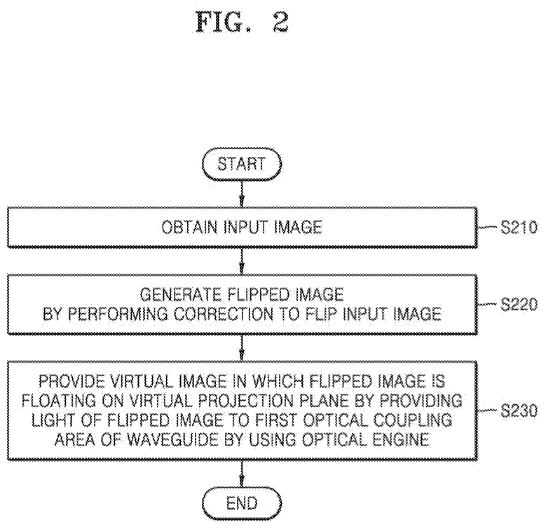

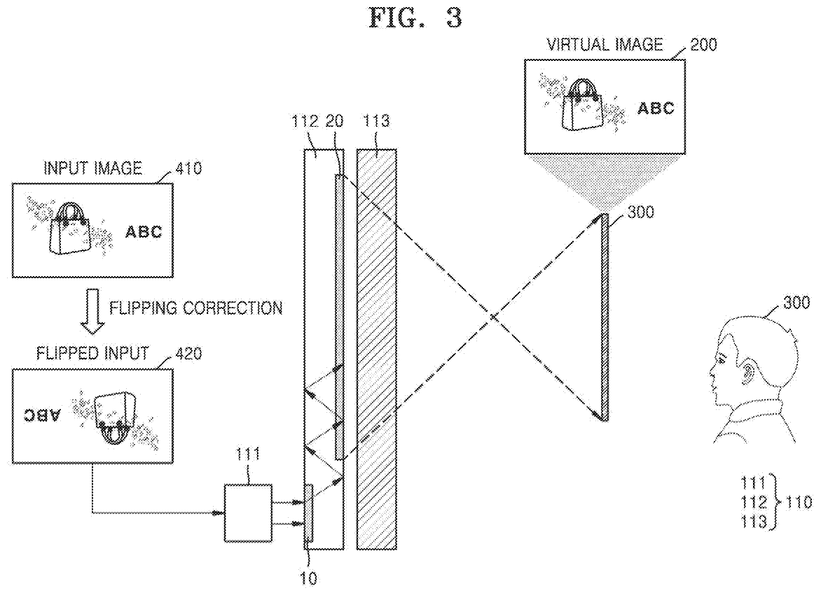

FIG. 2 is a flowchart illustrating a method of providing a virtual image through the electronic device 100 according to an embodiment of the disclosure. FIG. 3 is a diagram illustrating a method of operating the electronic device 100 according to an embodiment of the disclosure. For ease of description, descriptions that are redundant with those provided with reference to FIGS. 1A and 1B are simplified or omitted.

Referring to FIG. 2, a method of providing the virtual image through the electronic device 100 may include operations S210, S220, and S230. In an embodiment of the disclosure, operations S210, S220, and S230 may be executed by at least one processor included in the electronic device 100. The method of providing the virtual image is not limited to the method shown in FIG. 2, and in one or more embodiments of the disclosure, may further include an operation that is not shown in FIG. 2.

In operation S210 of FIG. 2, the electronic device 100 according to an embodiment of the disclosure may obtain an input image. The method of providing the virtual image according to an embodiment of the disclosure may include obtaining an input image.

In an embodiment of the disclosure, the input image may be not only a live image obtained by directly capturing a scene in the real world through a camera or an image sensor, but also an image generated through computer graphics (CG), animation, or other digital synthesis techniques. The input image may include not only real-time images collected through a physical image sensor, but also various types of digital image data received from an external device or system or loaded from a storage medium.

In an embodiment of the disclosure, the input image may include not only a static image including a single frame but also a dynamic image including a plurality of frames that continuously change over time. The static image refers to single image data captured or generated at one time, which may be, for example, a photo, a screenshot, or a rendered frame. The dynamic image refers to image data including sequentially arranged consecutive frames at regular time intervals, and may generally include a video, an animation, a simulation result image, or a real-time streaming image.

In an embodiment of the disclosure, the input image may be represented in RGB or grayscale format. An input image 410 may be represented in the form of a two-dimensional (2D) pixel arrangement, or may be represented in the form of a 3D arrangement including three channel information of red (R), green (G), and blue (B).

In operation S220 of FIG. 2, the electronic device 100 according to an embodiment of the disclosure may generate a flipped image by performing correction to flip the input image. The method of providing the virtual image according to an embodiment of the disclosure may include generating a flipped image by performing correction (e.g., comprising flipping the input image horizontally and vertically) to flip the input image.

Referring to FIG. 3 together, in an embodiment of the disclosure, by performing correction of horizontally flipping the input image 410 and perform correction of vertically flipping the input image 410, the electronic device 100 may generate a flipped image 420 that has been flipped horizontally and vertically from the input image 410.

Horizontal flip may be correction performed by flipping the position of a pixel with respect to the horizontal symmetry axis of an image. Horizontal flip may be transformation of changing each pixel within an image in a horizontal direction. Horizontal flip may be correction of reversing the horizontal order of pixels for each row of an image. For example, a pixel located at the left end of an image may be relocated to the right end, and a pixel located at the right end of the image may be relocated to the left end.

Vertical flip may be correction performed by flipping the position of a pixel with respect to the vertical symmetry axis of an image. Vertical flip may be transformation of changing each pixel within an in a vertical direction. Vertical flip may be correction of reversing the vertical order of pixels for each column of an image. For example, a pixel located at the upper end of an image may be relocated to the lower end, and a pixel located at the lower end, of the image may be relocated to the upper end.

In operation S230 of FIG. 2, the electronic device 100 according to an embodiment of the disclosure may provide the virtual image 200 in which the flipped image is floating on a virtual projection plane by providing light of a corrected image to the first optical coupling area 10 of the waveguide 112 by using the optical engine 111. The method of providing the virtual image according to an embodiment of the disclosure may include providing the virtual image 200 in which the flipped image is floating on a virtual projection plane by providing light of a corrected image to the first optical coupling area 10 of the waveguide 112 by using the optical engine 111.

Referring to FIG. 3 together, the optical engine 111 may receive the flipped image 420 on which correction has been performed from the input image 410. The electronic device 100 may transmit the flipped image 420 on which correction has been completed to the optical engine 111. The optical engine 111 may receive the flipped image 420 on which horizontal flip and vertical flip corrections have been performed and which have been horizontally and vertically flipped from the input image 410.

The optical engine 111 may provide light of the flipped image 420 (or light containing the flipped image 420) to the first optical coupling area 10 of the waveguide 112. The waveguide 112 may input the light of the flipped image 420 to the inside through the first optical coupling area 10. The light of the flipped image 420 incident into the waveguide 112 may propagate toward the second optical coupling area 20 through total internal reflection inside the waveguide 112. The waveguide 112 may emit the light of the flipped image 420 that has reached the second optical coupling area 20 to the outside through the second optical coupling area 20. A detailed description of a process in which the light of the flipped image 420 is incident on the waveguide 112 from the optical engine 111, propagates within the waveguide 112 and emitted to the outside will be provided below with reference to FIG. 5.

In an embodiment of the disclosure, the light of the flipped image 420 emitted through the second optical coupling area 20 of the waveguide 112 may pass through the lens 113. The light of the flipped image 420 may be refracted while passing through the lens 113 and condensed onto a virtual projection plane. The lens 113 may focus the light of the flipped image 420 onto the virtual projection plane as an inverted image. The light of the flipped image 420 may be horizontally and vertically flipped while passing through the lens 113 and focused onto the virtual projection plane. The virtual image 200 in a form that has been horizontally and vertically flipped from the flipped image 420 may be provided on the virtual projection plane.

According to an embodiment of the disclosure, by providing the light of the flipped image 420 from the optical engine 111 to the waveguide 112 after performing flip correction on the input image 410, the electronic device 100 may provide the virtual image 200 having the same form as the input image 410.

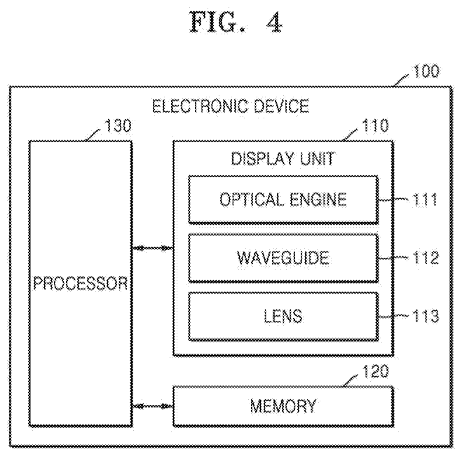

FIG. 4 is a block diagram of the electronic device 100 according to an embodiment of the disclosure.

Referring to FIG. 4, in an embodiment of the disclosure, the electronic device 100 may include the display unit 110, memory 120, and a processor 130. The electronic device 100 may be implemented with more elements than the elements shown in FIG. 4 or may be implemented with fewer elements than the shown elements. The display unit 110, the memory 120, and the processor 130 may be electrically and/or physically connected to each other. For ease of description, descriptions that are redundant with those provided with reference to FIGS. 1A, 1, 2, and 3 are simplified or omitted.

The display unit 110 may output information processed by the processor 130. For example, the display unit 110 may display a virtual object. In an embodiment of the disclosure, the display unit 110 may include the optical engine 111, the waveguide 112, and the lens 113.

The optical engine 111 may be configured to output light of a video (or an image) input to the optical engine 111. The optical engine 111 may be a micro projector using a 2D image panel or a scanning micro projector, but is not limited thereto. Information processing and image formation for the optical engine 111 may be performed directly by the processor 130 of the electronic device 100 itself, or may be performed by an external electronic device such as a smart phone, a tablet, a computer, a laptop computer, and all other intelligent (smart) devices to which the electronic device 100 is connected. Signal transmission between the electronic device 100 and the external electronic device may be performed through wired communication and/or wireless communication.

The optical engine 111 may include a light source that outputs light, an image panel that forms a 2D image by using the light output from the light source, and a projection optical system that projects light of the image formed by the image panel. The light source is an optical component that illuminates light, and may generate light by adjusting the color of RGB. The light source may be configured as, for example, a light emitting diode (LED). The image panel may be configured as a reflective image panel that reflects light illuminated by the light source while modulating the light into light containing the 2D image. The reflective image panel may be, for example, a digital micromirror device (DMD) panel, a liquid crystal on silicon (LCoS) panel, or another known reflective image panel.

The waveguide 112 may be configured to transmit light containing the video (or the image) output from the optical engine 111 to a user (e.g., a user's pupil). The waveguide 112 may have a planar shape. The waveguide 112 may be formed in a single-layer or multi-layer structure of a transparent material in which light may propagate through internal reflection. Here, the transparent material refers to a material through which light in a visible light band may pass, may not have the transparency of 100%, and may have a predetermined color. The waveguide 112 may face the exit surface of the optical engine 111 and receive the light output from the optical engine 111.

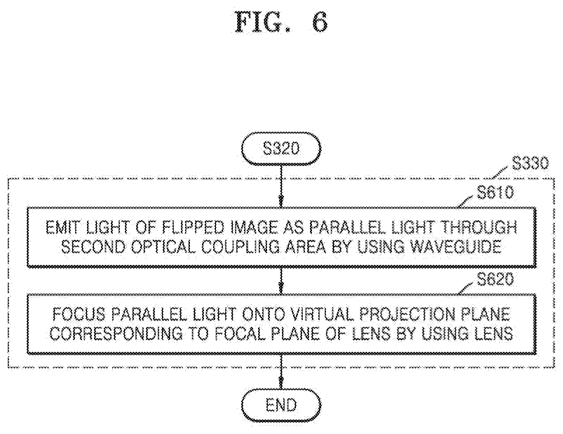

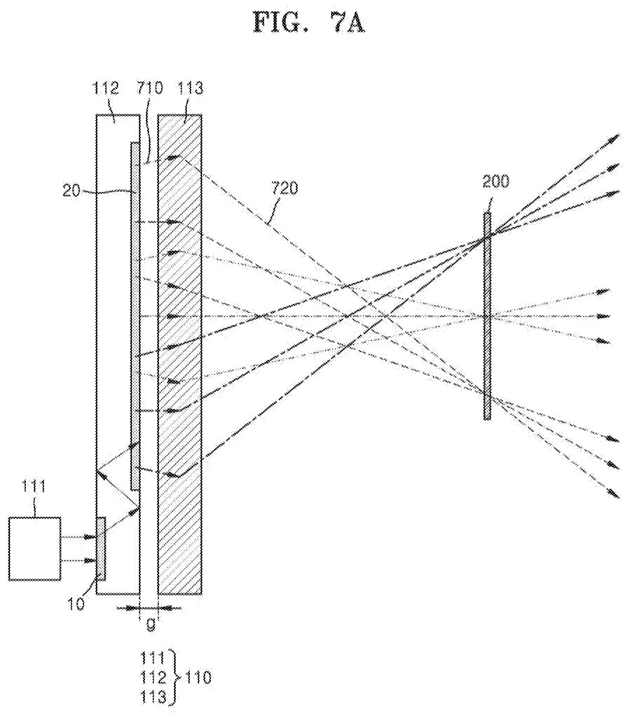

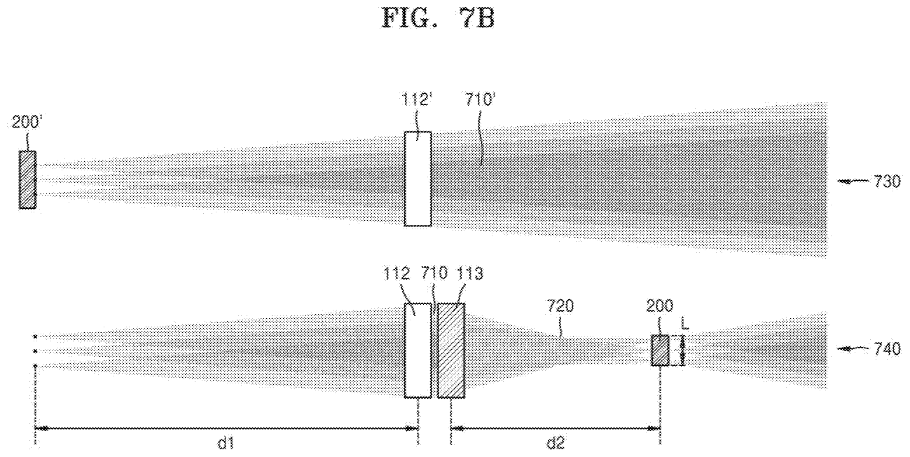

In an embodiment of the disclosure, the waveguide 112 may be configured to emit parallel light through the second optical coupling area 20. In more detail, the waveguide 112 may emit light of a flipped image input through the first optical coupling area 10 as parallel light through the second optical coupling area 20. Accordingly, the light of the flipped image emitted from the waveguide 112 may be incident on the lens 113 as parallel light. A detailed description in this regard will be provided below with reference to FIGS. 6, 7A, and 7B.

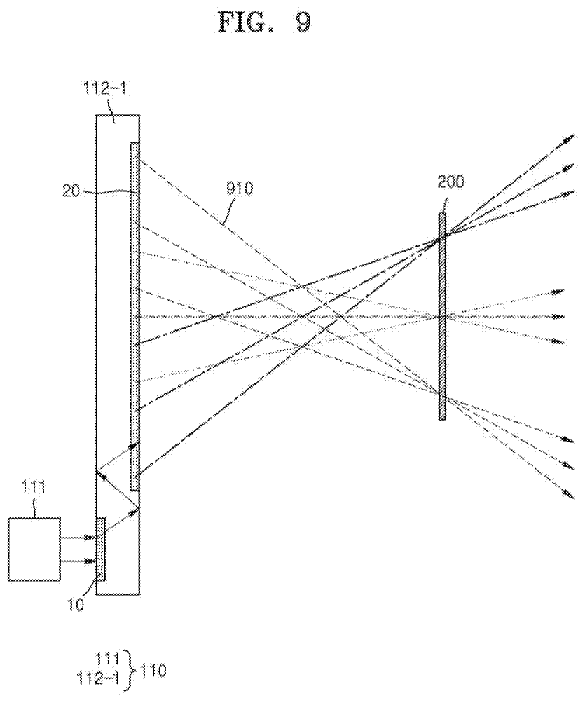

In an embodiment of the disclosure, the waveguide 112 may be configured to emit light focused onto a predetermined area through the second optical coupling area 20. In more detail, the waveguide 112 may emit the light of the flipped image input through the first optical coupling area 10 as light focused onto the predetermined area through the second optical coupling area 20. In this case, the waveguide 112 performs the function of the lens 113 together, and thus, the lens 113 may be omitted from the display unit 110. A detailed description in this regard will be provided below with reference to FIG. 9.

In an embodiment of the disclosure, the lens 113 may be an optical element that refracts incident light rays and condenses the light rays onto a predetermined area. The lens 113 may be an optical element that forms a focus or implements an image at a desired position by adjusting a path of light incident from the outside. The lens 113 may refract incident light and focus the incident light at a position corresponding to the focal length of the lens 113.

In an embodiment of the disclosure, the lens 113 may be a converging lens 113 configured to converge incident light. The converging lens 113 may be configured to focus light rays incident in parallel onto a predetermined point or area through internal refraction. For example, the converging lens 113 may implement the shape of a convex lens 113.

In an embodiment of the disclosure, the shape of the lens 113 does not necessarily need to be a continuous curved surface, and may be configured in a plurality of concentric circular steps or stepped shapes such as a Fresnel structure. The Fresnel lens 113 has the advantage of significantly reducing the thickness and weight of the lens 113 while maintaining an optical converging function. In addition, the lens 113 may be implemented in the form of a diffractive optical element (DOE) in which a minute refractive pattern is formed on a flat substrate.

According to an embodiment of the disclosure, the lens 113 is disposed on the front surface of the waveguide 112, and thus, the light of the image emitted from the waveguide 112 may be refracted while passing through the lens 113 and condensed onto a virtual projection plane. By forming a virtual image floating at a specific position by using the lens 113, the electronic device 100 may implement the virtual image with a sense of 3D or depth within the field of view of the user.

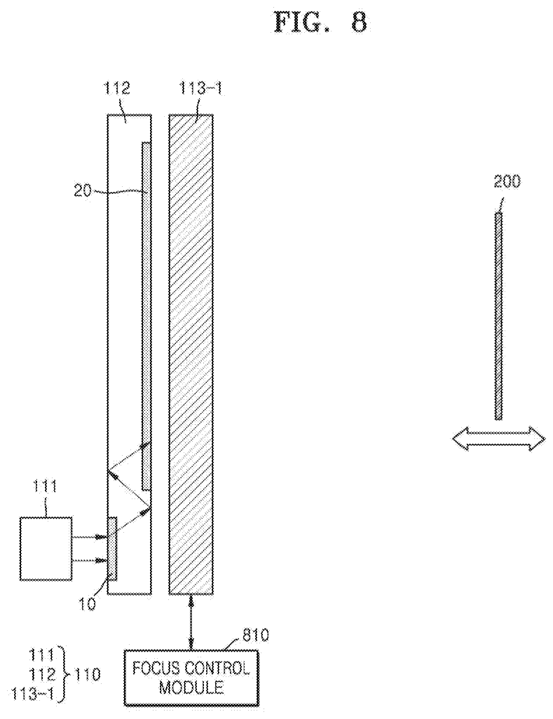

In an embodiment of the disclosure, the lens 113 may be configured to implement a variable focal length. By controlling the focal length of the lens 113, the electronic device 100 may control the position of a projection plane on which the virtual image is floating. Accordingly, the electronic device 100 may provide various senses of depth to the user 300, thereby providing a more improved sense of 3D. A detailed description in this regard will be provided below with reference to FIG. 8.

The processor 130 may execute one or more instructions of a program stored in the memory 120. The processor 130 may include hardware elements that perform arithmetic, logic, and input/output operations and image processing. FIG. 4 illustrates the processor 130 as one element, but the disclosure is not limited thereto. In an embodiment of the disclosure, the processor 130 may include one or more elements.

The processor 130 may include various processing circuitry and/or a plurality of processors 130. For example, the term ‘processor 130’ used in the disclosure, including the claims, may include various processing circuitry, including at least one processor 130. In the at least one processor 130, one or more processors 130 may be configured to perform the various functions described herein individually and/or collectively in a distributed form. As used in the disclosure, the ‘processor 130’, the ‘at least one processor 130’, and the ‘one or more processors 130’ may be configured to perform various functions. However, these terms cover, without limitation, a situation where one processor 130 may perform some of the functions and the other processor(s) 130 may perform the other functions, and a situation where a single processor 130 may perform all the functions. In addition, the at least one processor 130 may include a combination of the processors 130 that perform various functions of the functions disclosed in a distributed manner. The at least one processor 130 may execute program instructions to achieve or perform various functions.

In an embodiment of the disclosure, the processor 130 may store one or more instructions in the internally provided memory 120, and execute the one or more instructions stored in the internally provided memory 120 to control operations of the electronic device 100 to be performed. That is, the processor 130 may perform a predetermined operation by executing at least one instruction or program stored in the memory 120 internally provided in the processor 130 or in the memory 120.

For example, the processor 130 may be implemented as a general-purpose processor, such as a central processing unit (CPU), an application processor (AP), a digital signal processor (DSP), etc., a graphics-dedicated processor such as a graphic processing unit (GPU), and a graphic processing unit (VPU), or an artificial intelligence-dedicated processor such as a neural processing unit (NPU). The processor 130 may control to process input data according to a predefined operation rule or an artificial intelligence model. Alternatively, when the processor 130 is the artificial intelligence-dedicated processor, the artificial intelligence-dedicated processor may be designed in a hardware structure specialized for processing a specific artificial intelligence model.

For example, the memory 120 may be configured as at least one type of storage medium, such as flash memory-type memory, hard disk-type memory, multimedia card micro-type memory, card-type memory (e.g., SD or XD memory), random-access memory (RAM), static RAM (SRAM), read-only memory (ROM), electrically erasable programmable ROM (EEPROM), programmable ROM (PROM), or optical disk memory.

Instructions related to the function and/or operations of the electronic device 100 providing the virtual image may be stored in the memory 120. In an embodiment of the disclosure, at least one of instructions readable by the processor 130, algorithms, data structures, program codes, or application programs may be stored in the memory 120. The instructions, the algorithms, the data structures, and the program codes stored in the memory 120 may be implemented in a programming or scripting language such as C, C++, Java, and assembler.

The processor 130 may be implemented by executing the instructions or the program codes stored in the memory 120.

In an embodiment of the disclosure, at least one processor may individually or collectively execute instructions to cause the electronic device 100 to obtain an input image. The electronic device 100 may generate a flipped image by performing correction to flip the obtained input image. The electronic device 100 may provide light of the flipped image to a first optical coupling area of a waveguide by using an optical engine. The light of the flipped image incident into the waveguide through the first optical coupling area may be emitted to the outside of the waveguide through a second optical coupling area of the waveguide to pass through a lens, and thus, the electronic device 100 may provide the virtual image in which the input image is floating on a virtual projection plane.

FIG. 5 is a diagram for describing the optical engine 111 and the waveguide 112 according to an embodiment of the disclosure.

Referring to FIG. 5, in an embodiment of the disclosure, the waveguide 112 may include the first optical coupling area 10 and the second optical coupling area 20. The optical engine 111 may output light containing the flipped image 420 (see FIG. 4) in a Z direction toward the first optical coupling area 10 of the waveguide 112. For ease of description, the light of the flipped image 420 (see FIG. 4) output from the optical engine 111 is described as a first light L11 in FIG. 5. The first light L11 may be incident toward the first optical coupling area 10.

In an embodiment of the disclosure, a first optical element 510 may be disposed corresponding to the first optical coupling area 10 of the waveguide 112. The first optical element 510 may input the light output from the optical engine 111 to the waveguide 112. Accordingly, the waveguide 112 may allow the light output from the optical engine 111 through the first optical coupling area 10 to be incident into the waveguide 112. The first optical element 510 may be located on a back surface of the waveguide 112 facing the optical engine 111, a front surface facing the back surface, or inside the waveguide 112 (e.g., between layers in a multi-layer structure). The waveguide 112 may allow the first light L11 emitted from the optical engine 111 to be incident into the waveguide 112 through the first optical element 510 in the first optical coupling area 10.

The first optical element 510 may be configured to induce at least a part of the first light L11 emitted from the optical engine 111 toward the first optical coupling area 10 to escape from total reflection conditions and to be incident into the waveguide 112. For example, when the first light L11 reaches the first optical element 510, a +1st order beam diffracted by a predetermined angle compared to the incident light may be incident into the waveguide 112.

The first optical element 510 may include an input-coupler that diffracts light provided from the optical engine 111 and inputs the light into the waveguide 112. For example, the first optical element 510 may be a diffraction element that propagates light into the waveguide 112. The diffraction element may be implemented as a diffraction grating, a holographic optical element (HOE), a polymer dispersed liquid crystal (PDLC), a meta-surface, etc. In an embodiment of the disclosure, the first optical element 510 may be formed by being directly patterned on the surface of the waveguide 112, and in this case, the first optical element 510 may be implemented in a form integrated with the waveguide 112.

For ease of description, the first light L11 output from the optical engine 111 and incident through the first optical coupling area 10 in FIG. 5 is divided into a first light L12 propagating inside the waveguide 112 and a first light L13 emitted to the outside of the waveguide 112.

The first light L12 entering the waveguide 112 may propagate through total internal reflection inside the waveguide 112. The first light L12 propagating inside the waveguide 112 may travel along the waveguide 112 until reaching the second optical coupling area 20. For example, the first light L12 may propagate in the X direction, and the propagation path of the first light L12 may expand in the Y direction orthogonal to the X direction. In an embodiment of the disclosure, the propagation path of the first light L12 may expand not only in the Y direction but also in a direction crossing the X direction and the Y direction.

In an embodiment of the disclosure, an auxiliary optical element may be further disposed on the waveguide 112. The auxiliary optical element may be configured such that the first light L12 propagating in the waveguide 112 expands. The auxiliary optical element may be located between the first optical element 510 disposed in the first optical coupling area 10 and the second optical element 520 disposed in the second optical coupling area 20, may overlap the first optical element 510 in a partial area, or may overlap the second optical element 520 in a partial area. The auxiliary optical element may be configured such that the first light L12 propagating in the waveguide 112 travels toward the second optical coupling area 20. The auxiliary optical element may include a folding element that redirects input light toward the second optical coupling area 20 or an expanding element that expands the input light.

In an embodiment of the disclosure, the auxiliary optical element may be a diffraction element configured to change a traveling direction of light or expand input light. The diffraction element may be implemented as a diffraction grating, a HOE, a PDLC, a meta-surface, etc.

In an embodiment of the disclosure, the first light L12 may expand in the X direction through an auxiliary optical element (e.g., expanding element) and then be diffracted in the Y direction through an auxiliary optical element (e.g., folding element). The first light L12 may be diffracted in the Y direction and then expand in the Y direction through an auxiliary optical element (e.g., expanding element). The embodiment of the disclosure is not limited thereto, and the first light L12 may expand together in the X direction and the Y direction through an auxiliary optical element (e.g., expanding element). However, the function of the auxiliary optical element may be shared by the first optical element 510 or the second optical element 520 to be described below, and the technical idea of the disclosure is not limited thereto.

The first light L13 may be emitted to the outside of the waveguide 112 through the second optical coupling area 20. In an embodiment of the disclosure, the second optical element 520 may be disposed in the second optical coupling area 20 of the waveguide 112. The first light L12 propagating inside the waveguide 112 may be emitted to the outside of the waveguide 112 through the second optical element 520. The second optical element 520 may be located in a front surface corresponding to an exit surface from which the first light L12 is emitted to the outside, a back surface facing the front surface, or inside the waveguide 112 (e.g., between layers in a multi-layer structure). The waveguide 112 may emit the first light L12 propagating inside the waveguide 112 to the outside through the second optical element 520 in the second optical coupling area 20.

In an embodiment of the disclosure, the first optical element 510 and the second optical element 520 may be located on opposite surfaces of the waveguide 112. For example, the first optical element 510 may be located on the back surface of the waveguide 112, and the second optical element 520 may be located on the front surface of the waveguide 112. However, the embodiment of the disclosure is not limited thereto. For example, the first optical element 510 may be located on the front surface of the waveguide 112, and the second optical element 520 may be located on the back surface of the waveguide 112. Alternatively, for example, the first optical element 510 and the second optical element 520 may be located on the same surface (e.g., the back surface or the front surface) of the waveguide 112.

The second optical element 520 may include an output-coupler that diffracts light propagating into the waveguide 112 and outputs the light to the outside of the waveguide 112. The second optical element 520 may be a diffraction element configured to emit light propagating into the waveguide 112 to the outside. The diffraction element may be implemented as a diffraction grating, a HOE, a PDLC, a meta-surface, etc. In an embodiment of the disclosure, the second optical element 520 may be formed by being directly patterned on the surface of the waveguide 112, and in this case, the second optical element 520 may be implemented in a form integrated with the waveguide 112.

The second optical element 520 may be configured such that at least a part of internally propagating light deviates from total reflection conditions and is emitted to the outside. For example, when the first light L12 reaches the second optical element 520 (e.g., diffraction grating) while propagating inside the waveguide 112, a +1st order beam diffracted by a predetermined angle compared to the first light L12 may be emitted to the outside of the waveguide 112.

The first light L13 may be emitted forward of the waveguide 112 and then pass through the lens 113 (see FIG. 4) to be condensed onto a virtual projection plane. Accordingly, the electronic device 100 may provide the virtual image 200 floating on the virtual projection plane.

Hereinafter, various methods of implementing the waveguide 112 and the lens 113 in providing a virtual image on a virtual projection plane will be described with reference to FIGS. 6, 7A, 7B, 8, and 9.

FIG. 6 is a flowchart illustrating a method of providing a virtual image through the electronic device 100 according to an embodiment of the disclosure. FIG. 7A is a diagram for describing the waveguide 112 and the lens 113 according to an embodiment of the disclosure. FIG. 7B is a diagram for describing the waveguide 112 and the lens 113 according to an embodiment of the disclosure.

Referring to FIG. 6, a method of providing the virtual image 200 through the electronic device 100 may include operations S610 and S620. In an embodiment of the disclosure, operations S610 and S620 may be executed by at least one processor included in the electronic device 100. Operations S610 and S620 particularly specify operation S530 shown in FIG. 2.

In operation S610 of FIG. 6, the electronic device 100 according to an embodiment of the disclosure may emit light of a flipped image as parallel light 710 through the second optical coupling area 20 by using the waveguide 112. In operation S620 of FIG. 6, the electronic device 100 according to an embodiment of the disclosure may focus the parallel light 710 onto the virtual projection plane corresponding to a focal plane of the lens 113 by using the lens 113.

Referring to FIGS. 7A and 7B together, in an embodiment of the disclosure, the waveguide 112 may be configured to emit the parallel light 710 in the second optical coupling area 20. For example, a second optical element configured to emit the parallel light 710 may be disposed in the second optical coupling area 20 of the waveguide 112. The parallel light 710 may refer to light in which light rays travel parallel to each other and do not spread. In the ideal parallel light 710, all light rays may travel in the same direction. However, it is physically difficult to implement all light rays in the same direction up to an infinite distance, and in a real-world environment, the parallel light 710 may travel in the form of light with a very small divergence angle.

Although the waveguide 112 is theoretically configured to emit parallel light, FIG. 7A illustrates an example that light with a small divergence angle is emitted, in consideration of a real-world environment in which the electronic device 100 is used. The degree of light divergence is somewhat exaggerated in FIG. 7A, but in reality, the light may diverge at a very small divergence angle that is imperceptible to the naked eye.

In an embodiment of the disclosure, the lens 113 may be disposed to have a minimum gap g from the waveguide 112 in order to minimize distortion of the parallel light 710 emitted from the waveguide 112.

For example, the lens 113 may be disposed in a form directly attached to the front surface of the waveguide 112. In this case, even when light with a predetermined divergence angle is emitted from the waveguide 112, because space for the light to spread is not provided, the light may pass through the lens 13 with little divergence effect.

However, the embodiment of the disclosure is not limited thereto, and for example, the lens 113 may be spaced apart from the waveguide 112 by a predetermined distance. In this case, the light emitted from the exit surface of the waveguide 112 may gradually diverge until reaching the lens 113. As the lens 113 moves away from the waveguide 112, the degree of divergence of light reaching the lens 113 increases, and distorted light may be input to the lens 113. Accordingly, because it is not suitable for attaching the lens 113 directly to the waveguide 112, even when the lens 113 is spaced apart from the waveguide 112, it is necessary to design to minimize the gap g between the lens 113 and the waveguide 112.

FIG. 7B illustrates an optical path 730 in a structure in which only a waveguide 112′ implementing a parallel light 710′ is disposed and an optical path 740 in a structure in which the lens 113 is disposed in front of the waveguide 112 implementing the parallel light 710. In FIG. 7B, the waveguides 112 and 112′ are theoretically configured to emit parallel light 710 and 710′, respectively, but it is shown that somewhat diverging light is emitted in consideration of a real-world environment.

Because the waveguide 112′ has an infinite focus, when the waveguide 112′ alone provides a virtual image 200′, as shown in the optical path 730, the virtual image 200′ perceived as if located at a very long distance d1 close to an infinite distance toward the rear of the waveguide 112′ may be provided. The waveguide 112′ alone does not form an image that appears to be floating on the space between the electronic device 100 and the user 300, which may significantly reduce the degree of sense of distance or a 3D that the user 300 may feel.

On the other hand, when the lens 113 is disposed in front of the waveguide 112, the parallel light 710 emitted from the waveguide 112 may be condensed onto the virtual projection plane through the lens 113, and as shown in the optical path 740, and thus, the virtual image 200 located at a specific distance d2 in front of the waveguide 112 may be provided. The virtual image 200 may be perceived as if floating on the space between the electronic device 100 and the user 300, and provide a visual impression as if protruding forward from the electronic device 100, thereby providing an improved sense of 3D or distance.

In an embodiment of the disclosure, the virtual image 200 may be formed on a focal plane of the lens 113. The focal plane refers to a plane in which light converges or aggregates after passing through the lens 113, and an image of an object may be clearly formed on the corresponding plane. That is, the virtual projection plane on which the virtual image 200 is floating may coincide with the focal plane of the lens 113.

The focal plane of the lens 113 may be represented as Equation 2 below based on a lens formula (or lens equation) of Equation 1 below.

$$\frac{1}{f} = \frac{1}{{d}_{1}} + \frac{1}{{d}_{2}} \qquad [ Equation 1 ]$$

Here, f denotes a focal length of the lens 113, d1 denotes a distance to the object, and d2 denotes a distance to an image. Equation 1 may be represented as Equation 2.

$${d}_{2} = \frac{f \cdot {d}_{1}}{{d}_{1} - f} \qquad [ Equation 2 ]$$

In an embodiment of the disclosure, because the lens 113 receives the parallel light 710 from the waveguide 112, parallel light rays may be considered as being input as if the object is at infinity. Accordingly, Equation 2 may be organized by substituting infinity ∞ for a distance d₁ to the object, and a result of d₂=f may be derived. Accordingly, in an embodiment of the disclosure, the virtual image 200 may be provided by floating at a distance separated from the lens 113 by the focal length f of the lens 113. That is, the focal plane (or virtual projection plane) of the lens 113 may be formed at a position spaced apart from the optical center or principal point of the lens 113 by the focal length f of the lens 113.

In an embodiment of the disclosure, the size of the virtual image 200 may be derived through Equation 3 below.

$$L = 2 \cdot {d}_{2} \cdot tan \frac{θ}{2} = 2 \cdot f \cdot tan \frac{θ}{2} \qquad [ Equation 3 ]$$

Here, L denotes a height of the virtual image 200, and θ denotes a field of view (FOV) that may be implemented by the waveguide 112. The FOV that may be implemented by the waveguide 112 may be determined according to a design method such as a grating structure of the waveguide 112. Referring to Equation 3 above, in an embodiment of the disclosure, the size of the virtual image 200 may be controlled through the focal length f of the lens 113. Referring to Equation 3 above, in an embodiment of the disclosure, the size of the virtual image 200 may be controlled through the FOV that may be implemented by the waveguide 112. Accordingly, the size of the virtual image 200 may be controlled by changing detailed specifications of the waveguide 112 and/or the lens 113.

FIG. 8 is a diagram for describing the waveguide 112 and a lens 113-1 according to an embodiment of the disclosure. For ease of description, descriptions that are redundant with those provided with reference to FIGS. 1A, 1B, 2, 3, 4, 5, 6, 7A, and 7B are simplified or omitted.

Referring to FIG. 8, in an embodiment of the disclosure, the lens 113-1 may be configured to implement a variable focus length. The lens 113-1 (or variable focus lens) implementing the variable focal length may be an optical element capable of actively changing the focal length of the lens 113-1 according to an external stimulus (electricity, magnetism, heat, pressure, etc.)

In an embodiment of the disclosure, the variable focus lens may be implemented as a liquid crystal lens. The liquid crystal lens may be a lens in which the arrangement state of liquid crystal molecules changes according to an applied electric field or magnetic field. The liquid crystal lens may control the refractive index of the liquid crystal lens by controlling the orientation state of liquid crystal molecules within the liquid crystal lens through an applied electric field or magnetic field. Accordingly, the liquid crystal lens may have a focal length corresponding to the changed refractive index according to the applied electric field.

In an embodiment of the disclosure, the variable focus lens may be implemented by mechanically controlling the curvature of the lens. For example, the variable focus lens may be coupled with an actuator. The variable focus lens may include a flexible material (e.g., elastic body) having a changeable radius of curvature according to an external deformation force. The curvature of the lens may change by inducing mechanical deformation in the actuator and transmitting a deformation force generated in the actuator to the lens. For example, the actuator may be configured as a piezo actuator, a shape memory alloy (SMA) actuator, an electric actuator, a pneumatic actuator, etc., but the embodiment of the disclosure is not limited thereto.

In an embodiment of the disclosure, the variable focus lens may be implemented as a fluidic variable focus lens. The fluidic variable focus lens may use an interface between two fluids having different surface energies as an optical lens. The fluidic variable focus lens may change the curvature of the interface through fluid movement or fluid pressure control inside the lens, thereby actively controlling the focal length. For example, the fluidic variable focus lens may be configured as a combination of an optical fluid and a polymer membrane.

In an embodiment of the disclosure, the electronic device 100 may further include a focus control module 810 for controlling the focal length of the lens 113-1. The focus control module 810 may be an element that controls the optical characteristics of the lens 113-1, by providing a mechanical or electrical signal to the lens 113-1. For example, the focus control module 810 may be configured to apply an electric field or magnetic field to the lens 113-1 (e.g., liquid crystal lens). Alternatively, for example, the focus control module 810 may be implemented as an electronic driving device (e.g., actuator). Alternatively, for example, the focus control module 810 may be configured to adjust the fluid pressure of the lens 113-1 (e.g., fluidic variable focus lens).

The focus control module 810 may be linked with a controller to operate according to an external input. In an embodiment of the disclosure, the controller may generate a control signal for adjusting the focal length of the lens 113-1 based on an input (or command) of the user 300, an image processing result, or an output of a sensor. The generated control signal may be transmitted to the focus control module 810, and the focus control module 810 may change the focal length of the lens 113-1 based on the control signal.

In an embodiment of the disclosure, the electronic device 100 may control the focal length of the lens 113-1 through the lens 113-1 implementing the variable focal length, thereby changing a position of the focal plane of the lens 113-1 That is, the electronic device 100 may change a distance between the optical center or principal point of the lens 113-1 and the focal plane of the lens 113-1. Accordingly, the electronic device 100 may also change the position of the virtual projection plane on which the virtual image 200 is provided.

According to an embodiment of the disclosure, the electronic device 100 may variously control the floating position of the virtual image 200 by controlling the focal length of the lens 113-1. The electronic device 100 may change the virtual projection plane in a forward and backward direction, thereby providing various sense of depth to the user 300. For example, when the electronic device 100 changes the focal length of the lens 113-1 in real time while providing the virtual image 200, the user 300 may feel a sense of 3D similar to viewing a 3D object by changing the floating position of the virtual image 200 in real time.

According to an embodiment of the disclosure, the electronic device 100 may control the focal length of the lens 113-1 in a user-customized manner. For example, the floating position of the virtual image 200 may be dynamically adjusted according to the vision, viewing angle, or position of the user 300. Accordingly, the electronic device 100 may control the virtual image 200 to be provided at an optimal distance with respect to the viewing environment of the user 300.

In an embodiment of the disclosure, the electronic device 100 may receive an input of the user 300 with respect to a floating virtual image. For example, the electronic device 100 may provide a user interface (U) that may directly manipulate (e.g., virtual touch) a virtual image to a user. In this case, the electronic device 100 may control the focal length of the lens 113-1 according to the viewing position of the user 300, thereby implementing natural user interaction as if the user 300 physically touches the floating virtual image no matter where the user 300 views. In this case, even when the user 300 does not directly move the viewing position, the electronic device 100 may provide a function of aligning the actual position of a hand and the position of an image, thereby improving the precision of user interaction.

FIG. 9 is a diagram for describing a waveguide 112-1 according to an embodiment of the disclosure.

Referring to FIG. 9, in an embodiment of the disclosure, the waveguide 112-1 may be configured to emit light 910 focused onto a predetermined area in the second optical coupling area 20. For example, a second optical element configured to emit the focused light 910 may be disposed in the second optical coupling area 20 of the waveguide 112-1. Accordingly, the waveguide 112-1 may input light of a flipped image through the first optical coupling area 10 and output the light of the flipped image through the second optical coupling area 20, but output the light of the flipped image as the light 910 focused onto a virtual projection plane.

In an embodiment of the disclosure, the light of the flipped image may be diffracted while being emitted through the second optical coupling area 20 of the waveguide 112-1, and be condensed onto the virtual projection plane. The waveguide 112-1 may focus the light of the flipped image onto the virtual projection plane as an inverted image. Accordingly, the virtual image 200 that has been flipped horizontally and vertically from the flipped image may be provided on the virtual projection plane. That is, the virtual image 200 having the same shape as input image may be provided on the virtual projection plane.

According to an embodiment of the disclosure, the waveguide 112-1 may be designed to perform the functions of the lens 113 described with reference to FIGS. 6, 7A, and 7B. In this case, the lens 113 may be omitted from the display unit 110, and the virtual image 200 floating on the virtual projection plane may be provided through a combination of the optical engine 111 and the waveguide 112.

Hereinafter, a method, performed by the electronic device 100, of sensing a user reaction (e.g., gesture or body part) to implement a user interaction on a virtual image will be described.

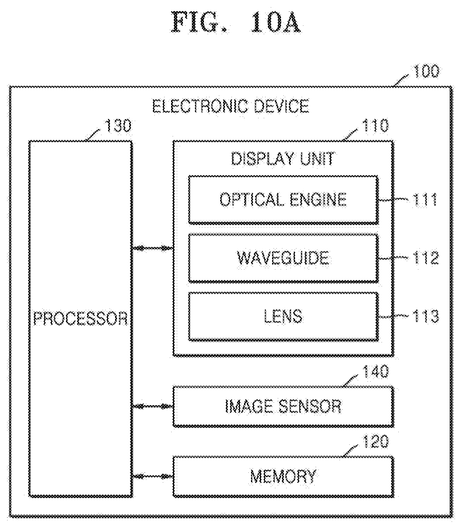

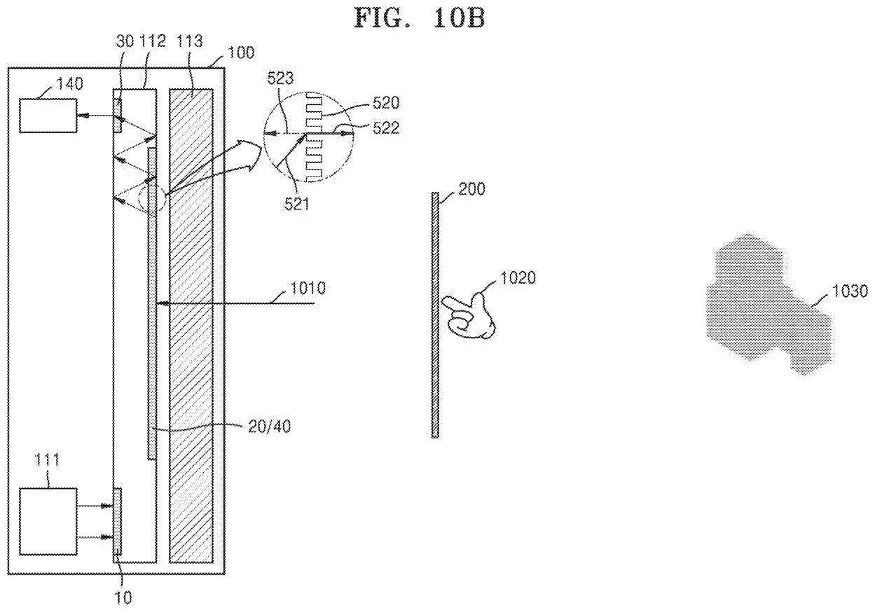

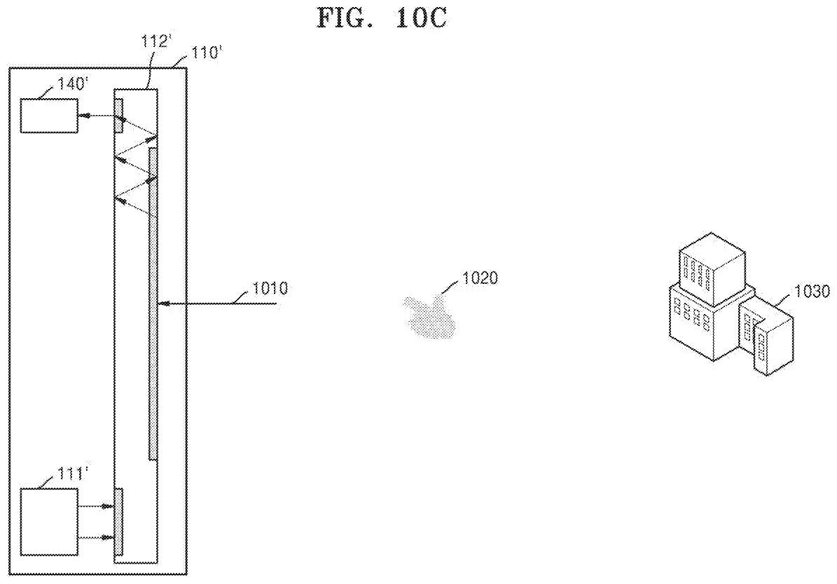

FIG. 10A is a block diagram of an electronic device 100 according to an embodiment of the disclosure. FIG. 10B is a diagram for describing an operation in which the electronic device 100 obtains an image of the real world according to an embodiment of the disclosure. FIG. 10C is a diagram for describing an operation in which an electronic device 100′ obtains an image of the real world according to a comparative example.

Referring to FIG. 10A, in an embodiment of the disclosure, the electronic device 100 may include the display unit 110, an image sensor 140, the memory 120, and the processor 130. The display unit 110 may include the optical engine 111, the waveguide 112, and the lens 113. The electronic device 100 may be implemented with more elements than the elements shown in FIG. 10A or may be implemented with fewer elements than the shown elements. The display unit 110, the image sensor 140, the memory 120, and the processor 130 may be electrically and/or physically connected to each other. Descriptions that are redundant with the components described with reference to FIGS. 1, 2, 3, 4, 5, 6, 7A, 7B, 8, and 9 are omitted, and differences will be mainly described.

The image sensor 140 may be an element or a device that receives light and converts the light into an electrical signal. The image sensor 140 may include a light receiving area including a plurality of pixels. The image sensor 140 may include a 2D light receiving area aggregated in the form of an array including the plurality of pixels arranged in a matrix. Each of the plurality of pixels may include at least one photoelectric conversion element. The image sensor 140 may detect light by using the photoelectric conversion element and output an image signal that is an electrical signal according to the detected light. The electronic device 100 may obtain an image by converting the light received through the image sensor 140 into an electrical signal. The image sensor 140 may be implemented as, for example, a charge-coupled device (CCD) or a complementary metal-oxide semiconductor (CMOS), but is not limited thereto.

Referring to FIG. 10B together, in an embodiment of the disclosure, the image sensor 140 may be configured to receive an external light 1010 transmitted through the waveguide 112. For example, the external light 1010 may include reflected light reflected by irradiating natural light (e.g., sunlight), artificial light (e.g., LED, fluorescent light, etc.), or other light sources to a subject (e.g., people, object, background, etc.) The external light 1010 may include visible light as well as infrared (IR) light.

In an embodiment of the disclosure, the waveguide 112 may be configured to allow the external light 1010 reaching toward the waveguide 112 to be incident into the waveguide 112. The external light 1010 incident into the waveguide 112 may propagate inside the waveguide 112. The waveguide 112 may be configured to emit the external light 1010 incident into the waveguide 112 to the image sensor 140. That is, the waveguide 112 may receive the external light 1010 and transmit the external light 1010 to the image sensor 140.

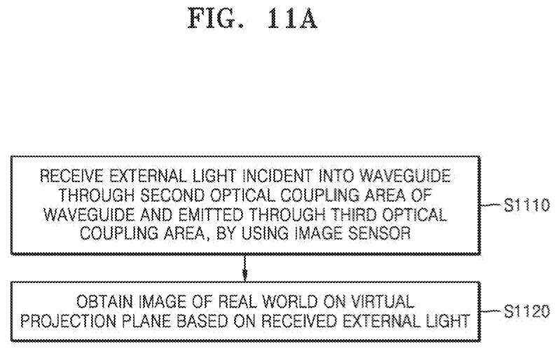

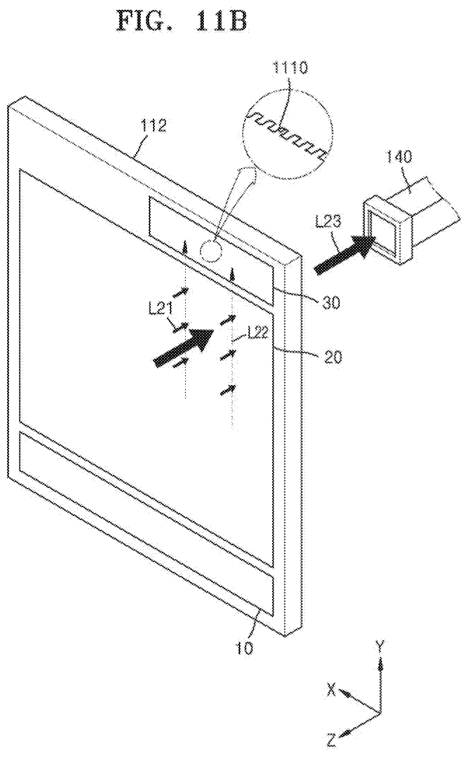

In an embodiment of the disclosure, the waveguide 112 may include the first optical coupling area 10, the second optical coupling area 20, and a third optical coupling area 30. The waveguide 112 may be configured to input thereinto light of a flipped image provided from the optical engine 111 through the first optical coupling area 10, and emit the light of the flipped image forward through the second optical coupling area 20. The waveguide 112 may be configured to input thereinto the external light 1010 reaching the second optical coupling area 20 through the second optical coupling area 20, and emit the external light 1010 to the image sensor 140 through the third optical coupling area 30. That is, according to an embodiment of the disclosure, the second optical coupling area 20 may be configured to output the light of the flipped image forward and simultaneously input the external light 1010 thereinto. A detailed description in this regard will be provided below with reference to FIGS. 11A and 11B.

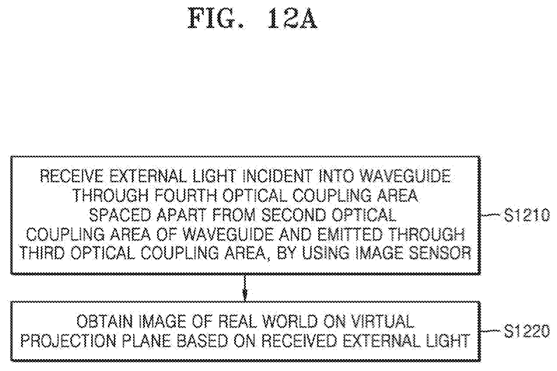

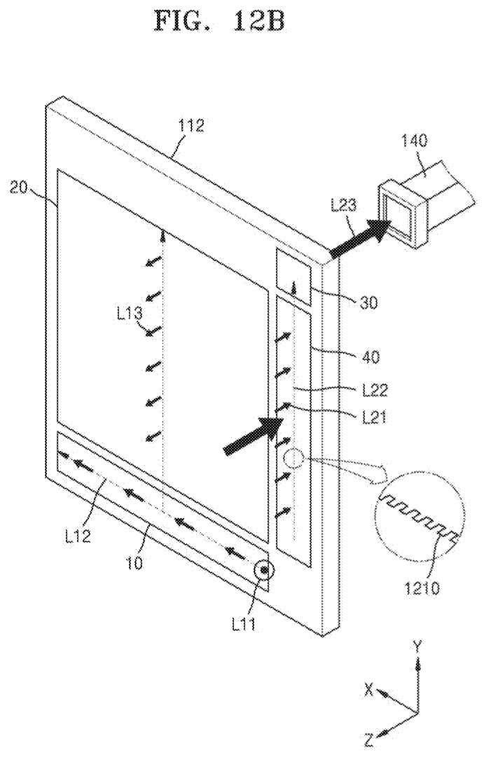

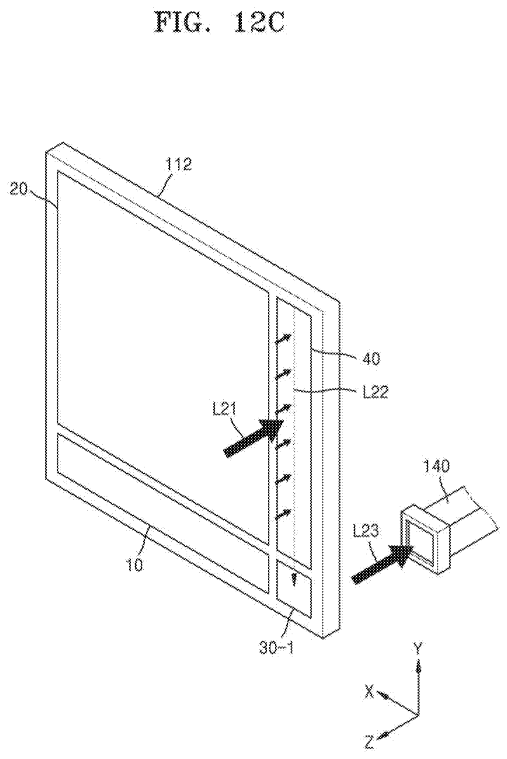

In an embodiment of the disclosure, the waveguide 112 may include the first optical coupling area 10, the second optical coupling area 20, the third optical coupling area 30, and a fourth optical coupling area 40. The waveguide 112 may be configured to input the light of the flipped image provided from the optical engine 111 through the first optical coupling area 10, and emit the light of the flipped image forward through the second optical coupling area 20. The waveguide 112 may be configured to input thereinto the external light 1010 reaching the second optical coupling area 20 through the fourth optical coupling area 40, and emit the external light 1010 to the image sensor 140 through the third optical coupling area 30. That is, according to an embodiment of the disclosure, the fourth optical coupling area 40 spaced apart from the second optical coupling area 20 may be provided to separate an area that emits the light of the flipped image from an area that inputs the external light 1010. A detailed description in this regard will be provided below with reference to FIGS. 12a, 12b, and 12c.

In an embodiment of the disclosure, the image sensor 140 may be located to face the back surface of the waveguide 112. For example, the image sensor 140 may be located to face the third optical coupling area 30 of the waveguide 112. The waveguide 112 may receive the external light 1010 that is incident through the waveguide 112 and propagates along the inside of the waveguide 112 from the rear. Accordingly, the image sensor 140 may receive the external light 1010 transmitted through the waveguide 112 even though not directly exposed to the outside of the electronic device 100. Accordingly, according to an embodiment of the disclosure, the electronic device 100 may be implemented such that the image sensor 140 is not perceived by the user 300. In addition, according to an embodiment of the disclosure, space required for implementing the image sensor 140 may be reduced compared to the image sensor 140 implemented in an externally exposed structure to directly receive the external light 1010. Accordingly, miniaturization and weight reduction of the electronic device 100 may be possible.

In an embodiment of the disclosure, the electronic device 100 may obtain the image of the real world by receiving the external light 1010 transmitted from the waveguide 112 through the image sensor 140. For example, the image of the real world may be image data obtained by receiving external light reflected from an object (e.g., person, object background, etc.) existing in real space. The image of the real world may include image data obtained by capturing a real space in front of the electronic device 100 providing the image. The image of the real world may include image data obtained by receiving external light reflected from a part of the user's body.

In an embodiment of the disclosure, the path of light (e.g., external light) passing through the lens 113 from an external space and incident on the waveguide 112 may correspond to inversely following the path of light (e.g., light of a flipped image) emitted from the waveguide 112, passing through the lens 113, and traveling to the external space. Accordingly, the electronic device 100 may obtain the image of the real world on a virtual projection plane. At this time, the image of the real world on the virtual projection plane may refer to an image in which a subject located on the virtual projection plane is focused so that the subject located on the virtual projection plane clearly appears, and subjects in other spaces gradually appear blurred further away from the virtual projection plane. This will be described in detail below.

In an embodiment of the disclosure, the second optical element 520 (e.g., diffraction grating, etc.) may be disposed in the second optical coupling area 20 of the waveguide 112. The second optical element 520 may be configured such that light propagating inside the waveguide 112 diffracted by the second optical element 520 and is emitted in a specific direction and is also emitted in a direction opposite to the specific direction at the same time. That is, light may be emitted in both directions in the second optical coupling area 20. For example, when a light 521 propagating inside may be diffracted by the second optical element 520 and a light 522 is emitted forward (+z direction), a light 523 may also be emitted backward (−z direction). For example, time-reversal symmetry may be applied to the waveguide 112 (or the second optical element 520). Time-reversal symmetry refers to the symmetry of physical laws to transformation that causes time to flow backward, and may mean that physical laws remain unchanged even when motion is flipped.

In an embodiment of the disclosure, a process in which the waveguide 112 receives the external light 1010 from the external space may correspond to reversely performing a process in which the waveguide 112 outputs the light of the flipped image to the external space. That is, an optical path in a process in which external light is refracted while passing through the lens 113 and is input into the inside through the second optical coupling area 20 may correspond to the reverse direction of an optical path in a process in which the light of the flipped image is emitted from the waveguide 112, refracted while passing through the lens 113, and forms an image on the projection plane (or the focal plane of the lens 113). The external light reflected from the subject located on the projection plane (or the focal plane of the lens 113) may be incident into the waveguide 112 by returning along the path of the light of the flipped image. Accordingly, the electronic device 100 may obtain the image of the real world on the virtual projection plane through the image sensor 140. In the image of the real world, the projection plane on which the virtual image 200 is floating may be focused, and the subject located on the projection plane on which the virtual image 200 is floating may clearly appear.

As shown in FIG. 10B, in an embodiment of the disclosure, the electronic device 100 may obtain the image of the real world by receiving the external light 1010 transmitted through the lens 113 and the waveguide 112 by using the image sensor 140. In the image of the real world based on the external light 1010 transmitted through the lens 113 and the waveguide 112, a hand 1020 located on the projection plane on which the virtual image 200 is floating may appear clearly, and a subject 1030 (e.g., background or building) located far away from the electronic device 100 may appear blurred.

On the other hand, as shown in FIG. 10C, when the electronic device 100′ uses only the waveguide 112′ to provide a virtual image or obtain the image of the real world, the waveguide 112′ may emit parallel light, so that the emitted light may travel up to an infinite distance. When the waveguide 112′ receives light containing the image from the optical engine 111′ and outputs the light forward, the virtual image perceived as if located at a very long distance close to the infinite distance toward the rear of the waveguide 112′ may be provided. At this time, when the image sensor 140′ receives the external light 1010 transmitted through the waveguide 112′, the electronic device 100′ may obtain the image of the real world in which the subject 1030 (e.g., background or building) located far away appears relatively clearly, and the hand 1020 located close appears blurred. In this case, considering that a user interaction with the virtual image mainly takes place near the virtual projection plane on which the virtual image is floating, it may be difficult to detect the user interaction (e.g., user gesture, etc.) with the image of the real world on which a subject located close to the projection plane appears blurred.

According to an embodiment of the disclosure, the electronic device 100 may include the lens 113 disposed on the front surface of the waveguide 112, thereby allowing the virtual image 200 to be floating on a predetermined projection plane, and simultaneously obtaining the image of the real world at a position where the virtual image 200 is floating. Accordingly, the electronic device 100 may easily recognize the user interaction (e.g., user gesture, etc.) with respect to the virtual image 200 based on the image of the real world.

According to an embodiment of the disclosure, the electronic device 100 may obtain (or sense) image information of the real world on the virtual projection plane without exposing a sensor to the outside, thereby minimizing user resistance and improving the aesthetics. In addition, according to an embodiment of the disclosure, the total volume of the electronic device 100 may be reduced, and miniaturization and weight reduction of the electronic device 100 may be possible, and thus, the electronic device 100 may provide a structure that is easy to commercialize.

Referring back to FIG. 10A, in an embodiment of the disclosure, a plurality of lenses 113 may be provided. The plurality of lenses 113 may include two or more lenses 113 having different focal lengths. That is, the plurality of lenses 113 may have focal planes formed at different positions. Accordingly, the electronic device 100 may obtain a plurality of images having different focal depths.

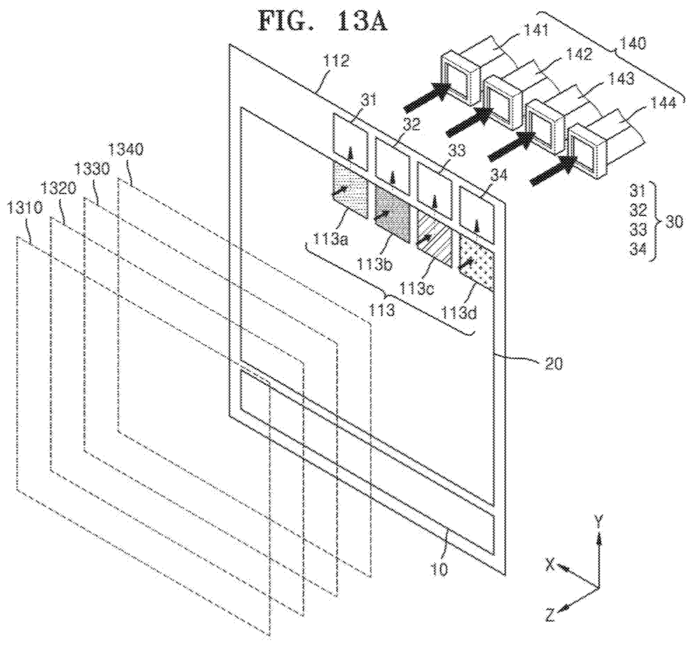

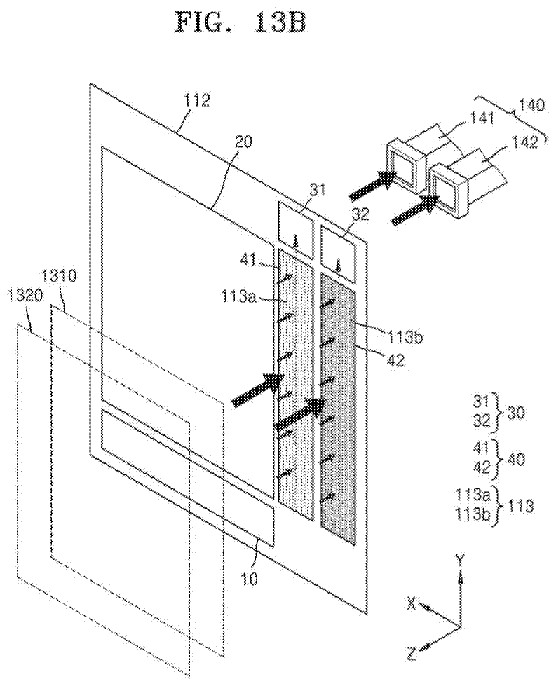

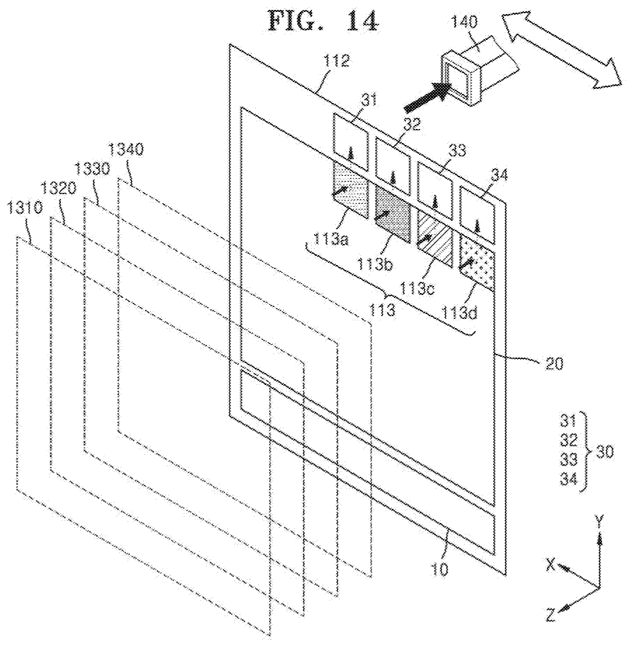

In an embodiment of the disclosure, a plurality of image sensors 140 may be provided. Each of the plurality of image sensors 140 may receive external light that has passed through the corresponding lens among the plurality of lenses 113 from the waveguide 112. The electronic device 100 may simultaneously obtain the plurality of images having different focal depths. The embodiment of the disclosure is not limited thereto, and the image sensor 140 may be implemented as a single image sensor to selectively receive external light that has passed through each of a plurality of different lenses (e.g., the first lens 113a, second lens 113b, third lens 113c, and fourth lens 113d) based on a time sequential method. A configuration including the plurality of lenses 113 and/or the plurality of image sensors 140 will be described below with reference to FIGS. 13A, 13B, and 14.

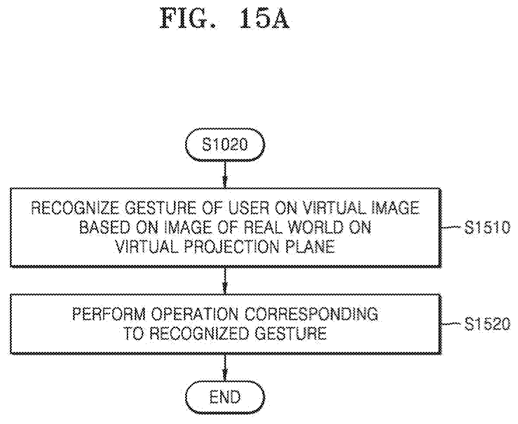

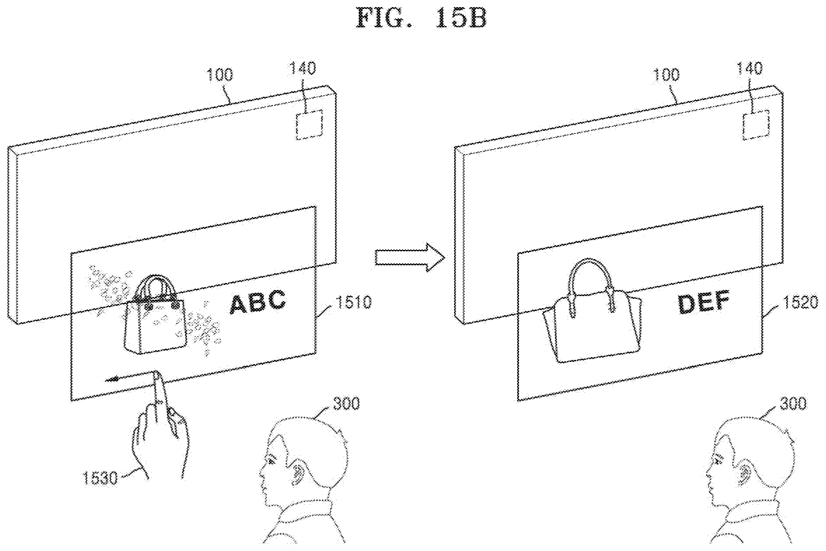

In an embodiment of the disclosure, the at least one processor 130 may individually or collectively execute instructions to cause the electronic device 100 to recognize a user gesture on the virtual image based on the image of the real world on the virtual projection plane. The electronic device 100 may perform an operation corresponding to the recognized gesture. A detailed description in this regard will be provided below with reference to FIGS. 15A and 15B.

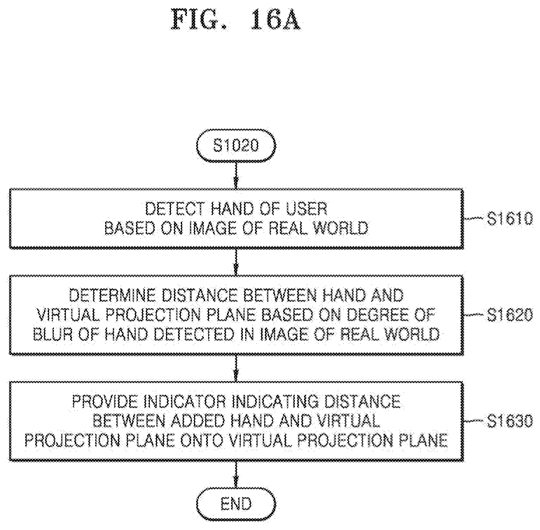

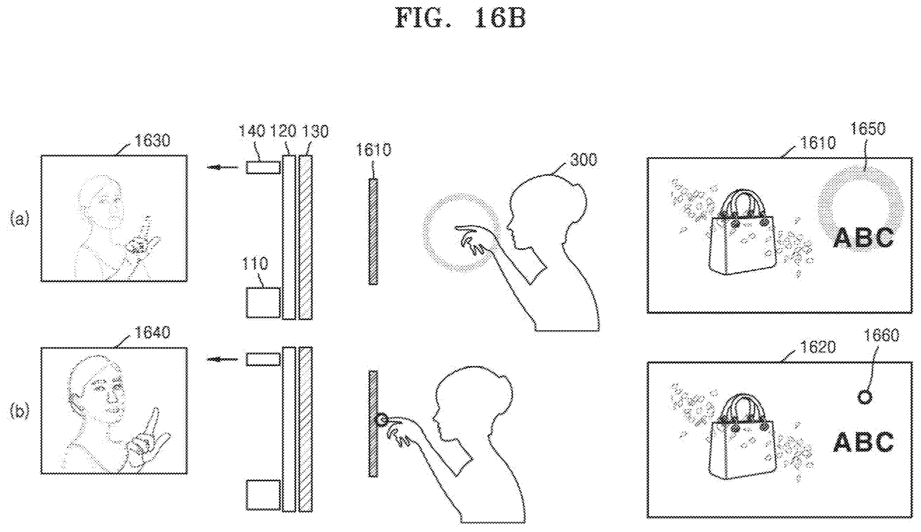

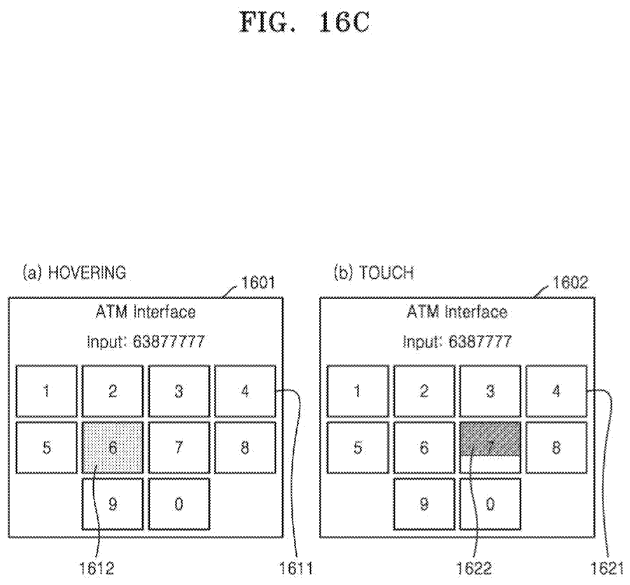

In an embodiment of the disclosure, the at least one processor 130 may individually or collectively execute instructions to cause the electronic device 100 to detect the user's hand based on the image of the real world. The electronic device 100 may determine a distance between the hand and the virtual projection plane based on the degree of blur of the hand detected in the image of the real world. The electronic device 100 may provide an indicator indicating a distance between the added hand and the virtual projection plane on the virtual projection plane. A detailed description in this regard will be provided below with reference to FIGS. 16A and 16B.

FIG. 11A is a flowchart illustrating an operating method of the electronic device 100 for obtaining an image of the real world by using the image sensor 140 according to an embodiment of the disclosure. FIG. 11B is a diagram for describing the waveguide 112 and the image sensor 140 according to an embodiment of the disclosure.

Referring to FIG. 11A, a method, performed by the electronic device 100, of providing a virtual image may further include operations S1110 and S1120. In an embodiment of the disclosure, operations S1110 and S1120 may be executed by the at least one processor 130 included in the electronic device 100. Operations S1110 and S1120 may be performed while operations S210 to S230 shown in FIG. 2 are performed (e.g., in parallel with one or more operations or before a previous operation is completed and a next operation starts), or may be performed before or after operations S210 to S230 are performed.

In operation S1110 of FIG. 11A, the electronic device 100 according to an embodiment of the disclosure may receive external light incident into the waveguide 112 through the second optical coupling area 20 of the waveguide 112 and emitted through the third optical coupling area 30, by using the image sensor 140.

Referring to FIG. 11B together, the waveguide 112 according to an embodiment of the disclosure may include the first optical coupling area 10, the second optical coupling area 20, and the third optical coupling area 30. Because a process in which the waveguide 112 allows the first light L11 of the flipped image 420 to be incident thereon through the first optical coupling area 10 and then emits the first light L11 of the flipped image 420 to the outside through the second optical coupling area 20 has been described in detail with reference to FIG. 5, a process in which an external light L21 is incident on the waveguide 112 and transmitted to the image sensor 140 will be described in detail with reference to FIGS. 11A and 11B. For ease of description, the external light L21 reaching the waveguide 112 is described as the second light L21 in FIG. 11B.

In an embodiment of the disclosure, the waveguide 112 may allow the second light L21 to be incident thereon through the second optical coupling area 20 and then emit the second light L21 to the outside through the third optical coupling area 30.

The second optical element 520 (see FIG. 5) may be disposed in the second optical coupling area 20. When the second light L21 reaches the second optical element 520 (see FIG. 5) (e.g., diffraction grating, etc.), the second light L21 may be diffracted by the second optical element 520 (see FIG. 5). For example, a +1st order beam diffracted by a predetermined angle compared to the incident light may be incident into the waveguide 112 by the second optical element 520 (see FIG. 5). In an embodiment of the disclosure, the second optical element 520 (see FIG. 5) may be configured to emit the first light L11 (see FIG. 5) that has internally propagated and reached, that is, light of the flipped image 420, to the outside, and simultaneously allow the second light L21 that has reached from the outside, that is, the external light, to be incident into the waveguide 112.

In an embodiment of the disclosure, the second optical element 520 (see FIG. 5) may include a bidirectional coupler that simultaneously performs a function of an output-coupler for outputting the first light L11 (see FIG. 5) to the outside and a function of an input-coupler for inputting the second light L21 to the inside.

A second light L22 entering the waveguide 112 may propagate through total internal reflection inside the waveguide 112. The second light L22 may propagate through total internal reflection inside the waveguide 112 toward the third optical coupling area 30. In an embodiment of the disclosure, the second light L22 may propagate through total internal reflection in the Y direction inside the waveguide 112.

In an embodiment of the disclosure, the third optical coupling area 30 may be located in the Y direction from the second optical coupling area 20 on a plane. The third optical coupling area 30 may be located in the propagation direction of light in the second optical coupling area 20. For example, as the input second light L22 propagates in the Y direction from the second optical coupling area 20, the third optical coupling area 30 may be located in the Y direction from the second optical coupling area 20.

In an embodiment of the disclosure, the third optical coupling area 30 may be disposed in a direction opposite to an arrangement direction from the second optical coupling area 20 to the first optical coupling area 10 on a plane. The third optical coupling area 30 may be located in the Y direction from the second optical coupling area 20 on a plane, and the first optical coupling area 10 may be located in a direction opposite to the Y direction from the second optical coupling area 20 on a plane.

In an embodiment of the disclosure, a third optical element 1110 may be disposed in the third optical coupling area 30 of the waveguide 112. The second light L22 propagating inside the waveguide 112 may be emitted to the outside of the waveguide 112 through the third optical element 1110. The third optical element 1110 may be located on a back surface facing the image sensor 140, a front surface facing the back surface, or inside the waveguide 112 (e.g., between layers in a multi-layer structure).

In an embodiment of the disclosure, the third optical element 1110 may be located on opposite surfaces of the second optical element 520 (see FIG. 5) and the waveguide 112, and may be located on the same surface of the first optical element 510 (see FIG. 5) and the waveguide 112. For example, the second optical element 520 (see FIG. 5) may be located on the front surface of the waveguide 112, and the first optical element 510 (see FIG. 5) and the third optical element 1110 may be located on the back surface of the waveguide 112. However, the embodiment of the disclosure is not limited thereto. For example, the third optical element 1110 may be located on the back surface of the waveguide 112. Alternatively, for example, the third optical element 1110 may be located on the same surface (e.g., back surface or front surface) of the second optical element 520 (see FIG. 5) and the waveguide 112.

The third optical element 1110 may include an output-coupler that diffracts light propagating into the waveguide 112 and outputs the light to the outside of the waveguide 112. The third optical element 1110 may be a diffraction element configured to emit the light propagating into the waveguide 112 to the outside. The diffraction element may be implemented as a diffraction grating, a HOE, a PDLC, a meta-surface, etc. In an embodiment of the disclosure, the third optical element 1110 may be formed by being directly patterned on the surface of the waveguide 112, and in this case, the third optical element 1110 may be implemented in a form integrated with the waveguide 112.

The third optical element 1110 may be disposed (or configured) to emit the second light L22 internally propagating from the waveguide 112 toward the image sensor 140. The second light L23 emitted from the waveguide 112 through the third optical element 1110 may be received by the image sensor 140.

In operation S1120 of FIG. 11A, the electronic device 100 according to an embodiment of the disclosure may obtain the image of the real world on a virtual projection plane based on the received external light.

In an embodiment of the disclosure, the external light input to the waveguide 112 may correspond to light that passes through the lens 113 located in the front surface of the waveguide 112 and reaches the second optical coupling area 20. Accordingly, the electronic device 100 may obtain the image of the real world on the virtual projection plane on which the virtual image is floating, that is, the focal plane of the lens 113. In more detail, the electronic device 100 may obtain the image of the real world in which an image of a subject located on the virtual projection plane is clearly formed.

On the other hand, FIG. 11B shows an example that the third optical coupling area 30 is disposed not to overlap the second optical coupling area 20, but the embodiment of the disclosure is not limited thereto. The second optical coupling area 20 and the third optical coupling area 30 may be located on opposite surfaces, respectively, and the third optical coupling area 30 may be disposed to overlap a part of the second optical coupling area 20.

FIG. 12A is a flowchart illustrating a method of operating the electronic device 100 for obtaining an image of the real world by using the image sensor 140 according to an embodiment of the disclosure. FIG. 12B is a diagram for describing the waveguide 112 and the image sensor 140 according to an embodiment of the disclosure. FIG. 12C is a diagram for describing the waveguide 112 and the image sensor 140 according to an embodiment of the disclosure.

Referring to FIG. 12A, a method, performed by the electronic device 100, of providing a virtual image may further include operations S1210 and S1220. In an embodiment of the disclosure, operations S1210 and S1220 may be executed by the at least one processor 130 included in the electronic device 100. Operations S1210 and S1220 may be performed while operations S210 to S230 shown in FIG. 2 are performed (e.g., in parallel with one or more operations or before a previous operation is completed and a next operation starts), or may be performed before or after operations S210 to S230 are performed.

In operation S1210 of FIG. 12A, the electronic device 100 according to an embodiment of the disclosure may receive external light incident into the waveguide 112 through the fourth optical coupling area 40 spaced apart from the second optical coupling area 20 of the waveguide 112 and emitted through the third optical coupling area 30, by using the image sensor 140.

Referring to FIGS. 12B and 12C together, the waveguide 112 may include the first optical coupling area 10, the second optical coupling area 20, the third optical coupling area 30, and the fourth optical coupling area 40. Because a process in which the waveguide 112 allows the first light L11 to be incident thereon through the first optical coupling area 10 and then emits the first light L11 to the outside through the second optical coupling area 20 has been described in detail with reference to FIG. 5, a process in which the external light L21 is incident on the waveguide 112 and transmitted to the image sensor 140 will be described in detail with reference to FIGS. 12A, 12B, and 12C. For ease of description, the external light L21 reaching the waveguide 112 is described as the second light L21 in FIG. 12B.

In an embodiment of the disclosure, the waveguide 112 may allow the second light L21 to be incident thereon through the fourth optical coupling area 40 and then emit the second light L23 to the outside through the third optical coupling area 30.

In an embodiment of the disclosure, the fourth optical coupling area 40 may be spaced apart from the second optical coupling area 20. As the fourth optical coupling area 40 is spaced apart from the second optical coupling area 20, a path for inputting the second light L21 to the inside and outputting the second light L21 to the image sensor 140 and a path for inputting the first light L11 to the inside and outputting the first light L11 to the front may be independently formed so as not to interfere with or overlap each other. Accordingly, noise caused by interference between the first light L12 and the second light L22 may be blocked or reduced.

In an embodiment of the disclosure, a fourth optical element 1210 may be disposed corresponding to the fourth optical coupling area 40 of the waveguide 112. When the second light L21 reaches the fourth optical element 1210, the second light L21 may be diffracted by the fourth optical element 1210. For example, a +1st order beam diffracted by a predetermined angle compared to the incident light may be incident into the waveguide 112 by the fourth optical element 1210. The waveguide 112 may allow the second light L21 reached through the fourth optical coupling area 40 to be incident into the waveguide 112. The fourth optical element 1210 may be located on a back surface of the waveguide 112 facing the image sensor 140, a front surface facing the back surface, or inside the waveguide 112 (e.g., between layers in a multi-layer structure).

The fourth optical element 1210 may include an input-coupler for diffracting the second light L21 and inputting the diffracted second light L21 into the waveguide 112. For example, the fourth optical element 1210 may be a diffraction element that propagates light into the waveguide 112. The diffraction element may be implemented as a diffraction grating, a HOE, a PDLC, a meta-surface, etc. In an embodiment of the disclosure, the fourth optical element 1210 may be formed by being directly patterned on the surface of the waveguide 112, and in this case, the fourth optical element 1210 may be implemented in a form integrated with the waveguide 112.

The second light L22 entering the waveguide 112 may propagate through total internal reflection inside the waveguide 112. The second light L22 may propagate through total internal reflection inside the waveguide 112 toward the third optical coupling area 30.

In an embodiment of the disclosure, as shown in FIG. 12B, the third optical coupling area 30 may be located in the Y direction from the second optical coupling area 20 on a plane. The waveguide 112 may be configured such that the input second light L22 is totally reflected in the Y direction in the fourth optical coupling area 40 and propagates toward the third optical coupling area 30. The third optical coupling area 30 may be spaced apart from the first optical coupling area 10 in the Y direction with the second optical coupling area 20 and the fourth optical coupling area 40 disposed therebetween.

In an embodiment of the disclosure, as shown in FIG. 12C, the third optical coupling area 30 may be located in a direction opposite to the Y direction from the second optical coupling area 20 on a plane. The waveguide 112 may be configured such that the second light L21 is input from the fourth optical coupling area 40, is totally reflected in a direction opposite to the Y direction, and propagates toward the third optical coupling area 30. The third optical coupling area 30 may be disposed in parallel with the first optical coupling area 10 in the X direction.

In an embodiment of the disclosure, an auxiliary optical element for expanding the second light L22 propagating in the waveguide 112 may be further disposed in the waveguide 112. The auxiliary optical element may be located between the fourth optical element 1210 disposed in the fourth optical coupling area 40 and the third optical element 1110 (see FIG. 111B) disposed in the third optical coupling area 30, may overlap the fourth optical element 1210 in a partial area, or may overlap the third optical element 1110 (see FIG. 111B) in a partial area. The auxiliary optical element may be configured such that the second light L22 propagating in the waveguide 112 travels toward the third optical coupling area 30. The auxiliary optical element may include a folding element that redirects the input second light L22 toward the fourth optical coupling area 40 or an expanding element that expands the input second light L22.

The third optical element 1110 (see FIG. 111B) may be disposed in the third optical coupling area 30 of the waveguide 112. The second light L22 propagating inside the waveguide 112 may be emitted to the outside of the waveguide 112 through the third optical element 1110 (see FIG. 11B). The third optical element 1110 (see FIG. 111B) has been described in detail with reference to FIG. 111B, and thus a description thereof is omitted.

The second light L23 emitted from the waveguide 112 through the third optical element 1110 (see FIG. 111B) may be received by the image sensor 140. The third optical element 1110 (see FIG. 111B) may be disposed (or configured) to emit the second light L22 internally propagating from the waveguide 112 toward the image sensor 140.

In operation S1220 of FIG. 12A, the electronic device 100 according to an embodiment of the disclosure may obtain the image of the real world on a virtual projection plane based on the external light received through the image sensor 140. According to an embodiment of the disclosure, a path for inputting the second light L21 to the inside and outputting the second light L21 to the image sensor 140 and a path for inputting the first light L11 to the inside and outputting the first light L11 to the front are independently formed, and thus, the image sensor 140 may receive external light in which interference with light containing an image is blocked or reduced. Accordingly, the electronic device 100 may obtain the image of the real world with a reduced signal-to-noise ratio (SNR) and improved quality. Operation S1220 has been described in detail with reference to operation S1120 of FIG. 11A and FIG. 11B, and thus, a description thereof is omitted.

FIG. 13A is a diagram for describing the waveguide 112 and the image sensor 140 according to an embodiment of the disclosure.

Referring to FIG. 13A, in an embodiment of the disclosure, a plurality of lenses 113 may be provided. The plurality of lenses 113 may include two or more lenses 113 having different focal lengths. For example, the plurality of lenses 113 may include the first lens 113a having a first focal length and the second lens 113b having a second focal length different from the first focal length. The plurality of lenses 113 may include the third lens 113c having a third focal length different from the first and second focal lengths, and the fourth lens 113d having a fourth focal length different from the first to third focal lengths. However, the number of the plurality of lenses 113 is not limited to any one embodiment of the disclosure, and the number of the plurality of lenses 113 may be less than four or more than four.

The waveguide 112 may input external light to the inside through the second optical coupling area 20. In an embodiment of the disclosure, the plurality of lenses 113 may overlap the second optical coupling area 20 of the waveguide 112. The external light that have passed through the plurality of lenses 113 (e.g., the first lens 113a, the second lens 113b, the third lens 113c, and the fourth lens 113d) and reached the second optical coupling area 20 may be input into the waveguide 112 through the second optical coupling area 20 (or second optical element).

The plurality of lenses 113 may overlap different areas of the fourth optical coupling area 40. For example, the first lens 113a may overlap a part of the second optical coupling area 20, and the second lens 113b may overlap another part of the second optical coupling area 20. The third lens 113c and the fourth lens 113d may also overlap different parts of the second optical coupling area 20.

In an embodiment of the disclosure, the third optical coupling area 30 may include sub-areas respectively corresponding to the plurality of lenses 113. For example, the third optical coupling area 30 may include a first sub-area 31 that emits the external light that has passed through the first lens 113a, a second sub-area 32 that emits the external light that has passed through the second lens 113b, a third sub-area 33 that emits the external light that has passed through the third lens 113c, and a fourth sub-area 34 that emits the external light that has passed through the fourth lens 113d.

In an embodiment of the disclosure, a plurality of image sensors 140 may be provided. Each of the plurality of image sensors 140 may receive the external light that has passed through the corresponding lens among the plurality of lenses 113 from the waveguide 112. For example, the plurality of image sensors 140 may include a first image sensor 141 that receives the external light emitted from the first sub-area 31, a second image sensor 142 that receives the external light emitted from the second sub-area 32, a third image sensor 143 that receives the external light emitted from the third sub-area 33, and a fourth image sensor 144 that receives the external light emitted from the fourth sub-area 34.

The first image sensor 141 may receive the external light that has passed through the first lens 113a and then input into the waveguide 112 and output through the first sub-area 31. The electronic device 100 may obtain a first image of the real world on a first focal plane 1310 corresponding to the first focal length through the external light received through the first image sensor 141.

The second image sensor 142 may receive the external light that has passed through the second lens 113b and then input into the waveguide 112 and output through the second sub-area 32. The electronic device 100 may obtain a second image of the real world on a second focal plane 1320 corresponding to the second focal length through the external light obtained through the second image sensor 142.

The third image sensor 143 may receive the external light that has passed through the third lens 113c and then input into the waveguide 112 and output through the first sub-area 31. The electronic device 100 may obtain a third image of the real world on a third focal plane 1330 corresponding to the third focal length through the external light obtained through the third image sensor 143.

The fourth image sensor 144 may receive the external light that has passed through the fourth lens 113d and then input into the waveguide 112 and output through the first sub-area 31. The electronic device 100 may obtain a fourth image of the real world on a fourth focal plane 1340 corresponding to the fourth focal length through the external light obtained through the fourth image sensor 144.

In an embodiment of the disclosure, by receiving external light using the lenses 113 having different focal lengths, the electronic device 100 may obtain a plurality of images having different focal depths. A first image may be an image of the real world in which an image of a subject located on the first focal plane 1310 is clearly formed. A second image may be an image of the real world in which an image of a subject located on the second focal plane 1320 at a different position from the first focal plane 1310 is clearly formed. A third image may be an image of the real world in which an image of a subject located on the third focal plane 1330 at a different position from the first focal plane 1310 and the second focal plane 1320 is clearly formed. A fourth image may be an image of the real world in which an image of a subject located on the fourth focal plane 1340 at a different position from the first focal plane 1310, the second focal plane 1320, and the third focal plane 1330 is clearly formed.

In an embodiment of the disclosure, any one of the first focal plane 1310, the second focal plane 1320, the third focal plane 1330, and the fourth focal plane 1340 may correspond to a virtual projection plane. Assuming that the fourth focal plane 1340 corresponds to the virtual projection plane, a virtual image may be provided on the fourth focal plane 1340. In this case, the first lens 113a, the second lens 113b, and the third lens 113c may locally overlap a part of the second optical coupling area 20, and the fourth lens 113d may overlap most of the second optical coupling area 20 excluding a part where the second lens 113b, the third lens 113c, and the fourth lens 113d are disposed.

According to an embodiment of the disclosure, the electronic device 100 may simultaneously obtain a plurality of images having different focal depths. That is, the electronic device 100 may obtain image information focused on subjects located at various distances. Accordingly, even when the user 300 performs a gesture at a distance slightly spaced apart from the virtual projection plane on which the virtual image is floating, the electronic device 100 may more clearly recognize a gesture of the user 300 through an image focused at a distance different from the virtual projection plane or may more accurately sense a distance between a body part (e.g., hand) of the user 300 and the projection plane. That is, the electronic device 100 may clearly recognize or sense a user's gesture or the position of a body part (e.g., hand) at various other distances as well as a specific focal length.

FIG. 13B is a diagram for describing the waveguide 112 and the image sensor 140 according to an embodiment of the disclosure. For ease of description, descriptions that are redundant with those provided with reference to FIG. 13A are simplified or omitted.

In an embodiment of the disclosure, a plurality of lenses 113 may be provided. The plurality of lenses 113 may include two or more lenses 113 having different focal lengths. For example, multiple lenses 113 may include the first lens 113a having a first focal length and the second lens 113b having a second focal length different from the first focal length.

In an embodiment of the disclosure, the waveguide 112 may input external light to the inside through the fourth optical coupling area 40. The plurality of lenses 113 may overlap the fourth optical coupling area 40 of the waveguide 112. The plurality of lenses 113 may overlap different areas of the fourth optical coupling area 40. For example, the fourth optical coupling area 40 may include a fifth sub-area 41 in which the first lens 113a overlaps and a sixth sub-area 42 in which the second lens 113b overlaps.

In an embodiment of the disclosure, the third optical coupling area 30 may include sub-areas respectively corresponding to the plurality of lenses 113. For example, the third optical coupling area 30 may include the first sub-area 31 that emits external light that has passed through the first lens 113a and the second sub-area 32 that emits external light that has passed through the second lens 113b.

In an embodiment of the disclosure, a plurality of image sensors 140 may be provided. For example, the plurality of image sensors 140 may include the first image sensor 141 that receives the external light emitted from the first sub-area 31 and the second image sensor 142 that receives the external light emitted from the second sub-area 32.

The first image sensor 141 may receive the external light that has passed through the first lens 113a and then input into the waveguide 112 through the fifth sub-area 41 and output through the first sub-area 31. The electronic device 100 may obtain a first image of the real world on the first focal plane 1310 corresponding to the first focal length through the external light received through the first image sensor 141.

The second image sensor 142 may receive the external light that has passed through the second lens 113b and then input into the waveguide 112 through the sixth sub-area 42 and output through the second sub-area 32. The electronic device 100 may obtain a second image of the real world on the second focal plane 1320 corresponding to the second focal length through the external light obtained through the second image sensor 142.

In an embodiment of the disclosure, the electronic device 100 may simultaneously obtain a plurality of images having different focal depths. That is, the electronic device 100 may obtain image information focused on subjects of various distances. Accordingly, even when the user 300 performs a gesture at a distance slightly spaced apart from a virtual projection plane on which a virtual image is floating, the electronic device 100 may more clearly recognize a gesture of the user 300 through an image having a focal depth different from the virtual projection plane or may more accurately sense a distance between a body part (e.g., hand) of the user 300 and the projection plane. That is, the electronic device 100 may clearly recognize or sense a user's gesture or the position of a body part (e.g., hand) at various other distances as well as a specific focal length.

FIG. 14 is a diagram for describing the waveguide 112 and the image sensor 140 according to an embodiment of the disclosure.

Referring to FIG. 14, in an embodiment of the disclosure, a plurality of lenses 113 may be included. The third optical coupling area 30 may include sub-areas respectively corresponding to the plurality of lenses 113. FIG. 14 shows an example in which the third optical coupling area 30 includes the first sub-area 31, the second sub-area 32, the third sub-area 33, and the fourth sub-area 34 respectively corresponding to the first lens 113a, the second lens 113b, the third lens 113c, and the fourth lens 113d having four different focal lengths. For ease of description, descriptions that are redundant with those provided with reference to FIG. 13A are simplified or omitted.

In an embodiment of the disclosure, the image sensor 140 may be implemented as a single image sensor. The image sensor 140 may receive all external light emitted from each of the first sub-area 31, the second sub-abrea 32, the third sub-area 33, and the fourth sub-area 34.

In an embodiment of the disclosure, the image sensor 140 may selectively receive the external light that has passed through each of the first lens 113a, the second lens 113b, the third lens 113c, and the fourth lens 113d that are different from each other based on a time sequential method. For example, by selectively opening or blocking a shutter by utilizing an active shutter disposed on an optical path, the image sensor 140 may selectively receive the external light that has passed through each of the first lens 113a, the second lens 113b, the third lens 113c, and the fourth lens 113d that are different from each other. Accordingly, the electronic device 100 may sequentially obtain a plurality of images having different focal depths by using one image sensor 140.

Alternatively, in an embodiment of the disclosure, the image sensor 140 may change the external light received by the image sensor 140 according to an environment in order to obtain an image having a specific depth of focus in response to a specific condition or a specific situation. For example, the image sensor 140 may be controlled to receive the external light emitted from the fourth sub-area 34 so as to receive the external light has passed through the fourth lens 113d when an image of a shallow depth of field is required, and image sensor 140 may be controlled to receive the external light emitted from the first sub-area 31 so as to receive the external light has passed through the first lens 113a.

FIG. 15A is a flowchart illustrating an operating method of the electronic device 100 for recognizing a gesture of the user 300 according to an embodiment of the disclosure. FIG. 15B is a diagram illustrating an operation in which the electronic device 100 recognizes the gesture of the user 300 according to an embodiment of the disclosure.

Referring to FIG. 15A, a method, performed by the electronic device 100 of providing a virtual image may further include operations S1510 and S1520. In an embodiment of the disclosure, operations S1510 and S1520 may be executed by the at least one processor 130 included in the electronic device 100. Operations S1510 and S1520 may be performed after operation S1020 shown in FIG. 10A is performed.

In operation S1510 of FIG. 15A, the electronic device 100 according to an embodiment of the disclosure may recognize the gesture of the user 300 on the virtual image based on an image of the real world on a virtual projection plane.

The electronic device 100 may receive external light through the image sensor 140 and obtain the image of the real world based on the received external light. The electronic device 100 may recognize a body part (e.g., hand) of the user 300 from the image of the real world to recognize a gesture by the recognized body part of the user 300. For example, the electronic device 100 may detect the body part from the image of the real world, estimate an outline or feature point from the detected body part, and analyze a body pose or motion. The electronic device 100 may recognize the gesture of the user 300 based on the estimated outline or feature point. The electronic device 100 may determine whether the recognized gesture matches a predefined gesture.

By recognizing the gesture of the user 300 based on the image of the real world on the virtual projection plane, the electronic device 100 may recognize the gesture of the user 300 with respect to the virtual image floating on the virtual projection plane. For example, the electronic device 100 may recognize a gesture input by the user 300 using a hand or other body part to perform a control command (e.g., selection, zoom in/out, swipe, play/pause content, etc.) on the virtual image.

According to an embodiment of the disclosure, the electronic device 100 may obtain an image of the real world in which an image of a subject (e.g., the body part of the user 300) located in an area in which the virtual image is floating is clearly formed. Accordingly, the electronic device 100 may increase the accuracy of recognition of the gesture of the user 300 responding to the virtual image or manipulating the virtual image.

For example, referring to FIG. 15B together, the user 300 may perform a gesture operation of manipulating a virtual image 1510 floating on the virtual projection plane by using a body part (e.g., a finger 1530). The user 300 may place the finger of the user 300 in a space where the virtual image 1510 is visible and then perform a side-swipe gesture operation. The electronic device 100 may obtain the image of the real world on the virtual projection plane, thereby obtaining the image of the real world in which a gesture operation of side-swiping the finger 1530 is clearly visible. Accordingly, the electronic device 100 may clearly recognize that the finger 1530 of the user 300 has performed a gesture operation of side-swiping a screen.

In addition, according to an embodiment of the disclosure, the electronic device 100 may recognize the gesture of the user 300 by obtaining the image of the real world while the image sensor 140 remains invisible to the user 300. Accordingly, the electronic device 100 may recognize the gesture of the user 300 without a sensor exposed to the outside, thereby minimizing the resistance of the user 300 and improving the aesthetics.

In an embodiment of the disclosure, the electronic device 100 may further perform a process of preprocessing the obtained image of the real world before recognizing the gesture from the image of the real world. For example, the electronic device 100 may perform preprocessing such as noise removal, brightness correction, background removal, etc. from the obtained image of the real world.

In an embodiment of the disclosure, the electronic device 100 may obtain an image of the real world that is flipped (e.g., horizontal flip and vertical flip) from an actual appearance of the real world. Light of the flipped image may be emitted from a waveguide and then focused onto a virtual projection plane as an inverted image after passing through a lens, and considering that a path of external light on the virtual projection plane corresponds to inversely following a path of light of the flipped image, an image of a subject on the virtual projection plane may be obtained as an image flipped from the actual image of the subject. Accordingly, the electronic device 100 may perform preprocessing of flipping (e.g., horizontal flip and vertical flip) the image of the real world before recognizing the gesture from the image of the real world.

In an embodiment of the disclosure, the electronic device 100 may perform preprocessing of removing an input image (or flipped image) from the image of the real world before recognizing the gesture from the image of the real world. In a process of propagating light of the flipped image and the external light inside a waveguide, optical paths may overlap and interfere with each other, and accordingly, the electronic device 100 may obtain an image of the real world with improved quality and reduce the possibility of errors in a gesture recognition process.

In operation S1520 of FIG. 15A, the electronic device 100 according to an embodiment of the disclosure may perform an operation corresponding to the recognized gesture.

The electronic device 100 may recognize a gesture such as the movement of the hand or finger of the user 300, an arm movement, and a specific pose, etc. through the image of the real world. The electronic device 100 may execute/manipulate a function or content corresponding to the recognized gesture. For example, referring to FIG. 15B together, the electronic device 100 may recognize performing the gesture operation of side-swiping the screen, and then perform an operation of displaying a virtual image 1520 converted to content of the next item in response to the gesture operation of side-swiping the screen.

FIG. 16A is a flowchart illustrating an operating method of the electronic device 100 for providing an indicator indicating a distance between a hand and a virtual projection plane according to an embodiment of the disclosure. FIG. 16B is a diagram for explaining an operation in which the electronic device 100 provides the indicator indicating the distance between the hand and the virtual projection plane according to an embodiment of the disclosure.

Referring to FIG. 16A, a method, performed by the electronic device 100, of providing a virtual image may further include operations S1610 to S1630. In an embodiment of the disclosure, operations S1610 to S1630 may be executed by the at least one processor 130 included in the electronic device 100. Operations S1610 to S1630 may be performed after operation S1020 shown in FIG. 10A is performed.

In operation S1610 of FIG. 16A, the electronic device 100 according to an embodiment of the disclosure may detect the hand of the user 300 based on an image of the real world. An operation of detecting a body part of the user 300 based on the image of the real world has been described in detail with reference to operation S1510 of FIG. 15A, and thus a description thereof is omitted.

In operation S1620 of FIG. 16A, the electronic device 100 according to an embodiment of the disclosure may determine the distance between the hand and the virtual projection plane based on the degree of blur of the hand detected in the image of the real world.

In an embodiment of the disclosure, the electronic device 100 may estimate the degree of blur of a hand image detected in the image of the real world. The closer the user's hand is located to the virtual projection plane, the less the degree of blur of the hand image in the image of the real world, and a relatively clear hand image may be obtained. The farther the user's hand is located from the virtual projection plane, the greater the degree of blur of the hand image in the image of the real world, and a relatively unclear hand image may be obtained.

In an embodiment of the disclosure, the electronic device 100 may numerically quantify the degree of blur of the hand image. For example, the electronic device 100 may measure the amount of brightness change (or gradient) between pixels by converting the image to grayscale. The greater the degree of blur of the image, the smaller the gradient value is measured, and accordingly, the degree of blur may be measured. Alternatively, for example, the electronic device 100 may estimate the degree of blur by generating an edge map and analyzing features (e.g., edge strength, edge length, etc.) of the edge map. A Laplacian filter may be used to analyze an edge. Alternatively, for example, the electronic device 100 may separate a frequency component of the image and analyze a low frequency component and a high frequency component to measure the degree of blur based on the degree to which the high frequency component is weak. However, a method, performed by the electronic device 100, of estimating the degree of blur of the hand image is not limited to any one embodiment of the disclosure. The electronic device 100 may use a known technology in estimating the degree of blur of the image.

In an embodiment of the disclosure, the electronic device 100 may determine the distance between the hand and the virtual projection plane based on the degree of blur of the hand image. For example, the electronic device 100 may previously obtain (or generate) data about a distance between an object corresponding to the degree of blur (e.g., the quantified degree of blur) of the object and the virtual projection plane. Alternatively, for example, the electronic device 100 may calculate the distance between the object and the virtual projection plane based on the degree of blur (e.g., the quantified degree of blur) of the object and a pre-stored characteristic value of the image sensor. However, a method of determining the distance between the hand and the virtual projection plane is not limited to any one embodiment of the disclosure. The electronic device 100 may use a known technology in estimating the position of the object based on the degree of blur of the image

In operation S1620 of FIG. 16A, the electronic device 100 according to an embodiment of the disclosure may provide the indicator indicating the distance between the hand and the virtual projection plane to the virtual projection plane.

In an embodiment of the disclosure, the electronic device 100 may provide the indicator to the virtual projection plane corresponding to a point indicated by the hand in the virtual image. For example, the electronic device 100 may provide the virtual image in which the indicator is displayed corresponding to the point indicated by the hand. In this case, the electronic device 100 may additionally perform correction of adding the indicator to an input image. However, the embodiment of the disclosure is not limited thereto, and the electronic device 100 may provide the indicator (or a UI to be additionally displayed on the input image) to the virtual projection plane through an optical engine separate from the optical engine 111 that provides the input image.

In an embodiment of the disclosure, the indicator may be represented as a circular cursor, a ring cursor, an arrow cursor, etc., but the embodiment of the disclosure is not limited thereto.

In an embodiment of the disclosure, the electronic device 100 may provide the shape of the indicator differently according to the distance between the hand of the user 300 and the projection plane. For example, when it is detected that the distance between the hand of the user 300 and the projection plane has increased, the electronic device 100 may provide the indicator that is relatively faint. When it is detected that the distance between the hand of the user 300 and the projection plane is close, the electronic device 100 may provide the indicator that is clearly emphasized. For example, the electronic device 100 may change the size, color, and/or transparency of the indicator. However, a representation method of the indicator is not limited thereto, and an animation effect (e.g., blinking or vibration effect when a finger approaches within a certain distance) may be applied to the indicator.

Referring to FIG. 16B together, in an embodiment of the disclosure, the electronic device 100 may obtain images 1630 and 1640 of the real world on a virtual projection plane in which virtual images 1610 and 1620 are floating.

First, as shown in (a) of FIG. 16B, the electronic device 100 may obtain the image 1630 of the real world with a high degree of blur of the hand of the user 300. The electronic device 100 may determine that the hand of the user 300 is located at a relatively far distance from the virtual projection plane based on the high degree of blur. In this regard, the electronic device 100 may display an indicator 1650 that is relatively faintly represented. For example, the electronic device 100 may provide an indicator having a light color, high transparency, and a widespread shape.

As shown in (b) of FIG. 16B, the electronic device 100 may obtain the image 1640 of the real world with a low degree of blur of the hand of the user 300. The electronic device 100 may determine that the hand of the user 300 is located relatively close to the virtual projection plane based on the low degree of blur. In this regard, the electronic device 100 may display an indicator 1660 that is relatively emphatically represented. For example, the electronic device 100 may provide an indicator 1660 having a dark or bright color, a low transparency, and a compact shape to clearly indicate only to a point indicated by the hand.

According to an embodiment of the disclosure, by providing the indicators 1650 and 1660 indicating the distance between the hand and the projection plane, the electronic device 100 may intuitively identify the points indicated by a finger in the virtual images 1610 and 1620 and/or the distance of the finger from the virtual images 1610 and 1620. Because the virtual images 1610 and 1620 do not have a physical substance, the user 300 may not feel a tactile reaction even when touching the virtual images 1610 and 1620, which may be relatively difficult to identify that a gesture of the user 300 is recognized by a system. On the other hand, according to an embodiment of the disclosure, the electronic device 100 provides a visual notification through the indicators 1650 and 1660, and thus, the user 300 may intuitively identify that the gesture of the user 300 is recognized by the system.

FIG. 16C is a diagram for explaining an operation in which the electronic device 100 provides a hovering detection indicator 1612 and a touch recognition indicator 1622 according to an embodiment of the disclosure.

Referring to FIG. 16C, in an embodiment of the disclosure, the electronic device 100 may provide a virtual image (e.g., a first virtual image 1601 or a second virtual image 1602) including one or more UI elements 1611 and 1621. The UI elements 1611 and 1621 may each include a button-type object for inducing a user input. The electronic device 100 may activate a function corresponding to the touched or clicked UI element 1611 or 1621 based on detecting a user's gesture of touching or clicking any one of the UI elements 1611 and 1621.

Referring to the first virtual image 1601 of the drawing in (a) of FIG. 16C, in an embodiment of the disclosure, the electronic device 100 may determine that a user's hand is in a hovering state when it is detected that the user's hand is spaced apart from the virtual projection plane but is located within a defined (e.g., predefined) threshold distance from the virtual projection plane. In this regard, the electronic device 100 may provide the hovering detection indicator 1612 for visually guiding the current instruction position of a user to the virtual projection plane. For example, the electronic device 100 may provide the first virtual image 1601 in which the hovering detection indicator 1612 is displayed in response to a point indicated by the user's hand. The electronic device 100 may display the hovering detection indicator 1612 that is relatively faintly represented. For example, the electronic device 100 may provide the hovering detection indicator 1612 having a light color, high transparency, and a widespread shape.

Referring to the second virtual image 1602 of (b) of FIG. 16C, in an embodiment of the disclosure, when it is detected that the user's hand crosses the virtual projection plane or contacts the virtual projection plane, the electronic device 100 may determine that the user's hand is in a touch state. In this regard, the electronic device 100 may provide the touch recognition indicator 1622 for visually guiding the current instruction position of the user to the virtual projection plane. For example, the electronic device 100 may provide the second virtual image 1602 in which the touch recognition indicator 1622 is displayed in response to a point indicated by the user's hand. The electronic device 100 may display the touch recognition indicator 1622 that is relatively emphatically represented. For example, the electronic device 100 may provide the touch recognition indicator 1622 having a bright color, low transparency, and a compact shape to more clearly indicate the point indicated by the hand.

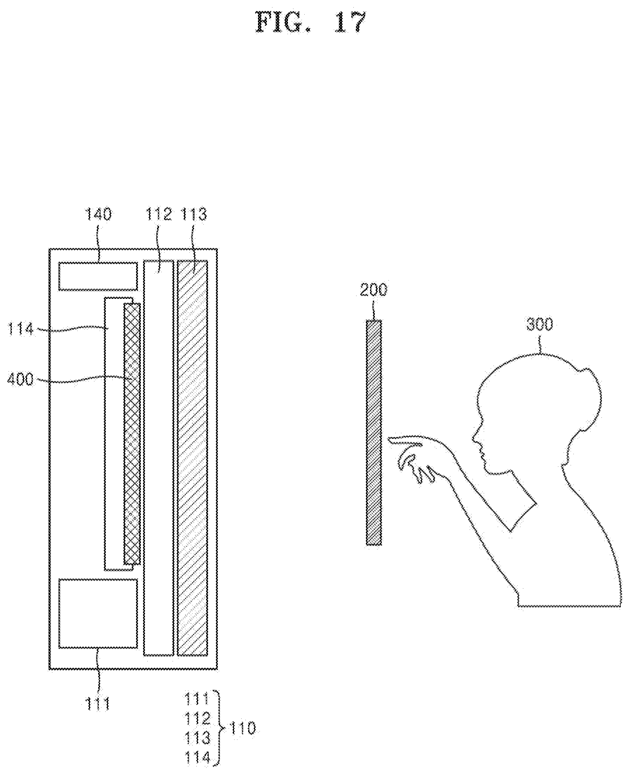

FIG. 17 is a diagram for explaining the display unit 110 of the electronic device 100 according to an embodiment of the disclosure.

Referring to FIG. 17 together, in an embodiment of the disclosure, the electronic device 100 may include the display unit 110 and the image sensor 140, and the display unit 110 may include the optical engine 111, the waveguide 112, the lens 113, and a display 114. In an embodiment of the disclosure, the image sensor 140 may be omitted from the electronic device 100.

In an embodiment of the disclosure, the display 114 may be a device that visually outputs a 2D image 400 on a screen. The display 114 may be referred to as a flat display or a 2D display.

The display 114 is a device for visually displaying the 2D image 400 on the screen, and is generally configured through a display panel including a plurality of pixels. The display panel may include a configuration such as a liquid crystal display (LCD) and an organic light emitting diode (OLED), and may implement a 2D image on a plane by controlling the brightness and color of each pixel according to the input image signal.

The display 114 may be located on the back surface of the waveguide 112. In an embodiment of the disclosure, the display 114 being located on the back surface of the waveguide 112 may mean both the display 114 being directly coupled (e.g., attached) to the back surface of the waveguide 112 and the display 114 being spaced apart from the back surface of the waveguide 112 by a predetermined distance. The display 114 may be disposed to face the back surface of the waveguide 112. The display 114 may be located at the rear (or a lower portion) of the waveguide 112. The display 114 may be located farther from the user 300 than the waveguide 112. As the waveguide 112 includes a transparent material in a visible light band, light may be transmitted in the thickness direction of the waveguide 112. Accordingly, the user 300 may perceive the display 114 disposed at the rear of the waveguide 112 through the waveguide 112.

In an embodiment of the disclosure, the electronic device 100 may obtain a single input image. The electronic device 100 may separate content for outputting a 2D image and content for outputting the virtual image from the single input image. The electronic device 100 may analyze the input content and classify the input content into a 2D image 400 and a virtual image 200 (or a floating image). For example, a background screen or basic UI may be provided as the general 2D image 400 through a panel, and a notification, a selection menu, and a virtual object may be classified to be provided as the virtual image 200 (or a floating image). By classifying a UI requiring a response of the user 300 and providing the UI as a floating image, the electronic device 100 may provide a visual effect that allows the user 300 to immediately perceive relevant information and feel as if the user 300 may actually reach out and manipulate the UI. By classifying content to be visually emphasized and providing the content as a floating image, the electronic device 100 may select only information having high importance or priority and display the information in front to transmit an intuitive information structure to the user 300.

In an embodiment of the disclosure, the electronic device 100 may independently receive an image to be provided as the virtual image 200 and an image to be provided as the 2D image 400. That is, the electronic device 100 may separately receive 2D image data and virtual image data. The electronic device 100 may provide the 2D image 400 through the display 114 based on the 2D image data, and provide the virtual image 200 through the optical engine 111 based on the virtual image data.

According to an embodiment of the disclosure, by simultaneously outputting the 2D image 400 and the virtual image 200 that appears to be floating in the air from the 2D image 400 through the display 114, the electronic device 100 may provide the user 300 with a visual experience with further improved sense of depth and 3D.

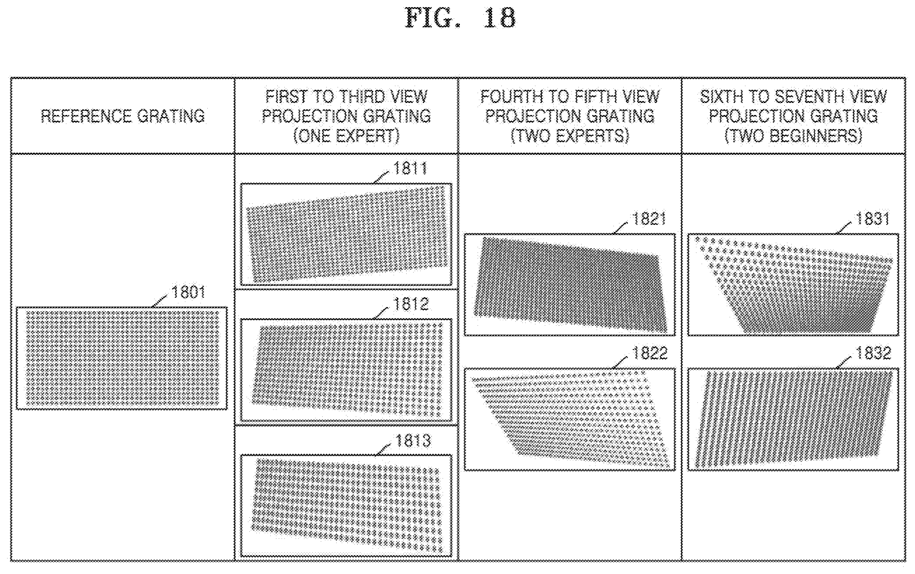

FIG. 18 is a diagram illustrating a reference grating 1801 of a reference coordinate system and projection gratings for each user viewpoint according to an embodiment of the disclosure.

Referring to FIG. 18, in an embodiment of the disclosure, the electronic device 100 may perform a process of transforming and projecting the reference grating on the reference coordinate system to match a user's real-time viewpoint based on a transform matrix obtained through a calibration process. The calibration process may refer to a procedure performed to estimate the geometric relationship between the reference coordinate system and a user viewpoint coordinate system, and in the calibration process, the transform matrix representing the transformation relationship between the coordinate systems may be calculated using the location information of reference feature points. In the disclosure, the reference coordinate system may correspond to a virtual projection plane formed by floating a virtual image.

The reference grating 1801 on the reference coordinate system may be mapped onto a transformation plane of the user viewpoint coordinate system corresponding to the user viewpoint based on a calibration result. In this process, each grating point of the reference grating 1801 may be transformed into a corresponding position in the user viewpoint coordinate system, and the reference grating 1801 may be expressed as the projection grating for each user viewpoint.

A first viewpoint projection grating 1811, a second viewpoint projection grating 1812, and a third viewpoint projection grating 1813 may be generated to correspond to viewpoints of the same first expert. For example, the first viewpoint projection grating 1811, the second viewpoint projection grating 1812, and the third viewpoint projection grating 1813 may correspond to projection results obtained by the first expert viewing the same screen three times at a specific viewpoint position. Referring to the first viewpoint projection grating 1811, the second viewpoint projection grating 1812, and the third viewpoint projection grating 1813, even the same user may differently recognize the virtual image output from the same electronic device 100.

A fourth viewpoint projection grating 1821 may be generated to correspond to the viewpoint of a second expert. A fifth viewpoint projection grating 1822 may be generated to correspond to the viewpoint of a third expert different from the second expert. For example, fourth viewpoint projection grating 1821 and fifth viewpoint projection grating 1822 may correspond to projection results obtained by the second expert and the third expert viewing the same screen at a specific viewpoint position.

Humans may form binocular parallax due to the distance between their two eyes (e.g., the distance between their pupils), and may perceive the depth and position of an object based on the binocular parallax. In this regard, because the distance between two eyes is different for each user, even when the same virtual image is provided, the degree of binocular parallax varies, and thus, the position, depth, and/or shape of the virtual image may be perceived differently. Therefore, referring to the fourth viewpoint projection grating 1821 and the fifth viewpoint projection grating 1822, even experts familiar with viewing floating images may have a large difference in screen perception between users.

A sixth viewpoint projection grating 1831 may be generated to correspond to the viewpoint of a first beginner. A seventh viewpoint projection grating 1832 may be generated to correspond to the viewpoint of a second beginner different from the first beginner. For example, the sixth viewpoint projection grating 1831 and the seventh viewpoint projection grating 1832 may correspond to projection results obtained by the first beginner and the second beginner viewing the same screen at a specific viewpoint position.

The human eye may generally be adjusted to focus on the distance at which an object is located when perceiving the object. In the case of a floating image, a difference may occur between a position of the floating image recognized by the eye and a position at which actual light is generated. For example, even though the floating image is perceived as floating about 30 cm in the air, the actual light may be emitted from a display unit inside the electronic device 100. As described above, when the position of the perceived floating image and the position of the actual light source are different from each other, confusion may occur with respect to a position where the eyes need to be focused. Accordingly, a beginner unfamiliar with the floating image may be required to have an adaptation time before stably perceiving the floating image. Therefore, referring to the sixth viewpoint projection grating 1831 and seventh viewpoint projection grating 1832, for beginners unfamiliar with viewing floating images, screen perception may be inconsistent.

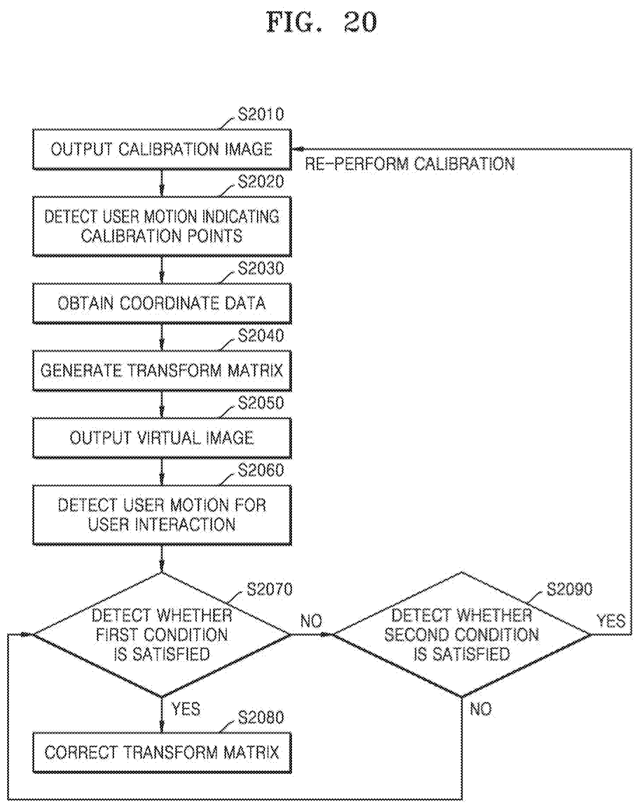

Referring to the first viewpoint projection grating 1811, the second viewpoint projection grating 1812, the third viewpoint projection grating 1813, the fourth viewpoint projection grating 1821, the fifth viewpoint projection grating 1822, the sixth viewpoint projection grating 1831, and the seventh viewpoint projection grating 1832, even for the same viewer, perception of the virtual image may vary from time to time, and there may be differences in perception characteristics between viewers, and thus, the calibration process may be performed to provide accurate perception of the virtual image in response to perception characteristics for each user. In an embodiment of the disclosure, the electronic device 100 may perform a customized calibration process for each user before each user uses a user interaction function. An operation in which the electronic device 100 performs the customized calibration process for each user will be described in detail with reference to FIGS. 20, 21, 22, 23, 24, 25, 26, 27, 28A, 28B, 29A, and 29B.

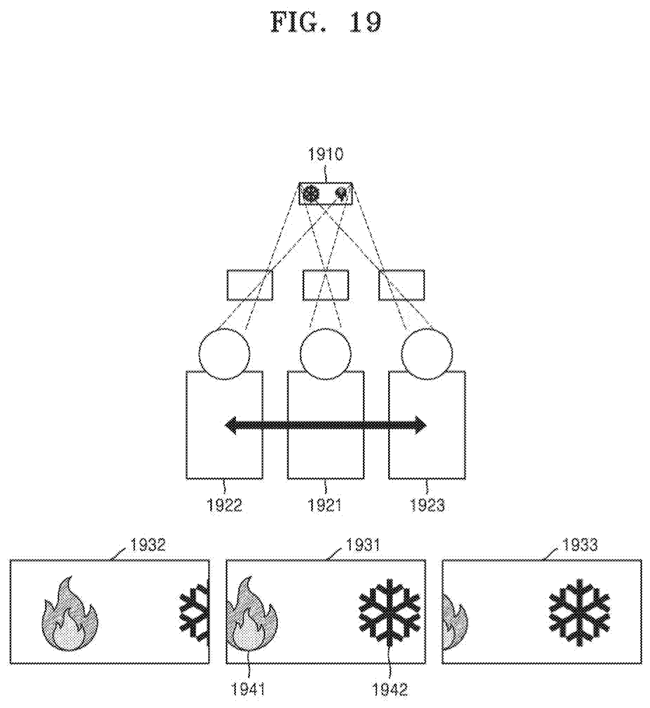

FIG. 19 is a diagram illustrating first virtual image 1931, second virtual image 1932, and third virtual image 1933 provided by the electronic device 100 according to an embodiment of the disclosure, which vary depending on viewing positions of users 1921, 1922, and 1923.

Referring to FIG. 19, in an embodiment of the disclosure, the electronic device 100 may provide a virtual image (e.g., the first virtual image 1931, the second virtual image 1932, or the third virtual image 1933) floating on a virtual projection plane. For example, the electronic device 100 may generate a flipped image by performing correction to flip (e.g., correction to horizontally flip and correction to vertically flip) an input image. By providing light 1910 of the flipped image, the electronic device 100 may provide the virtual image (e.g., the first virtual image 1931, the second virtual image 1932, or the third virtual image 1933) in which the light 1910 of the flipped image is horizontally and vertically flipped while passing through a lens and focused onto the virtual projection plane. Accordingly, the electronic device 100 may provide the virtual image (e.g., the first virtual image 1931, the second virtual image 1932, or the third virtual image 1933) in the same form as the input image.

For example, the input image may include a first object disposed on the left side and a second object disposed on the right side. The first object may have a flame shape, and the second object may have a snowflake shape. The electronic device 100 may perform correction to horizontally flip the input image and correction to vertically flip the input image to generate a flipped image including the first object disposed on the right side and horizontally and vertically flipped and the second object disposed on the left side and horizontally and vertically flipped. The electronic device 100 may provide the light 1910 of the flipped image to be horizontally and vertically flipped while passing through the lens, so that the virtual image (e.g., the first virtual image 1931, the second virtual image 1932, or the third virtual image 1933) in the same form as the input image may be floating on the virtual projection plane. That is, the electronic device 100 may provide the virtual image (e.g., the first virtual image 1931, the second virtual image 1932, or the third virtual image 1933) including a first object 1941 disposed on the left side and having the flame shape that is not flipped and a second object 1942 disposed on the right side and having the snowflake shape that is not flipped.

In an embodiment of the disclosure, the electronic device 100 may provide the virtual image (e.g., the first virtual image 1931, the second virtual image 1932, or the third virtual image 1933) that is perceived differently according to the viewing position of the user. For example, when the user 1921 is located in the middle to watch, the user 1921 may watch the first virtual image 1931. When the user 1922 moves to the left to watch, the user 1922 may watch the second virtual image 1932. The second virtual image 1932 may be perceived as if the first object 1941 and the second object 1942 have moved to the right compared to the first virtual image 1931. In the second virtual image 1932, the first object 1941 having the flame shape may be perceived as being more central. That is, when the user 1922 is watching while moving to the left, the user 1922 may perceive the first object 1941 and the second object 1942 as moving to the right, and may perceive a screen (or position of a video) as moving to the right.

When the user 1923 moves to the right to watch, the user 1923 may watch the third virtual image 1933. The third virtual image 1933 may be perceived as if the first object 1941 and the second object 1942 have moved to the left compared to the first virtual image 1931. In the third virtual image 1933, the second object 1942 having the snowflake shape may be perceived as being more central. That is, when the user 1923 is watching while moving to the right, the user 1923 may perceive the first object 1941 and the second object 1942 as moving to the left, and may perceive the screen (or position of the video) as moving to the left.

Referring to the first virtual image 1931, the second virtual image 1932, and the third virtual image 1933, the position of the perceived image may vary depending on the viewing position of the user 1921, 1922, or 1923 (e.g., a minute position change due to a head movement, a gaze movement, etc.) Accordingly, the electronic device 100 may correct a calibration result during use to provide accurate perception of the virtual image (e.g., the first virtual image 1931, the second virtual image 1932, or the third virtual image 1933) in response to a change in the viewing position of the user 1921, 1922, or 1923. An operation in which the electronic device 100 corrects the calibration result during use will be described in detail with reference to FIGS. 20, 21, 22, 23, 24, 25, 26, 27, 28A, 28B, 29A, and 29B.

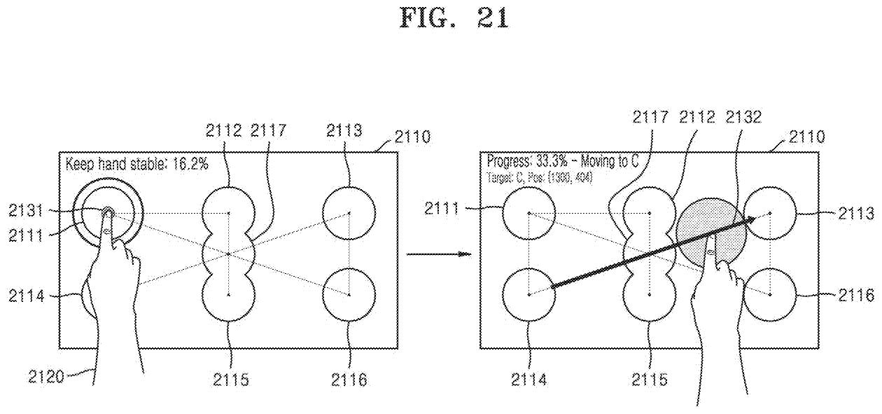

FIG. 20 is a flowchart illustrating an operating method of the electronic device 100 for performing calibration and detecting user motion according to an embodiment of the disclosure. FIG. 21 is a diagram illustrating an operation in which the electronic device 100 generates a transform matrix by performing calibration according to an embodiment of the disclosure.

Referring to FIG. 20, a method of providing a virtual image through the electronic device 100 may include operation S2010, S2020, S2030, S2040, S2050, S2060, S2070, S2080, and S2090. In an embodiment of the disclosure, operation S2010, S2020, S2030, S2040, S2050, S2060, S2070, S2080, and S2090 may be executed by the at least one processor included in the electronic device 100.

In operation S2010 of FIG. 20, the electronic device 100 according to an embodiment of the disclosure may output a calibration image including a plurality of calibration points. In operation S2020 of FIG. 20, the electronic device 100 according to an embodiment of the disclosure may detect the user motion indicating the calibration points. In operation S2030 of FIG. 20, the electronic device 100 according to an embodiment of the disclosure may obtain hand coordinate data of a user corresponding to the calibration points. In operation S2040 of FIG. 20, the electronic device 100 according to an embodiment of the disclosure may generate the transform matrix based on the hand coordinate data. The electronic device 100 may transform the position of a user's hand into coordinates on a virtual projection plane through the transform matrix.

Referring to FIG. 21 together, according to an embodiment of the disclosure, the electronic device 100 may output a calibration image 2110. In the calibration image 2110, a plurality of calibration points (e.g., first calibration point 2111, second calibration point 2112, third calibration point 2113, fourth calibration point 2114, fifth calibration point 2115, sixth calibration point 2116, and seventh calibration point 2117) may be disposed at defined (e.g., predefined) positions. The calibration image 2110 may be configured to perceive defined (e.g., predefined) reference positions through the plurality of calibration points (e.g., the first calibration point 2111, second calibration point 2112, third calibration point 2113, fourth calibration point 2114, fifth calibration point 2115, sixth calibration point 2116, and seventh calibration point 2117). The calibration image 2110 may provide reference information for setting the correspondence relationship between a reference coordinate system and a user interaction space through the plurality of calibration points (e.g., the first calibration point 2111, second calibration point 2112, third calibration point 2113, fourth calibration point 2114, fifth calibration point 2115, sixth calibration point 2116, and seventh calibration point 2117). In the disclosure, the reference coordinate system may correspond to the virtual projection plane formed by floating the virtual image. The reference coordinate system may be referred to as a screen coordinate system.

FIG. 21 shows an example of the calibration image 2110 in which the first calibration point 2111, second calibration point 2112, third calibration point 2113, fourth calibration point 2114, fifth calibration point 2115, sixth calibration point 2116, and seventh calibration point 2117 are displayed, but the number of calibration points is not limited thereto. For example, the number of calibration points may be 5, 6, or 8 or more.

FIG. 21 shows an example that the calibration image 2110 having an arrangement in which three calibration points (e.g., the first calibration point 2111, second calibration point 2112, and third calibration point 2113) are arranged in a row at the top, three calibration points (e.g., the fourth calibration point 2114, fifth calibration point 2115, sixth calibration point 2116) are arranged at the bottom, and one calibration point (e.g., the seventh calibration point 2117) is arranged near the center, but the disclosure is not limited thereto. For example, the calibration image 2110 may be provided in which calibration points are arranged at geometrically easy-to-compute points such as grating shapes or vertices of a specific polygon.

The electronic device 100 may guide a user to sequentially indicate the first to seventh calibration points 2111 to 2117 displayed on the calibration image 2110. By sequentially indicating (e.g., touching) the first to seventh calibration points 2111 to 2117 displayed on the virtual projection plane with a hand 2120, the user may perform the calibration process by positioning the hand 2120 at a position corresponding to each of the first to seventh calibration points 2111 to 2117.

The electronic device 100 may detect the user motion indicating the first to seventh calibration points 2111 to 2117 by using an image sensor. The electronic device 100 may detect user input coordinates (e.g., hand coordinates) in the user interaction space by using the image sensor. For example, the electronic device 100 may detect a position of the hand 2120 by using the image sensor and extract hand coordinates 2131 corresponding to a 3D position of a user's fingertip. The electronic device 100 may extract hand coordinates of the user corresponding to each of the first to seventh calibration points 2111 to 2117. The electronic device 100 may build a dataset by obtaining the hand coordinates 2131 at a time when the hand 2120 indicates (e.g., touches to overlap) a specific calibration point and extract hand coordinate data including the hand coordinates of the user corresponding to each of the first to seventh calibration points 2111 to 2117.

In an embodiment of the disclosure, when the hand 2120 stays at a specific depth for more than 2 seconds, and a position change of the hand 2120 occurs within a radius of 40 pixels for more than 2 seconds, the electronic device 100 may extract the hand coordinates 2131 indicating a specific calibration point at a corresponding time by considering that the specific calibration point has been touched.

In an embodiment of the disclosure, the electronic device 100 may provide the degree to which the user stably maintains the hand 2120 at a specific position. For example, the electronic device 100 may also provide a guide phrase indicating the degree to which a stable state is maintained in the form of a percentage, such as ‘Keep hand stable: 16.3%’ in the calibration image 2110. As a displayed value increases, it may mean that the hand 2120 is maintained more stably. The electronic device 100 may provide the degree to which the hand 2120 is stably maintained in a numerical value, thereby allowing the user to intuitively perceive the stable state of the hand 2120.

In an embodiment of the disclosure, the electronic device 100 may obtain the hand coordinates 2131 corresponding to a current calibration point and then provide guidance to move to coordinates corresponding to a next calibration point. For example, the electronic device 100 may obtain hand coordinates corresponding to the fourth calibration point 2114 and then provide a guide indication 2132 in the form of an arrow from the fourth calibration point 2111 to the third calibration point 2113 so as to move to coordinates corresponding to the third calibration point 2113. The electronic device 100 may provide guidance to sequentially indicate the first calibration point 2111, the fourth calibration point 2114, the third calibration point 2113, the sixth calibration point 2116, the first calibration point 2111, the second calibration point 2112, the seventh calibration point 2117, and the fifth calibration point 2115, but the order set to sequentially indicate the first to seventh calibration points 2111 to 2117 is not limited thereto.

The electronic device 100 may analyze the correspondence relationship between hand coordinate data collected corresponding to the first to seventh calibration points 2111 to 2117 and logical reference coordinates defined when the calibration image 2110 is designed. Accordingly, the electronic device 100 may form a corresponding pair between reference coordinates in the reference coordinate system corresponding to the virtual projection plane and the user input coordinates (e.g., hand coordinates) in the user interaction space. The electronic device 100 may estimate coordinate transformation relationships including translation, rotation, scaling, tilt correction, perspective transformation, or a combination thereof by using a plurality of corresponding coordinate pairs, and may generate a transform matrix as a result. The transform matrix may be utilized as a parameter for transforming the user input coordinates (e.g., hand coordinates) obtained through the image sensor into mapping coordinates on a virtual projection plane.

The user input coordinates (e.g., hand coordinates) may be extracted in the form of 2D planar coordinates or may be extracted in the form of 3D spatial coordinates. For example, when the image sensor is configured as an RGB camera, the electronic device 100 may identify a feature point corresponding to a user's fingertip within a captured image frame, and extract the position of the feature point as 2D coordinates (x, y) on an image plane. For example, when the image sensor is configured as a depth camera capable of depth detection (e.g., stereo camera), or the electronic device 100 further includes an IR sensor, the electronic device 100 may extract the position of the user's fingertip in 3D spatial coordinates (x, y, z). A z-axis coordinate is utilized to calculate a physical distance that the user's hand is spaced apart from the virtual projection plane, which enables a numerical determination of whether the user's hand is in a hovering state or a touch state.

For example, the transform matrix may be a homography matrix and may be calculated based on a homography algorithm. The homography matrix may refer to a geometric transform matrix defining a projection relationship between two different planes. By mapping user input coordinates (e.g., x, y components of 2D planar coordinates or 3D planar coordinates) to 2D coordinates on the virtual projection plane through the homography matrix and correcting perspective distortion due to a viewpoint difference, the electronic device 100 may transform coordinates in an actual user interaction space into coordinates on the virtual projection plane where the virtual image is displayed.

For example, a transform matrix H may be a matrix of a size of 3×3, as described in Equation 4 below.

$$“ H ” : [ [ 0.959 , - 0.71 , 181.127 ] , [ - 0.107 , 0.581 , 329.612 ] , [ 1.948 e - 05 , - 0.001 , 1. ] ] \qquad [ Equation 4 ]$$

The user input coordinates (e.g., x, y components of 2D planar coordinates (x, y) or 3D planar coordinates (x, y, z)) may extend in the form of a 3D vector (x, y, 1) for a projection transformation operation, and the corresponding coordinates (u, v) on the virtual projection plane may also be expressed in the form of (u, v, 1). In this regard, the transform matrix H of the size of 3×3 may be required to perform linear transformation between the two coordinates.

Referring back to FIG. 20, in operation S2050 of FIG. 20, the electronic device 100 according to an embodiment of the disclosure may output the virtual image. In operation S2060 of FIG. 20, the electronic device 100 according to an embodiment of the disclosure may detect the user motion on the virtual image for user interaction.

In an embodiment of the disclosure, the electronic device 100 may scan space around the virtual projection plane in real time by using an image sensor, and may detect the user motion for user interaction. In the disclosure, the user motion may cover all physical movements performed by the user to manipulate the virtual image formed in the air. The electronic device 100 may identify a user's body part, for example, a feature point corresponding to a fingertip. The user motion may include 3D position coordinates of the fingertip, a movement trajectory, a movement speed, and acceleration data.

In an embodiment of the disclosure, by performing a matrix product operation between the hand coordinates obtained through the image sensor and the transform matrix, the electronic device 100 may map the hand coordinates obtained through the image sensor into coordinates (hereinafter referred to as mapping coordinates) on the virtual projection plane on which the virtual image is output. By performing the calibration process before detecting the user motion, the electronic device 100 may improve consistency between the position of the virtual image perceived by each user in an actual viewing space and the user input coordinates. Accordingly, the electronic device 100 may precisely match an instruction position intended by the user with the position of a target object within the virtual image.

By analyzing the displacement of feature points between continuous image frames, the electronic device 100 may track not only a simple position movement of a user's fingertip but also an intentional movement pattern in real time. The electronic device 100 may recognize a user's gesture by analyzing a temporal change in the displacement of feature points and a movement trajectory. The electronic device 100 may perform a user interaction corresponding to the recognized gesture. For example, the electronic device 100 may perform a function corresponding to the detected user interaction, or may provide a virtual image including a virtual object or a UI corresponding to the detected user interaction.

In operation S2070 of FIG. 20, the electronic device 100 according to an embodiment of the disclosure may detect whether a first condition is satisfied. In operation S2070 of FIG. 20, when it is detected that the first condition is satisfied, the electronic device 100 according to an embodiment of the disclosure may correct the transform matrix by performing operation S2080. In the disclosure, the first condition may refer to one or more criteria for performing correction of the transform matrix. In an embodiment of the disclosure, after detecting that the first condition is satisfied, the electronic device 100 may perform correction of the transform matrix capable of reducing a coordinate alignment error based on an error between the user input coordinates obtained in a user interaction process and the coordinates of an interaction target object (e.g., UI element) in which the user interaction occurs. In an embodiment of the disclosure, in operation S2070 of FIG. 20, when it is detected that the first condition is not satisfied, operation S2090 may be performed.

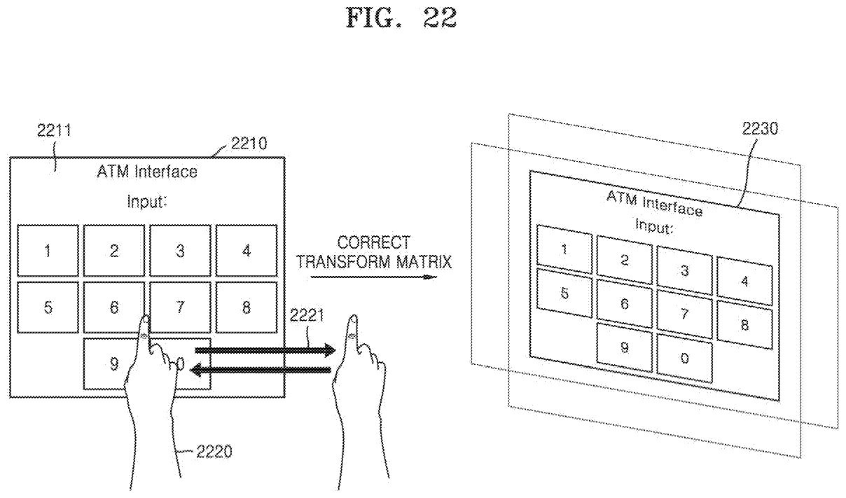

In an embodiment of the disclosure, the first condition may include at least one of whether the hand has deviated, whether a minute movement of the hand is repeated, or whether an offset between reference point coordinates and coordinates on a virtual projection plane corresponding to the position of the user's hand exceeds a defined (e.g., predefined) threshold value. Examples of the first condition will be described below with reference to FIGS. 22, 23, 27, 28A, and 28B.

The position of the virtual image perceived by the user may vary depending on a minute movement of the user (e.g., a minute movement of the body or gaze). For example, when the user puts the user's hand down and then touches it again, the sense of depth perceived by the user may vary, and the position of the virtual image may be perceived differently. In this case, a position other than the intended position is touched, and thus, touch accuracy may decrease, and trial and error may be repeated. According to an embodiment of the disclosure, the electronic device 100 may detect a movement that may change the user's perception of the virtual image and/or a movement as the perception of the virtual image changes, and perform correction of the transform matrix in real time based on the detection of the corresponding movement. Accordingly, the electronic device 100 may maintain or improve touch accuracy in real time, and improve the accuracy and convenience of user interaction.

In operation S2090 of FIG. 20, the electronic device 100 according to an embodiment of the disclosure may detect whether a second condition is satisfied. In operation S2090 of FIG. 20, when it is detected that the second condition is satisfied, the electronic device 100 according to an embodiment of the disclosure may output the calibration image 2110 by performing operation S2010 again. That is, the electronic device 100 may re-perform the calibration process. In the disclosure, the second condition may mean one or more criteria for re-performing calibration. On the other hand, in operation S2090 of FIG. 20, when it is detected that the second condition is not satisfied, the electronic device 100 may continuously (or periodically) detect whether the first condition and/or the second condition is satisfied by performing operation S2070 again.

In an embodiment of the disclosure, the second condition may include a condition with respect to at least one of hand movement trajectory, selection accuracy, the number of selection failures, touch duration, or usage time. Examples of the second condition will be described below with reference to FIGS. 22, 23, 27, 29A, and 29B.

FIG. 22 is a diagram illustrating an operation in which the electronic device 100 corrects a transform matrix based on detecting that a first condition is satisfied according to an embodiment of the disclosure.

Referring to FIG. 22, in an embodiment of the disclosure, the electronic device 100 may correct the transform matrix based on detecting that the first condition regarding whether a hand has deviated is satisfied. For example, when the hands of a user 2220 deviates from a valid area 2211 of a user interaction corresponding to a virtual image and then returns to the valid area 2211 of the user interaction, as it is detected that the first condition is satisfied, the electronic device 100 may correct the transform matrix.

In the disclosure, the valid area 2211 of the user interaction may refer to a spatial range in which the electronic device 100 may recognize and process an input of the user 2220 as a valid interaction, and may be set to correspond to an area in which the virtual image is displayed. For example, the valid area 2211 of the user interaction may be set to a 3D spatial range including a planar area in which the virtual image is visually displayed and extending forward and backward from a plane by a defined (e.g., predefined) threshold distance.

The electronic device 100 may track the hand position of the user 2220 through an image sensor. By performing a matrix product operation between hand coordinates obtained through the image sensor and the transform matrix, the electronic device 100 may map the hand coordinates on a user interaction space into coordinates (hereinafter referred to as mapping coordinates) on a virtual projection plane 2210 on which the virtual image is output. The electronic device 100 may detect whether the hand position of the user 2220 deviates from the valid area 2211 of the user interaction with respect to the mapping coordinates on the virtual projection plane 2210 corresponding to the hand position of the user 2220.

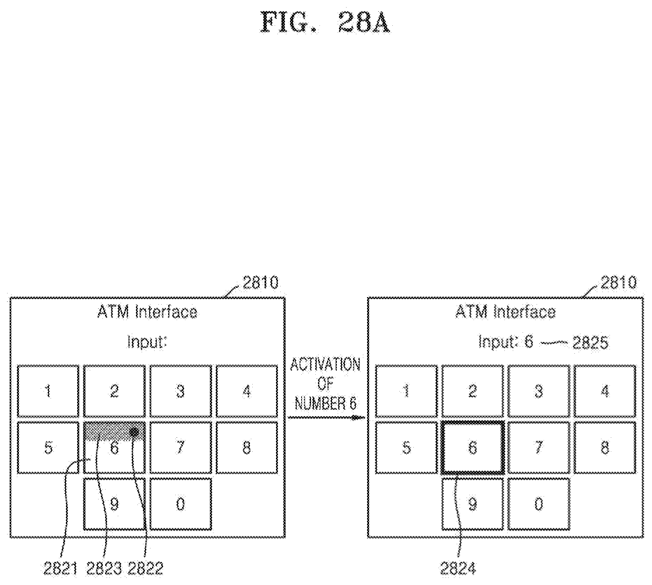

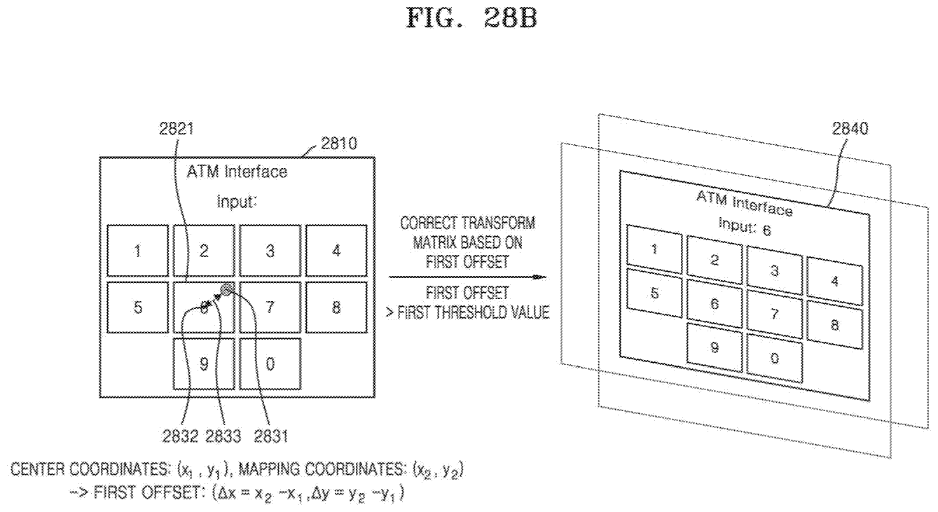

When a user motion 2221 in which the mapping coordinates corresponding to the hand position deviate from the valid area 2211 of the user interaction and then return to the valid area 2211 of the user interaction is detected, as it is detected that the first condition is satisfied, the electronic device 100 may correct the transform matrix. For example, after detecting that the first condition is satisfied, the electronic device 100 may perform correction of the transform matrix capable of reducing a coordinate alignment error based on an error between user input coordinates obtained in a user interaction process and coordinates of an interaction target object (e.g., UI element) in which the user interaction occurs. A detailed description in this regard will be provided below with reference to FIG. 28B.

In an embodiment of the disclosure, as the transform matrix is corrected, the geometric shape of horizontal and vertical axis components constituting the virtual projection plane 2210 (or reference coordinate system) to which the user input coordinates on a 3D space are mapped may vary. Therefore, the virtual projection plane 2210 (or reference coordinate system) may be updated to a new virtual projection plane 2230 to which 2D plane deformation is applied based on the corrected transform matrix. Accordingly, the electronic device 100 may maintain spatial consistency between the user input coordinates and the virtual image through the updated virtual projection plane 2230 (or reference coordinate system), and improve the precision of interaction.

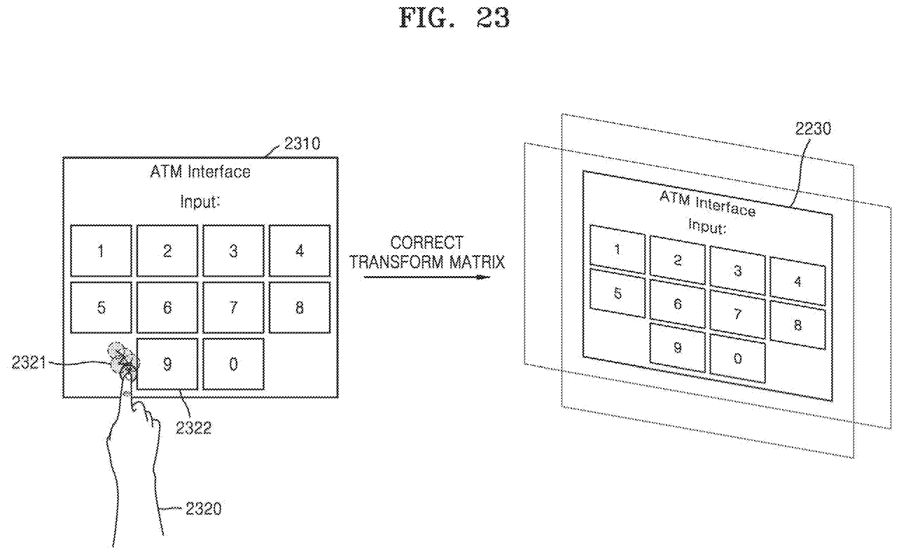

FIG. 23 is a diagram illustrating an operation in which the electronic device 100 corrects a transform matrix based on detecting that a first condition is satisfied according to an embodiment of the disclosure.

Referring to FIG. 23, in an embodiment of the disclosure, the electronic device 100 may correct the transform matrix based on detecting that the first condition regarding whether a minute hand movement is repeated is satisfied. For example, when a user motion 2321 repeating a minute movement is detected to select a UI element intended by a user 2320, as it is detected that the first condition is satisfied, the electronic device 100 may correct the transform matrix.

In an embodiment of the disclosure, the electronic device 100 may provide a virtual image including one or more interaction target objects. For example, the electronic device 100 may provide a virtual image including one or more UI elements configured as button-type objects for inducing an input of the user 2320.

In an embodiment of the disclosure, the electronic device 100 may detect a temporal change in the hand position of the user 2320 based on continuous image frames obtained through an image sensor. The electronic device 100 may map the hand position of the user 2320 to coordinates on a virtual projection plane 2310 on which the virtual image is output. The electronic device 100 may time-sequentially analyze mapping coordinates on the virtual projection plane 2310 corresponding to the hand position of the user 2320 to track the movement trajectory of the hand on the virtual image and calculate the movement speed of the hand.

In an embodiment of the disclosure, the electronic device 100 may identify a manipulation intention of the user 2320 to select a specific interaction target object based on a dynamic state change (e.g., a movement trajectory, a movement speed, etc.) of the hand. For example, the electronic device 100 may identify the user motion 2321 according to the manipulation intention of the user 2320 to select a button-type UI element 2322 corresponding to ‘9’, based on the movement speed of the hand being reduced below a defined (e.g., predefined) threshold speed value, and the minute movement of mapping coordinates corresponding to the hand position being repeated within a local threshold area adjacent to a specific interaction target object, e.g., the button-type UI element 2322.

When the user motion 2321 according to the manipulation intention of the user 2320 to select the specific interaction target object is detected, the electronic device 100 may correct the transform matrix by considering that it is detected that the first condition is satisfied. For example, after detecting that the first condition is satisfied, the electronic device 100 may perform correction of the transform matrix capable of reducing a coordinate alignment error based on an error between user input coordinates obtained in a user interaction process and coordinates of the interaction target object (e.g., the button-type UI element 2322 corresponding to ‘9’) in which the user interaction occurs. A detailed description in this regard will be provided below with reference to FIG. 28B.

In an embodiment of the disclosure, as the transform matrix is corrected, the geometric shape of horizontal and vertical axis components constituting the virtual projection plane 2310 (or reference coordinate system) to which the user input coordinates on a 3D space are mapped may vary. Therefore, the virtual projection plane 2310 (or reference coordinate system) may be updated to a new virtual projection plane 2330 to which 2D plane deformation is applied based on the corrected transform matrix. Accordingly, the electronic device 100 may maintain spatial consistency between the input coordinates of the user 2320 and the virtual image through the updated virtual projection plane 2330 (or reference coordinate system), and improve the precision of interaction.

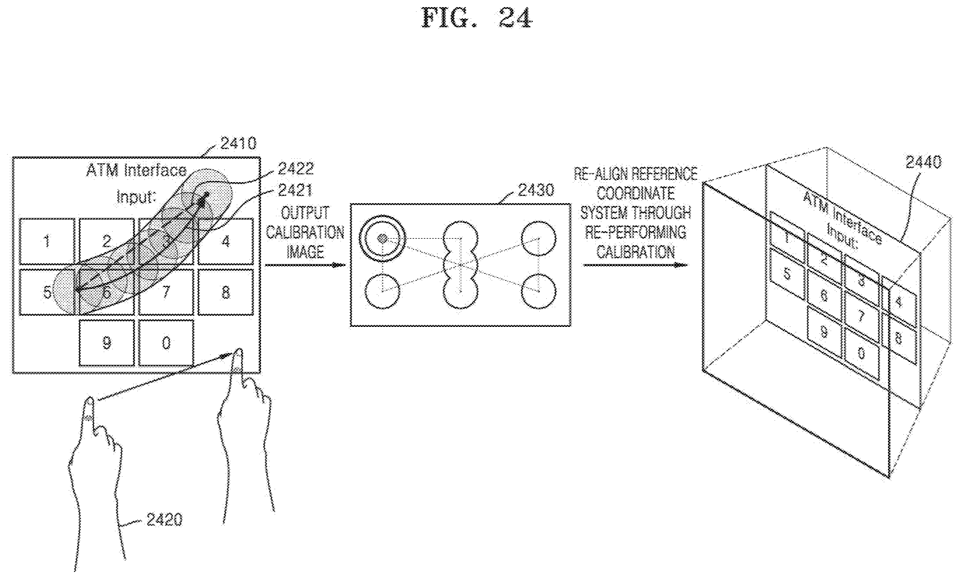

FIG. 24 is a diagram illustrating an operation in which the electronic device 100 re-performs calibration based on detecting that a second condition is satisfied according to an embodiment of the disclosure.

Referring to FIG. 24, in an embodiment of the disclosure, the electronic device 100 may re-perform a calibration process based on detecting that the second condition regarding a movement trajectory 2421 of a hand is satisfied. For example, when the movement trajectory 2421 of the hand mapped onto a virtual projection plane differs by more than a defined (e.g., predefined) threshold deviation from a virtual reference straight line 2422 (or a virtual straight path), as it is detected that the second condition is satisfied, the electronic device 100 may re-perform the calibration process.

In an embodiment of the disclosure, by performing a matrix product operation between hand coordinates obtained through an image sensor and a transform matrix, the electronic device 100 may map the hand coordinates on a user interaction space into coordinates (hereinafter referred to as mapping coordinates) on the virtual projection plane on which a virtual image is output. The electronic device 100 may obtain continuous image frames through the image sensor. By time-sequentially accumulating the mapping coordinates transformed onto a virtual projection plane 2410, the electronic device 100 may track the movement trajectory 2421 of the hand on the virtual projection plane 2410.

In an embodiment of the disclosure, the electronic device 100 may detect whether the movement trajectory 2421 of the hand mapped onto the virtual projection plane 2410 differs by more than the defined (e.g., predefined) threshold deviation from the virtual reference straight line 2422. In the disclosure, the threshold deviation may encompass not only a spatial deviation distance from a reference movement path, but also the degree of decline in similarity indicating consistency in a movement direction.

For example, the electronic device 100 may generate the virtual reference straight line 2422 connecting a manipulation start point of a user 2420 to a current position. The electronic device 100 may calculate an orthogonal distance between mapping coordinates calculated for each image frame and the virtual reference straight line 2422. In this regard, the threshold deviation may correspond to a distance threshold based on the orthogonal distance. The electronic device 100 may detect whether a state in which the orthogonal distance of each frame exceeds the distance threshold is continuously maintained for a defined (e.g., a predefined number of reference frames). Alternatively, the electronic device 100 may calculate an arithmetic average with respect to a plurality of orthogonal distance values obtained within a specific time (or a specific number of frames) and detect whether the arithmetic average exceeds the distance threshold. Alternatively, the electronic device 100 may accumulate the absolute amount or square value of the plurality of orthogonal distance values obtained within the specific time (or the specific number of frames), calculate the total cumulative deviation, and detect whether the total cumulative deviation value exceeds the distance threshold.

For example, the electronic device 100 may analyze an angle between a movement vector based on a movement trajectory within the specific time (or the specific number of frames) and the virtual reference straight line 2422 and calculate a cosine similarity value with respect to the angle. In this regard, the threshold deviation may correspond to a similarity threshold based on cosine similarity. The electronic device 100 may detect whether the calculated cosine similarity value is reduced to less than the similarity threshold.

However, a method, performed by the electronic device 100, of detecting whether the movement trajectory 2421 of the hand differs by more than the defined (e.g., predefined) threshold deviation from the virtual reference straight line 2422 is not limited thereto. For example, the electronic device 100 may estimate a best fit line by applying a least squares method to a plurality of mapping coordinates, and detect whether a determination coefficient representing the degree of agreement between the best fit line and the actual movement trajectory falls below a threshold. Alternatively, the electronic device 100 may detect whether the movement trajectory 2421 of the hand differs by more than the threshold deviation based on the curvature of the movement trajectory 2421 of the hand or the movement acceleration of the hand.

When the movement trajectory 2421 of the hand mapped onto the virtual projection plane 2410 differs by more than the defined (e.g., predefined) threshold deviation from the virtual reference straight line 2422, the electronic device 100 may re-perform the calibration process by considering that it is detected that the second condition is satisfied. After detecting that the second condition is satisfied, the electronic device 100 may perform operations S2010, S2020, S2030, and S2040 of FIG. 20 again. The electronic device 100 may output a calibration image 2430 again to obtain hand coordinate data corresponding to each of calibration points. Accordingly, the electronic device 100 may re-generate a new transform matrix by re-performing calibration. Upon re-performing calibration, the virtual projection plane 2410 may vary in a position and/or inclination on a 3D space including a depth direction (z-axis) component, in addition to simply varying the geometric shape of horizontal and vertical axis components. Therefore, the virtual projection plane 2410 (or reference coordinate system) may be updated to a new virtual projection plane 2440 to which 3D spatial deformation is applied based on the re-generated transform matrix. Accordingly, the electronic device 100 may maintain spatial consistency between the input coordinates of the user 2420 and the virtual image through the updated virtual projection plane 2440 (or reference coordinate system), and improve the precision of interaction. Even though an error occurs in the depth perception of the virtual image during use by the user 2420, the electronic device 100 may induce the depth of the virtual image to be more accurately perceived through re-performing calibration.

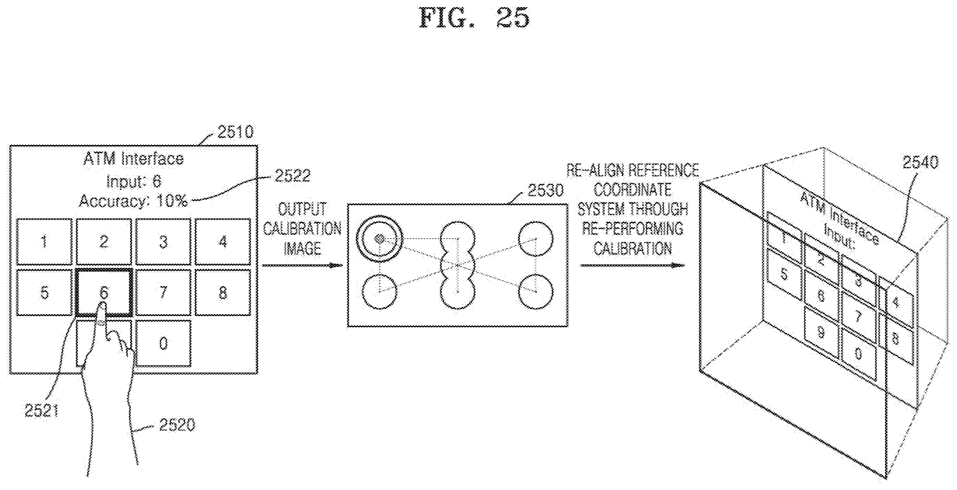

FIG. 25 is a diagram illustrating an operation in which the electronic device 100 re-performs calibration based on detecting that a second condition is satisfied according to an embodiment of the disclosure.

Referring to FIG. 25, in an embodiment of the disclosure, the electronic device 100 may re-perform a calibration process based on detecting that the second condition regarding a selection accuracy 2522 is satisfied. For example, when the selection accuracy 2522 of an interaction target object 2521 is below a defined (e.g., predefined) threshold value, the electronic device 100 may re-perform the calibration process as it is detected that the second condition is satisfied.

In an embodiment of the disclosure, when a selection input of a user 2520 of the specific interaction target object 2521 is received, the electronic device 100 may calculate the selection accuracy 2522 of the selected interaction target object 2521.

In an embodiment of the disclosure, the electronic device 100 may calculate selection coordinates of the interaction target object 2521. For example, the electronic device 100 may calculate position coordinates at a time a selection event occurs (e.g., a click time, a well completion time, etc.) as the selection coordinates of the interaction target object 2521. For example, the electronic device 100 may calculate average position coordinates for a specific time (or a specific frame) before the selection event occurs as the selection coordinates of the interaction target object 2521. For example, the electronic device 100 may calculate position coordinates in a movement path of a hand closest to center coordinates of the interaction target object 2521 as the selection coordinates of the interaction target object 2521. The electronic device 100 may calculate the selection accuracy 2522 based on a distance between the selection coordinates of the interaction target object 2521 and the center coordinates of the interaction target object 2521. In this regard, as the distance increases, the selection accuracy 2522 may have a lower value.

In an embodiment of the disclosure, the electronic device 100 may calculate an area in which a user input is recognized. For example, the electronic device 100 may calculate the area in which the user input is recognized by applying a boundary range with respect to the selection coordinates of the interaction target object 2521. The boundary range may be set to a fixed value (e.g., a certain radius), or may be variably adjusted according to depth information of the hand of the user 2520. The electronic device 100 may calculate the selection accuracy 2522 based on the degree of overlap between the area in which the user input is recognized and an area of the interaction target object 2521. In this case, as the degree of overlap increases, the selection accuracy 2522 may have a higher value.

In an embodiment of the disclosure, when a user input for selecting the interaction target object 2521 is received, the electronic device 100 may perform an operation or function corresponding to the selected interaction target object 2521 and display the selection accuracy 2522 of the selected interaction target object 2521. For example, when a user input for selecting the interaction target object 2521 (e.g., a button-type UI element) corresponding to an input of the number ‘6’ is received, the electronic device 100 may display the number ‘6’ on an input item (e.g., ‘Input:’) and display the selection accuracy 2522 (e.g., ‘Accuracy: 10%’) together.

When the selection accuracy 2522 of the selected interaction target object 2521 is below the defined (e.g., predefined) threshold value, the electronic device 100 may re-perform the calibration process by considering that it is detected that the second condition is satisfied. After detecting that the second condition is satisfied, the electronic device 100 may perform operations S2010, S2020, S2030, and S2040 of FIG. 20 again. The electronic device 100 may output a calibration image 2530 again to obtain hand coordinate data corresponding to each of calibration points. Accordingly, the electronic device 100 may re-generate a new transform matrix by re-performing calibration. Therefore, the virtual projection plane 2510 (or reference coordinate system) may be updated to a new virtual projection plane 2540 to which 3D spatial deformation is applied based on the re-generated transform matrix. Accordingly, even though an error occurs in the depth perception of a virtual image during use by the user 2520, the electronic device 100 may induce the depth of the virtual image to be more accurately perceived through re-performing calibration.

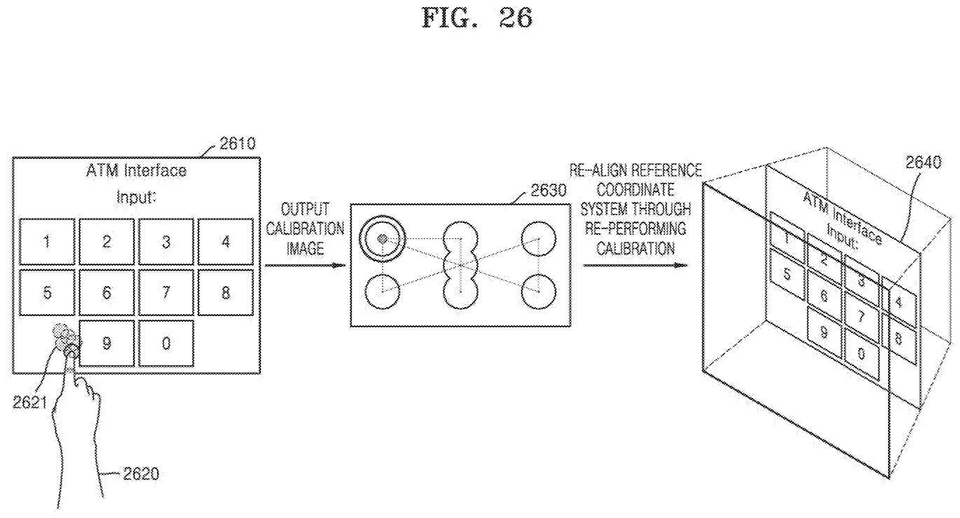

FIG. 26 is a diagram illustrating an operation in which the electronic device 100 re-performs calibration based on detecting that a second condition is satisfied according to an embodiment of the disclosure.

Referring to FIG. 26, in an embodiment of the disclosure, the electronic device 100 may re-perform a calibration process based on detecting that the second condition regarding the number of selection failures is satisfied. For example, even though a selection signal 2621 of a user 2620 for selecting a specific interaction target object has been detected, when the interaction target object remains in an inactive state for more than a defined (e.g., predefined) threshold number of times, the electronic device 100 may re-perform the calibration process as it is detected that the second condition is satisfied.

In an embodiment of the disclosure, the electronic device 100 may track z-axis coordinates of a fingertip of the user 2620. When detecting that the fingertip of the user 2620 has entered more than a defined (e.g., predefined) threshold depth with respect to a virtual projection plane 2610 on which a virtual image is displayed, the electronic device 100 may determine the motion as a user gesture for generating the selection signal 2621 (e.g., a ‘click’ or ‘push’ event) with respect to the interaction target object corresponding to the position.

In an embodiment of the disclosure, based on detecting a defined (e.g., predefined) user motion, the electronic device 100 may determine the motion as a user gesture for generating a selection signal with respect to an interaction target object corresponding to the position. For example, based on detecting an air tap motion of lightly flicking the index finger or a pinch motion of touching the thumb and the index finger together, the electronic device 100 may determine the motion as a user gesture for generating the selection signal 2621. However, the motion determined as the user gesture for generating the selection signal 2621 is not limited thereto.

In an embodiment of the disclosure, based on detecting a user motion in which transformation coordinates corresponding to a converted hand position of the user 2620 stays on the virtual projection plane 2610 for more than a defined (e.g., predefined) threshold time, the electronic device 100 may determine the user motion as a user gesture for generating the selection signal 2621 for the interaction target object corresponding to the position.

Based on the selection signal 2621 of the user 2620 for selecting the specific interaction target object being input within a valid area of the corresponding interaction target object, the electronic device 100 may convert the selected interaction target object into an active state and perform a corresponding function or operation. On the other hand, based on the selection signal 2621 of the user 2620 being input at a position outside the valid area of the interaction target object, the electronic device 100 may maintain the interaction target object in an inactive state.

In an embodiment of the disclosure, based on the selection signal 2621 has been detected but the number of times that the interaction target object remains in an inactive state being more than a threshold number of times, the electronic device 100 may re-perform the calibration process by considering that it is detected that the second condition is satisfied. After detecting that the second condition is satisfied, the electronic device 100 may perform operations S2010, S2020, S2030, and S2040 of FIG. 20 again. The electronic device 100 may output a calibration image 2630 again to obtain hand coordinate data corresponding to each of calibration points. Accordingly, the electronic device 100 may re-generate a new transform matrix by re-performing calibration. Therefore, the virtual projection plane 2610 (or reference coordinate system) may be updated to a new virtual projection plane 2640 to which 3D spatial deformation is applied based on the re-generated transform matrix. Accordingly, even when an error occurs in the depth perception of the virtual image during use by the user 2620, the electronic device 100 may induce the depth of the virtual image to be more accurately perceived through re-performing calibration.

The criterion for determining whether the second condition is satisfied is not limited to examples shown in FIGS. 24, 25, and 26. For example, when the time required for a touch motion of the user 2620 is more than the defined (e.g., predefined) threshold time or increases, the electronic device 100 may re-perform the calibration process by considering that it is detected that the second condition is satisfied. For example, when the cumulative time of the user 2620 using the electronic device 100 is more than the defined (e.g., predefined threshold time, the electronic device 100 may re-perform the calibration process by considering that it is detected that the second condition is satisfied. For example, when more than the defined (e.g., predefined) threshold time elapses after performing the calibration process, the electronic device 100 may re-perform the calibration process by considering that it is detected that the second condition is satisfied.

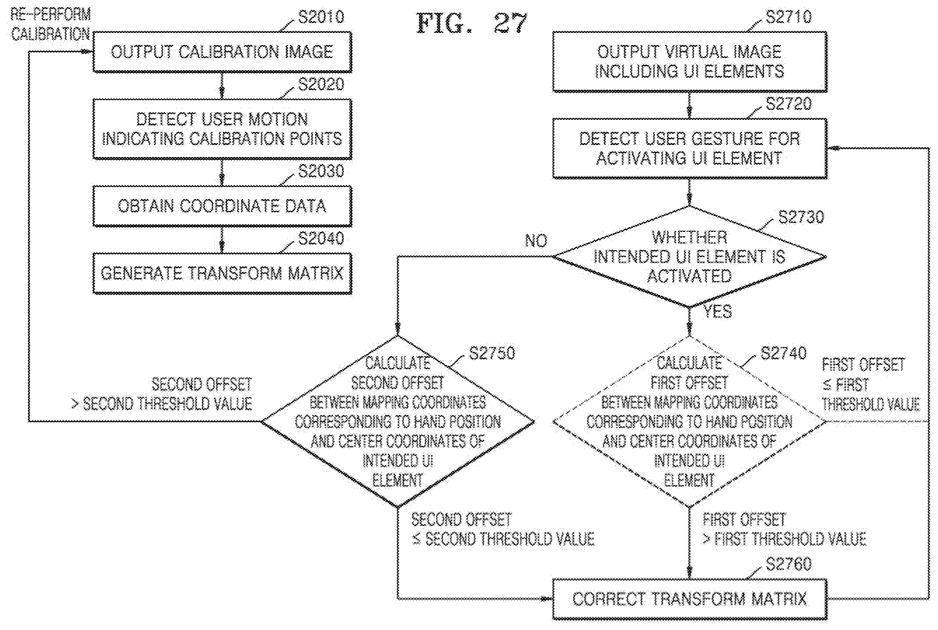

FIG. 27 is a flowchart illustrating a method, performed by the electronic device 100, of correcting or re-calibrating a transform matrix based on whether an intended UI element is activated according to an embodiment of the disclosure.

Referring to FIG. 27, a method of providing a virtual image through the electronic device 100 may include operations S2010, S2020, S2030, and S2040 and operations S2710, S2720, S2730, S2740, S2750, and S2760. In an embodiment of the disclosure, operations S2010, S2020, S2030, and S2040 and operations S2710, S2720, S2730, S2740, S2750, and S2760 may be executed by at least one processor included in the electronic device 100. Operations S2010, S2020, S2030, and S2040 of FIG. 27 respectively correspond to operations S2010, S2020, S2030, and S2040 of FIG. 20, and thus, redundant descriptions thereof are omitted.

Operation S2710 of FIG. 27 may particularly specify operation S2050 of FIG. 20. Operation S2720 of FIG. 27 may particularly specify operation S2060 of FIG. 20. Operations S2730, S2740, and S2750 of FIG. 27 may particularly specify operations S2070 and S2090 of FIG. 20, respectively. Operation S2760 of FIG. 27 may correspond to operation S2080 of FIG. 20.

In operation S2710 of FIG. 27, the electronic device 100 according to an embodiment of the disclosure may output a virtual image including one or more UI elements. In operation S2720 of FIG. 27, the electronic device 100 according to an embodiment of the disclosure may detect a user gesture for activating a specific UI element.

For example, the electronic device 100 may detect whether the user gesture for generating a selection signal of a user for selecting a corresponding UI element within a valid area of the specific UI element has occurred. Based on a user's fingertip entering more than a threshold depth with respect to virtual projection plane, a user motion (e.g., air tap motion, pinch motion, etc.) corresponding to the generation of the selection signal being detected, or a user motion staying for more than a threshold time being detected, the electronic device 100 may determine the motion as a user gesture for generating the selection signal with respect to a UI element corresponding to the position.

In operation S2730 of FIG. 27, the electronic device 100 according to an embodiment of the disclosure may identify whether the intended UI element is activated. In operation S2730 of FIG. 27, based on the intended UI being activated, the electronic device 100 may perform operation S2740 to calculate a first offset between mapping coordinates corresponding to a hand position and center coordinates of the intended UI element. In operation S2740, based on the first offset between the hand coordinates and the center coordinates of the intended UI element being less than or equal to a first threshold value, the electronic device 100 may perform operation S2720 again. In operation S2740, based on the first offset between the mapping coordinates corresponding to a hand position and the center coordinates of the intended UI element exceeding the first threshold value, the electronic device 100 may perform operation S2760 to correct a transform matrix. Operations S2730 and S2740 may particularly specify operation S2070 of FIG. 20. Detailed descriptions of operations S2730 and S2740 will be provided below with reference to FIGS. 28A and 28B.

In an embodiment of the disclosure, the transform matrix may be corrected based on the occurrence of the first offset regardless of whether the first offset between the mapping coordinates corresponding to the hand position and the center coordinates of the intended UI element is greater than or equal to a specific threshold value in operation S2740.

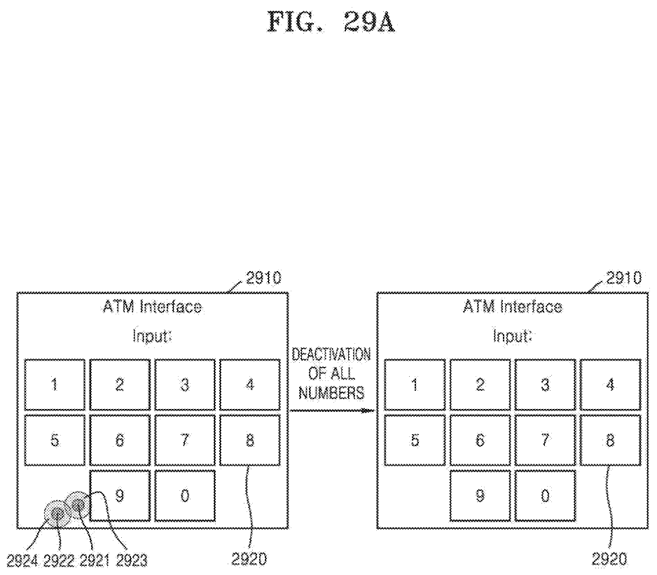

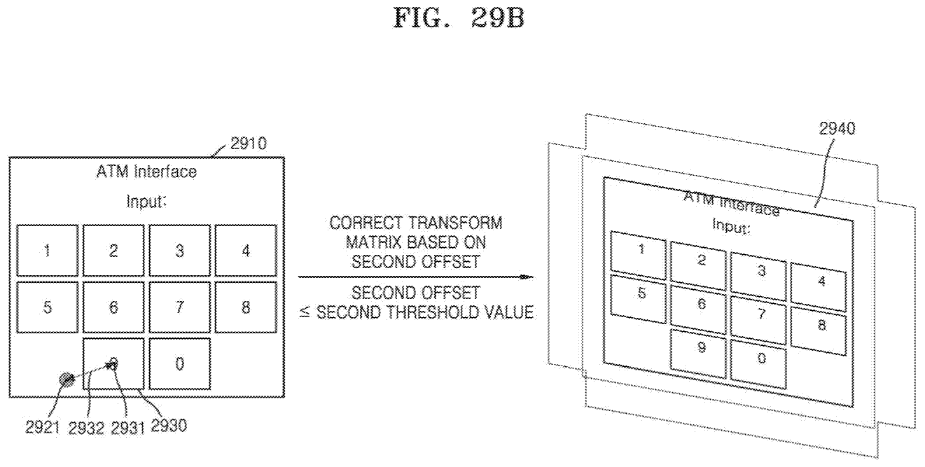

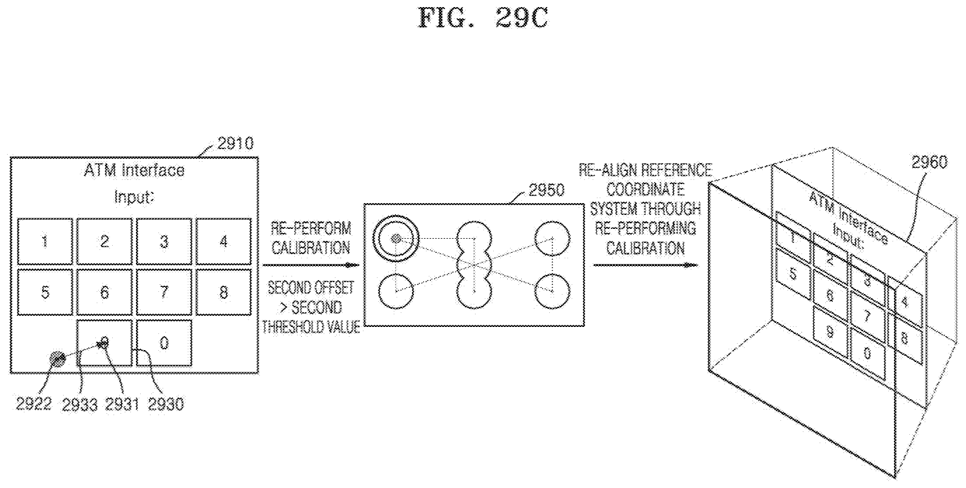

In operation S2730 of FIG. 27, based the intended UI element being deactivated, the electronic device 100 may perform operation S2750 to calculate a second offset between the mapping coordinates corresponding to the hand position and the center coordinates of the intended UI element. In operation S2750, based on the second offset between the mapping coordinates corresponding to the hand position and the center coordinates of the intended UI element being less than or equal to a second threshold value, the electronic device 100 may perform operation S2760 to correct the transform matrix. In operation S2750, based on the second offset between the mapping coordinates corresponding to the hand position and the center coordinates of the intended UI element exceeding the second threshold value, the electronic device 100 may perform operation S2010 again to re-perform calibration. Operations S2730 and S2750 may particularly specify operation S2090 of FIG. 20. Detailed descriptions of operations S2730 and S2750 will be provided below with reference to FIGS. 29A, 29B, and 29C.

FIG. 28A is a diagram illustrating an operation in which the electronic device 100 detects activation of an intended UI element 2821 according to an embodiment of the disclosure. FIG. 28B is a diagram illustrating an operation in which the electronic device 100 corrects a transform matrix based on a first offset 2833 according to an embodiment of the disclosure.

Referring to FIG. 28A, in an embodiment of the disclosure, the electronic device 100 may provide a virtual image including one or more interaction target objects. For example, the electronic device 100 may provide a virtual image including one or more UI elements configured as button-type objects for inducing a user input.

In an embodiment of the disclosure, by performing a matrix product operation between hand coordinates obtained through an image sensor and the transform matrix, the electronic device 100 may map the hand coordinates on a user interaction space into coordinates (hereinafter referred to as mapping coordinates) on a virtual projection plane on which the virtual image is output. The electronic device 100 may detect that mapping coordinates 2822 corresponding to a hand position on a virtual projection plane 2810 are located within an interaction valid area of the UI element 2821 corresponding to the number ‘6’. When it is detected that a user's hand crosses the virtual projection plane 2810 or contacts the virtual projection plane 2810, the electronic device 100 may determine that the user's hand is in a touch state, and may provide a touch recognition indicator 2823 on the virtual projection plane 2810.

The electronic device 100 may receive a valid selection (e.g., click event or push event) signal with respect to the UI element 2821 corresponding to the number ‘6’based on detecting a user gesture for generating a defined (e.g., predefined) selection signal within the interaction valid area of the UI element 2821 corresponding to the number ‘6’.

The electronic device 100 may convert the UI element 2821 corresponding to the number ‘6’ from a standby state to an active state. The electronic device 100 may provide visual feedback 2824 indicating that the UI element 2821 corresponding to the number ‘6’ is activated. For example, the electronic device 100 may change the color or thickness of the UI element 2821 corresponding to the number ‘6’, or may apply a 3D animation effect that simulates the sensation of being pressed. The electronic device 100 may perform an operation of inputting the number ‘6’ mapped to the activated UI element 2821, and may display the number ‘6’ on an input item 2825 (e.g., text field) of the virtual image.

Referring to FIG. 28B, in an embodiment of the disclosure, the electronic device 100 may calculate the first offset 2833 between mapping coordinates 2831 corresponding to a hand position and center coordinates 2832 of the intended UI element 2821 based on the intended UI element 2821 being activated.

The electronic device 100 may calculate the mapping coordinates 2831 corresponding to the hand position. For example, the electronic device 100 may determine mapping coordinates on the virtual projection plane 2810 corresponding to the hand position at a time a selection event occurs (e.g., a click time, a well completion time, etc.) as the mapping coordinates 2831 corresponding to the hand position. For example, the electronic device 100 may determine average position coordinates for a specific time (or a specific frame) before the selection event occurs as the mapping coordinates 2831 corresponding to the hand position.

The electronic device 100 may calculate the center coordinates 2832 of the intended UI element 2821. In this regard, the intended UI element 2821 may be a UI element selected by a user. For example, the center coordinates 2832 of the UI element 2821 may be determined as a geometric center point of the boundary area of the interaction target object corresponding to the UI element 2821, or may be determined as a weighted center or predefined representative coordinates when the shape of the interaction target object is atypical.

The electronic device 100 may calculate a difference between the mapping coordinates 2831 corresponding to the hand position and the center coordinates 2832 of the selected UI element 2821 as the first offset 2833 in the form of a vector. When the center coordinates 2832 of the selected UI element 2821 are calculated as ‘(x₁, y₁)’, and the mapping coordinates 2831 corresponding to the hand position are calculated as ‘(x₂, y₂)’, the first offset 2833 may be calculated as ‘(Δx=x₂−x₁, Δy=y₂−y₁)’.

The electronic device 100 may correct the transform matrix by using the calculated first offset 2833. When the first offset 2833 exceeds a defined (e.g., predefined) first threshold value, the electronic device 100 may reflect the first offset 2833 to the transform matrix currently in use and correct a coordinate transformation relationship. The electronic device 100 may adjust a parallel movement component of the transform matrix by using a horizontal axis component (i.e., Δx) and a vertical axis component (i.e., Δy) of the first offset 2833. For example, the electronic device 100 may reflect a weight coefficient for adjusting a correction strength and the horizontal axis component of the first offset 2833 to a parallel movement component of the transform matrix in a horizontal axis direction. The electronic device 100 may reflect the weight coefficient for adjusting the correction strength and the vertical axis component of the first offset 2833 to the parallel movement component of the transform matrix in a vertical axis direction.

According to an embodiment of the disclosure, when it is detected that the UI element 2821 being selected at a position more than a certain distance away from the center coordinates 2832 of the selected UI element 2821, the electronic device 100 may correct the transform matrix by considering that spatial consistency between user input coordinates and the virtual image is reduced. Accordingly, the geometric shape of horizontal and vertical axis components constituting the virtual projection plane 2810 (or reference coordinate system) to which the user input coordinates on a 3D space are mapped may be varied. The virtual projection plane 2810 (or reference coordinate system) may be updated to a new virtual projection plane 2840 to which 2D plane deformation is applied based on the corrected transform matrix. Accordingly, the electronic device 100 may maintain spatial consistency between the user input coordinates and the virtual image through the updated virtual projection plane 2840 (or reference coordinate system), and improve the precision of interaction.

FIG. 29A is a diagram illustrating an operation in which the electronic device 100 fails to detect activation of an intended UI element 2930 according to an embodiment of the disclosure. FIG. 29B is a diagram illustrating an operation in which the electronic device 100 corrects a transform matrix based on a second offset 2932 according to an embodiment of the disclosure. FIG. 29C is a diagram illustrating an operation in which the electronic device 100 re-performs calibration based on a second offset 2933 according to an embodiment of the disclosure.

Referring to FIG. 29A, in an embodiment of the disclosure, when it is detected that a user's hand crosses a virtual projection plane 2910 or contacts the virtual projection plane 2910, the electronic device 100 may determine that the user's hand is in a touch state, and may provide a touch recognition indicator 2923 or 2924 onto the virtual projection plane 2910. FIG. 29A shows mapping coordinates 2921 corresponding to a hand position in a first case and mapping coordinates 2922 corresponding to a hand position in a second case together. FIG. 29A shows the touch recognition indicator 2923 provided in the first case and the touch recognition indicator 2924 provided in the second case together.

In an embodiment of the disclosure, when the mapping coordinates 2921 or 2922 corresponding to the hand position are not included in an interaction valid area of any UI element 2920, even though a user gesture for generating a selection signal is detected, the electronic device 100 may not recognize the user gesture as a valid selection input. Accordingly, the electronic device 100 may maintain an inactive state without giving an active state to all UI elements 2920. For example, the electronic device 100 may detect that the mapping coordinates 2921 or 2922 corresponding to the hand position are located adjacent to an UI element corresponding to the number ‘9’ on the virtual projection plane 2910 but exist outside an interaction valid area of the UI element corresponding to the number ‘9’. In this regard, even when the user gesture for generating the selection signal is detected at a corresponding position, the electronic device 100 may not recognize the user gesture as the valid selection input, and all UI elements 2920 may remain in the inactive state. Accordingly, a number may not be additionally input to an input item (e.g., text field) of a virtual image.

FIG. 29B shows the operation of the electronic device 100 when the mapping coordinates corresponding to the hand position in the first case of FIG. 29A are detected. Referring to FIG. 29B, in an embodiment of the disclosure, the electronic device 100 may calculate the second offset 2932 between the mapping coordinates 2921 corresponding to the hand position and center coordinates 2931 of the intended UI element 2930 based on the intended UI element 2930 remaining in the inactive state. In this regard, the intended UI element 2930 may be determined as a UI element closest to the mapping coordinates 2921 corresponding to the hand position. Because the mapping coordinates 2921 corresponding to the hand position in the first case (hereinafter, referred to as the first mapping coordinates 2921) are located closest to the UI element 2930 corresponding to the number ‘9’, the intended UI element 2930 may be determined as the UI element 2930 corresponding to the number ‘9’.

The electronic device 100 may calculate the first mapping coordinates 2921 and the center coordinates 2931 of the intended UI element 2930. The descriptions with reference to FIG. 28B above may be equally applied to a method of calculating the mapping coordinates 2921 corresponding to the hand position and a method of calculating the center coordinates 2931 of the UI element 2930. The electronic device 100 may calculate a difference between the first mapping coordinates 2921 and the center coordinates 2931 of the intended UI element 2930 as the second offset 2932 in the form of a vector.

Based on the second offset 2932 being less than or equal to a second threshold value, the electronic device 100 may correct the transform matrix by using the second offset 2932 by considering that a first condition is satisfied. The electronic device 100 may reflect the second offset 2932 to the transform matrix currently in use and correct a coordinate transformation relationship. The description with reference to FIG. 28B above may be equally applied to a method of correcting the transform matrix by using a calculated offset.

According to an embodiment of the disclosure, when a selection signal is input at a position within a certain distance away from the center coordinates 2931 of the unintended UI element 2930 that is not selected, the transform matrix may be corrected by considering that spatial consistency between user input coordinates and the virtual image is reduced. Accordingly, the geometric shape of horizontal and vertical axis components constituting the virtual projection plane 2910 (or reference coordinate system) to which the user input coordinates on a 3D space are mapped may be varied. The virtual projection plane 2910 (or the existing reference coordinate system) may be updated to a new virtual projection plane 2940 to which 2D plane deformation is applied based on the corrected transform matrix. Accordingly, the electronic device 100 may maintain spatial consistency between the user input coordinates and the virtual image through the updated virtual projection plane 2940 (or updated reference coordinate system), and improve the precision of interaction.

FIG. 29C shows the operation of the electronic device 100 when the mapping coordinates 2922 corresponding to the hand position in the second case of FIG. 29A are detected. Referring to FIG. 29C, in an embodiment of the disclosure, the electronic device 100 may calculate the second offset 2933 between the mapping coordinates 2922 corresponding to the hand position and the center coordinates 2931 of the intended UI element 2930 based on the intended UI element 2930 remaining in the inactive state. In this regard, the intended UI element 2930 may be determined as a UI element closest to the mapping coordinates 2922 corresponding to the hand position. Because the mapping coordinates 2922 corresponding to the hand position in the second case (hereinafter, referred to as the second mapping coordinates 2922) are located closest to the UI element 2930 corresponding to the number ‘9’, the intended UI element 2930 may be determined as the UI element 2930 corresponding to the number ‘9’.

The electronic device 100 may calculate the second mapping coordinates 2922 and the center coordinates 2931 of the intended UI element 2930. The electronic device 100 may calculate a difference between the second mapping coordinates 2922 and the center coordinates 2931 of the intended UI element 2930 as the second offset 2933 in the form of a vector. The electronic device 100 may re-perform calibration by considering that a second condition is satisfied based on the second offset 2933 exceeding the second threshold value. After detecting that the second condition is satisfied, the electronic device 100 may perform operations S2010, S2020, S2030, and S2040 of FIG. 27 again. For example, as described above with reference to FIG. 21, the electronic device 100 may obtain coordinate data by outputting a calibration image 2950 in which calibration points are displayed and detecting a user motion indicating the calibration points. The electronic device 100 may re-generate a new transform matrix based on the newly obtained coordinate data.

Upon re-performing calibration, the virtual projection plane 2910 may vary in a position and/or inclination on a 3D space including a depth direction (z-axis) component, in addition to simply varying the geometric shape of horizontal and vertical axis components. Therefore, the virtual projection plane 2910 may be updated to a new virtual projection plane 2960 to which 3D spatial deformation is applied based on the re-generated transform matrix.

When viewing a virtual image floating on a virtual projection plane, a user may perceive the depth of the virtual image differently due to a perception change during use. In this regard, alignment errors between the user input coordinates and the virtual projection plane may accumulate while using, and it may be difficult to reduce alignment errors only by 2D correction through correction of the transform matrix. According to an embodiment of the disclosure, when a selection signal is input at a position more than a certain distance away from center coordinates of an unselected intended UI element, by considering that it is difficult to reduce alignment errors only by 2D correction through correction of the transform matrix, the electronic device 100 may re-perform calibration and re-generate a new transform matrix. Accordingly, even though an error occurs in the depth perception of the virtual image while the user is using it, the electronic device 100 may induce the depth of the virtual image to be more accurately perceived by performing calibration again. In order to solve the above-described technical problem, in an embodiment of the disclosure, the electronic device 100 is provided.

In an embodiment of the disclosure, the electronic device 100 may include at least one processor configured to obtain an input image, and generate a flipped image by performing correction to flip the input image. In an embodiment of the disclosure, the electronic device 100 may include the optical engine 111 configured to provide light of the flipped image when receiving the flipped image. In an embodiment of the disclosure, the electronic device 100 may include the waveguide 112 including the first optical coupling area 10 configured to direct the light of the flipped image provided from the optical engine 111 to be incident into the waveguide 112 and the second optical coupling area 20 configured to emit the light of the flipped image incident through the first optical coupling area 10 to the outside.

In an embodiment of the disclosure, the electronic device 100 may include the lens 113 located on the front surface of the waveguide 112 and configured to provide the virtual image 200 in which the input image is floating on a virtual projection plane by focusing the light of the flipped image emitted through the second optical coupling area 20 as an inverted image on the virtual projection plane.

In an embodiment of the disclosure, the waveguide 112 may be configured to emit the light of the flipped image as parallel light through the second optical coupling area 20. In an embodiment of the disclosure, the lens 113 may be configured to focus the parallel light emitted through the waveguide 112 onto the virtual projection plane. In an embodiment of the disclosure, the virtual projection plane may correspond to the focal plane of the lens 113.

In an embodiment of the disclosure, the lens 113 may be configured to implement a variable focal length.

In an embodiment of the disclosure, the waveguide 112 may further include the third optical coupling area 30 for emitting external light incident into the waveguide 112 from the virtual projection plane through the second optical coupling area 20 to the image sensor 140.

In an embodiment of the disclosure, the electronic device 100 may include the image sensor 140 that receives external light emitted through the third optical coupling area 30 and obtains an image of the real world on the virtual projection plane.

In an embodiment of the disclosure, a plurality of lenses 113 may be provided. The plurality of lenses 113 may include the first lens 113a overlapping a part of the second optical coupling area 20 and having a first focal length, and the second lens 113b overlapping another part of the second optical coupling area 20 and having a second focal length different from the first focal length. In an embodiment of the disclosure, the image of the real world may include a first image on a first virtual projection plane corresponding to the first focal length and a second image on a second virtual projection plane corresponding to the second focal length.

In an embodiment of the disclosure, the image sensor 140 may include the first image sensor 141 that receives external light that passes through the first lens 113a and is incident into the waveguide 112 and the second image sensor 142 that receives the external light that passes through the second lens 113b and is incident into the waveguide 112.

In an embodiment of the disclosure, the waveguide 112 may include the fourth optical coupling area 40 spaced apart from the second optical coupling area 20 and configured to direct external light to be incident into the waveguide 112 from the virtual projection plane, and the third optical coupling area 30 configured to emit the external light incident into the waveguide 112 from the virtual projection plane through the fourth optical coupling area 40 to the image sensor 140. In an embodiment of the disclosure, the electronic device 100 may include the image sensor 140 that receives the external light emitted through the third optical coupling area 30 and obtains an image of the real world on the virtual projection plane.

In an embodiment of the disclosure, a plurality of lenses 113 may be provided. The plurality of lenses 113 may include the first lens 113a overlapping a part of the fourth optical coupling area 40 and having a first focal length, and the second lens 113b overlapping another part of the fourth optical coupling area 40 and having a second focal length different from the first focal length. In an embodiment of the disclosure, the image of the real world may include a first image on a first virtual projection plane corresponding to the first focal length and a second image on a second virtual projection plane corresponding to the second focal length.

In an embodiment of the disclosure, the electronic device 100 may include the memory 120 that stores instructions. In an embodiment of the disclosure, the at least one processor 130 may be operably coupled to the memory 120 and include processing circuitry. In an embodiment of the disclosure, the at least one processor 130 may individually or collectively execute the instructions to cause the electronic device 100 to recognize a user's gesture on the virtual image 200 based on the image of the real world on the virtual projection plane. In an embodiment of the disclosure, the at least one processor 130 may individually or collectively execute the instructions to cause the electronic device 100 to perform an operation corresponding to the recognized gesture.

In an embodiment of the disclosure, the at least one processor 130 may individually or collectively execute the instructions to cause the electronic device 100 to detect a user's hand based on the image of the real world. In an embodiment of the disclosure, the at least one processor 130 may individually or collectively execute the instructions to cause the electronic device 100 to determine a distance between the hand and the virtual projection plane based on the degree of blur of the hand detected in the image of the real world. The at least one processor 130 may individually or collectively execute the instructions to cause the electronic device 100 to provide an indicator indicating the distance between the hand and the virtual projection plane on the virtual projection plane.

In an embodiment of the disclosure, the at least one processor 130 may individually or collectively execute the instructions to cause the electronic device 100 to provide a calibration image including a plurality of calibration points. In an embodiment of the disclosure, the at least one processor 130 may individually or collectively execute the instructions to cause the electronic device 100 to obtain hand coordinate data of the user corresponding to the plurality of calibration points, by detecting a motion of the user indicating the plurality of calibration points. In an embodiment of the disclosure, the at least one processor 130 may individually or collectively execute the instructions to cause the electronic device 100 to generate a transform matrix for transforming a hand position of the user into coordinates on the virtual projection plane, based on the hand coordinate data.

In an embodiment of the disclosure, the at least one processor 130 may individually or collectively execute the instructions to cause the electronic device 100 to correct the transform matrix, by using an offset between reference point coordinates and the coordinates on the virtual projection plane corresponding to the hand position of the user, based on detecting that a defined (e.g., predefined) first condition is satisfied. In an embodiment of the disclosure, the defined (e.g., predefined) first condition may include at least one of whether the hand has deviated, whether a minute movement of the hand is repeated, or whether the offset exceeds a defined (e.g., predefined) threshold value.

In an embodiment of the disclosure, the at least one processor 130 may individually or collectively execute the instructions to cause the electronic device 100 to re-generate the transform matrix by providing the calibration image again, based on detecting that a defined (e.g., predefined) second condition is satisfied. In an embodiment of the disclosure, the defined (e.g., predefined) second condition may include a condition with respect to at least one of hand coordinate trajectory, selection accuracy, number of selection failures, touch duration, or usage time.

In an embodiment of the disclosure, the at least one processor 130 may individually or collectively execute the instructions to cause the electronic device 100 to provide the virtual image 200 with a UI element capable of user interaction. In an embodiment of the disclosure, the at least one processor 130 may individually or collectively execute the instructions to cause the electronic device 100 to detect a user's gesture for selecting the UI element. In an embodiment of the disclosure, the at least one processor 130 may individually or collectively execute the instructions to cause the electronic device 100 to activate the UI element based on detecting the user's gesture for selecting the UI element. In an embodiment of the disclosure, the at least one processor 130 may individually or collectively execute the instructions to cause the electronic device 100 to calculate a first offset between the coordinates on the virtual projection plane corresponding to the hand position of the user and center coordinates of the UI element, based on activating the UI element. In an embodiment of the disclosure, the at least one processor 130 may individually or collectively execute the instructions to cause the electronic device 100 to correct the transform matrix by using the first offset, based on the first offset exceeding a defined (e.g., predefined) first threshold value.

In an embodiment of the disclosure, the at least one processor 130 may individually or collectively execute the instructions to cause the electronic device 100 to provide the virtual image 200 including a UI element capable of user interaction. In an embodiment of the disclosure, the at least one processor 130 may individually or collectively execute the instructions to cause the electronic device 100 to detect a user's gesture for selecting the UI element. In an embodiment of the disclosure, the at least one processor 130 may individually or collectively execute the instructions to cause the electronic device 100 to calculate a second offset between the coordinates on the virtual projection plane corresponding to the hand position of the user and center coordinates of the UI element, based on deactivating the UI element. In an embodiment of the disclosure, the at least one processor 130 may individually or collectively execute the instructions to cause the electronic device 100 to correct the transform matrix by using the second offset, based on the second offset being less than or equal to a defined (e.g., predefined) second threshold value. In an embodiment of the disclosure, the at least one processor 130 may individually or collectively execute the instructions to cause the electronic device 100 to re-generating the transform matrix by providing the calibration image again, based on the second offset exceeding the defined (e.g., predefined) second threshold value.

In an embodiment of the disclosure, the electronic device 100 may further include the display 114 located on the back surface of the waveguide 112 and configured to display the input image.

In an embodiment of the disclosure, a method of providing the virtual image 200 through the electronic device 100 may be provided.

In an embodiment of the disclosure, the method may include operation S210 of obtaining an input image. In an embodiment of the disclosure, the method may include operation S220 of generating a flipped image by performing correction comprising flipping the input image horizontally and vertically. In an embodiment of the disclosure, the method may include operation S230 of providing the virtual image 200 in which the input image is floating by providing light of the flipped image to the first optical coupling area 10 of the waveguide 112 by using the optical engine 111, and emitting the light of the flipped image incident into the waveguide 112 to the outside of the waveguide 112 through the second optical coupling area 20 of the waveguide 112, directing the light of the flipped image to pass through the lens 113 and focusing the light of the flipped image as an inverted image on a virtual projection plane.

In an embodiment of the disclosure, operation S230 of providing the virtual image 200 may include operation S610 of emitting the light of the flipped image as parallel light through the second optical coupling area 20 by using the waveguide 112. In an embodiment of the disclosure, operation S230 of providing the virtual image 200 may include operation S620 of focusing the parallel light onto the virtual projection plane corresponding to a focal plane of the lens 113 by using the lens 113.

In an embodiment of the disclosure, the lens 113 may be configured to implement a variable focal length. In an embodiment of the disclosure, the method may include controlling the focal length of the lens 113 so that the position of the virtual projection plane is changed.

In an embodiment of the disclosure, the method may include operation S110 of receiving external light that is incident into the waveguide 112 from the virtual projection plane through the second optical coupling area 20 and is emitted through the third optical coupling area 30, by using the image sensor 140. In an embodiment of the disclosure, the method may include operation S1120 of obtaining an image of a real world on the virtual projection plane based on the received external light.

In an embodiment of the disclosure, the method may include obtaining a first image on a first virtual projection plane corresponding to a first focal length, by using the first lens 113a overlapping a part of the second optical coupling area 20 and having the first focal length. In an embodiment of the disclosure, the method may include obtaining a second image on a second virtual projection plane corresponding to a second focal length, by using the second lens 113b overlapping another part of the second optical coupling area 20 and having the second focal length different from the first focal length.

In an embodiment of the disclosure, the method may include operation S1210 of receiving, by using the image sensor 140, external light that is incident into the waveguide 112 from the virtual projection plane through the fourth optical coupling area 40 spaced apart from the second optical coupling area 20 and is emitted through the third optical coupling area 30. In an embodiment of the disclosure, the method may include operation S1220 of obtaining an image of a real world on the virtual projection plane based on the received external light.

In an embodiment of the disclosure, the method may include operation S1510 of recognizing a user's gesture on the virtual image 200 based on the image of the real world on the virtual projection plane. In an embodiment of the disclosure, the method may include operation S1520 of performing an operation corresponding to the recognized gesture.

In an embodiment of the disclosure, the method may include operation S1610 of detecting a user's hand based on the image of the real world. In an embodiment of the disclosure, the method may include operation S1620 of determining a distance between the hand and the virtual projection plane, based on a degree of blur of the hand detected in the image of the real world. In an embodiment of the disclosure, the method may include operation S1630 of providing an indicator indicating the determined distance between the hand and the virtual projection plane onto the virtual projection plane.

In an embodiment of the disclosure, the method may include providing a calibration image including a plurality of calibration points. In an embodiment of the disclosure, the method may include obtaining, by detecting a motion of the user indicating the plurality of calibration points, hand coordinate data of the user corresponding to the plurality of calibration points. In an embodiment of the disclosure, the method may include generating, based on the hand coordinate data, a transform matrix for transforming a hand position of the user into coordinates on the virtual projection plane.

In an embodiment of the disclosure, the method may include correcting the transform matrix, by using an offset between reference point coordinates and the coordinates on the virtual projection plane corresponding to the hand position of a hand of the user, based on detecting that a defined (e.g., predefined) first condition is satisfied. In an embodiment of the disclosure, the defined (e.g., predefined) first condition may include a condition with respect to at least one of whether the hand has deviated, whether a minute movement of the hand is repeated, or whether the offset exceeds a defined (e.g., predefined) threshold value.

In an embodiment of the disclosure, the method may include re-generating the transform matrix by providing the calibration image again, based on detecting that a defined (e.g., predefined) second condition is satisfied. In an embodiment of the disclosure, the defined (e.g., predefined) second condition may include a condition with respect to at least one of hand coordinate trajectory, selection accuracy, number of selection failures, touch duration, or usage time.

In an embodiment of the disclosure, the method may include providing the virtual image 200 with a UI element capable of user interaction. In an embodiment of the disclosure, the method may include detecting a user's gesture for selecting the UI element. In an embodiment of the disclosure, the method may include activating the UI element, based on detecting the user's gesture for selecting the UI element. In an embodiment of the disclosure, the method may include calculating a first offset between the coordinates on the virtual projection plane corresponding to the hand position of the user and center coordinates of the UI element, based on activating the UI element. In an embodiment of the disclosure, the method may include correcting the transform matrix by using the first offset, based on the first offset exceeding a defined (e.g., predefined) first threshold value.

In an embodiment of the disclosure, the method may include providing the virtual image 200 with a UI element capable of user interaction. In an embodiment of the disclosure, the method may include detecting a user's gesture for selecting the UI element. In an embodiment of the disclosure, the method may include calculating a second offset between the coordinates on the virtual projection plane corresponding to the hand position of the user and center coordinates of the UI element, based on deactivating the UI element. In an embodiment of the disclosure, the method may include correcting the transform matrix by using the second offset, based on the second offset being less than or equal to a defined (e.g., predefined) second threshold value. In an embodiment of the disclosure, the method may include re-generating the transform matrix by providing the calibration image again, based on the second offset exceeding the defined (e.g., predefined) second threshold value.

In an embodiment of the disclosure, the method may include displaying the input image by using the display 114.

A program executable by the electronic device 100 described in the disclosure may be implemented as a hardware element, a software element, and/or a combination of hardware elements and software elements. The program is executable by any system capable of executing computer-readable instructions.

The software may include a computer program, code, instructions, or a combination of one or more thereof, and may configure the processor to operate as desired or may independently or collectively instruct the processor.

The software may be implemented as a computer program that includes instructions stored in computer-readable storage media. The computer-readable storage media may include, for example, magnetic storage media (e.g., a read-only memory (ROM), a random-access memory (RAM), floppy disks, hard disks, etc.) and optical storage media (e.g., a compact disc ROM (CD-ROM), a digital versatile disc (DVD), etc.) The computer-readable recording medium may be distributed in computer systems connected via a network and may store and execute computer-readable code in a distributed manner. The recording medium is readable by a computer, stored in memory, and executable by a processor.

A computer-readable storage medium may be provided in the form of a non-transitory storage medium Here, ‘non-transitory’ means that the storage medium does not include a signal but is tangible, but does not mean that data is permanently or temporarily stored in the storage medium. For example, the ‘non-transitory storage medium’ may include a buffer in which data is temporarily stored.

In addition, the program according to embodiments of the disclosure may be included and provided in a computer program product. The computer program product may be traded as a product between a seller and a buyer.

The computer program product may include a software program and a computer-readable recording medium storing the software program. For example, the computer program product may include a product (e.g., a downloadable application) in the form of a software program electronically distributed via a manufacturer of the electronic device 100 or an electronic market (e.g., Samsung Galaxy Store™). For electronic distribution, at least part of the software program may be stored in a storage medium or temporarily generated. In this case, the storage medium may be a storage medium of a server of the manufacturer of the electronic device 100, a server of the electronic market, or a relay server that temporarily stores the software program.

The computer program product may include a storage medium of a server or a storage medium of the electronic device 100 in a system including the electronic device 100 and/or the server. Alternatively, when there is a third device communicatively connected to the electronic device 100, the computer program product may include a storage medium of the third device. Alternatively, the computer program product may include a software program itself transmitted from the electronic device 100 to the third device or transmitted from the third device to the electronic device 100.

In this case, one of the electronic device 100 or the third device may execute the computer program product to perform a method according to embodiments of the disclosure. Alternatively, at least one of the electronic device 100 or the third device may execute a computer program product to distribute and implement a method according to embodiments of the disclosure.

For example, the electronic device 100 may execute a computer program product stored in the memory 120 to control another electronic device communicatively connected to the electronic device 100 to perform the method according to embodiments of the disclosure.

As another example, the third device may execute the computer program product to control an electronic device communicatively connected to the third device to perform the method according to embodiments of the disclosure.

When the third device executes the computer program product, the third device may download a computer program product from the electronic device 100 and execute the downloaded computer program product. Alternatively, the third device may execute a computer program product provided in a pre-loaded state to perform the method according to embodiments of the disclosure.

Although embodiments of the disclosure have been described with the limited embodiments and the drawings, various modifications and changes may be made by one of skill in the art from the above descriptions. For example, appropriate results may be obtained even when the described techniques are performed in a different order, or when elements in a described electronic device, architecture, device, or circuit are coupled or combined in a different manner, or replaced or supplemented by other elements or their equivalents.

1. An electronic device for providing a virtual image, the electronic device comprising:
at least one processor configured to obtain an input image, and generate a flipped image by performing correction to flip the input image;
an optical engine configured to provide light of the flipped image when receiving the flipped image;
a waveguide comprising a first optical coupling area configured to direct the light of the flipped image provided from the optical engine to be incident into the waveguide and a second optical coupling area configured to emit the light of the flipped image incident through the first optical coupling area to outside; and
a lens located on a front surface of the waveguide and configured to provide the virtual image in which the input image is floating on a virtual projection plane by focusing the light of the flipped image emitted through the second optical coupling area as an inverted image on the virtual projection plane.

2. The electronic device of claim 1, wherein
the waveguide is configured to emit the light of the flipped image as parallel light through the second optical coupling area,
the lens is configured to focus the parallel light emitted through the waveguide onto the virtual projection plane, and
the virtual projection plane corresponds to a focal plane of the lens.

3. The electronic device of claim 1, wherein
the waveguide further comprises a third optical coupling area for emitting external light incident into the waveguide from the virtual projection plane through the second optical coupling area to an image sensor, and
the electronic device further comprising: the image sensor configured to receive the external light emitted through the third optical coupling area and obtain an image of a real world on the virtual projection plane.

4. The electronic device of claim 3, wherein
the lens is provided as a plurality of lenses, and the plurality of lenses comprise:
a first lens overlapping a part of the second optical coupling area and comprising a first focal length; and
a second lens overlapping another part of the second optical coupling area and comprising a second focal length different from the first focal length,
the image of the real world comprises a first image on a first virtual projection plane corresponding to the first focal length and a second image on a second virtual projection plane corresponding to the second focal length, and
the image sensor comprises:
a first image sensor configured to receive the external light that passes through the first lens and is incident into the waveguide; and
a second image sensor configured to receive the external light that passes through the second lens and is incident into the waveguide.

5. The electronic device of claim 1, wherein
the waveguide further comprises a fourth optical coupling area spaced apart from the second optical coupling area and configured to direct external light to be incident into the waveguide from the virtual projection plane, and a third optical coupling area configured to emit the external light incident into the waveguide from the virtual projection plane through the fourth optical coupling area to an image sensor,
the electronic device further comprising: the image sensor configured to receive the external light emitted through the third optical coupling area and obtain an image of a real world on the virtual projection plane.

6. The electronic device of claim 3, further comprising: memory storing instructions,
wherein the at least one processor is operably coupled to the memory, comprises processing circuitry, and is configured to individually or collectively execute the instructions to cause the electronic device to:
recognize a gesture of a user on the virtual image, based on the image of the real world on the virtual projection plane; and
perform an operation corresponding to the gesture.

7. The electronic device of claim 3, wherein
the at least one processor is configured to individually or collectively execute the instructions to cause the electronic device to:
detect a hand of a user, based on the image of the real world;
determine a distance between the hand and the virtual projection plane, based on a degree of blur of the hand detected in the image of the real world; and
provide an indicator indicating the distance between the hand and the virtual projection plane onto the virtual projection plane.

8. The electronic device of claim 3, wherein
the at least one processor is configured to individually or collectively execute the instructions to cause the electronic device to:
provide a calibration image comprising a plurality of calibration points;
obtain hand coordinate data of a user corresponding to the plurality of calibration points, by detecting a motion of the user indicating the plurality of calibration points; and
generate a transform matrix for transforming a hand position of the user into coordinates on the virtual projection plane, based on the hand coordinate data.

9. The electronic device of claim 8, wherein
the at least one processor is configured to individually or collectively execute the instructions to cause the electronic device to:
correct the transform matrix, by using an offset between reference point coordinates and the coordinates on the virtual projection plane corresponding to the hand position of the hand of the user, based on detecting that a defined first condition is satisfied; and
re-generate the transform matrix by providing the calibration image again, based on detecting that a defined second condition is satisfied, and
the defined first condition comprises at least one of whether the hand has deviated, whether a minute movement of the hand is repeated, or whether the offset exceeds a threshold value,
the defined second condition comprises a condition with respect to at least one of hand coordinate trajectory, selection accuracy, number of selection failures, touch duration, or usage time.

10. The electronic device of claim 1, further comprising: a display located on aback surface of the waveguide and configured to display the input image.

11. A method of providing a virtual image through an electronic device, the method comprising:
obtaining an input image;
generating a flipped image by performing correction comprising flipping the input image horizontally and vertically; and
providing the virtual image in which the input image is floating by providing light of the flipped image to a first optical coupling area of a waveguide by using an optical engine, and emitting the light of the flipped image incident into the waveguide to outside of the waveguide through a second optical coupling area of the waveguide, directing the light of the flipped image to pass through a lens, and focusing the light of the flipped image as an inverted image on a virtual projection plane.

12. The method of claim 11, wherein
the providing of the light of the flipped image to the first optical coupling area of the waveguide by using the optical engine comprises:
emitting the light of the flipped image as parallel light through the second optical coupling area, by using the waveguide; and
focusing the parallel light onto the virtual projection plane corresponding to a focal plane of the lens), by using the lens.

13. The method of claim 11, further comprising:
receiving external light that is incident into the waveguide from the virtual projection plane through the second optical coupling area and is emitted through a third optical coupling area, by using an image sensor; and
obtaining an image of a real world on the virtual projection plane based on the received external light.

14. The method of claim 13, further comprising:
providing a calibration image comprising a plurality of calibration points;
obtaining, by detecting a motion of a user indicating the plurality of calibration points, hand coordinate data of the user corresponding to the plurality of calibration points; and
generating, based on the hand coordinate data, a transform matrix configured to transform a hand position of the user into coordinates on the virtual projection plane.

15. The method of claim 14, further comprising:
correcting the transform matrix, by using an offset between reference point coordinates and the coordinates on the virtual projection plane corresponding to the hand position of a hand of the user, based on detecting that a defined first condition is satisfied; and
re-generating the transform matrix by providing the calibration image again, based on detecting that a defined second condition is satisfied; and
wherein the defined first condition comprises a condition with respect to at least one of whether the hand has deviated, whether a minute movement of the hand is repeated, or whether the offset exceeds a threshold value, and
wherein the defined second condition comprises a condition with respect to at least one of hand coordinate trajectory, selection accuracy, number of selection failures, touch duration, or usage time.
